(19) United States
(12) Patent Application Publication
(10) Pub. No.: US 2025/0066571 A1
(43) Pub. Date: Feb. 27, 2025

(54) THERMOPLASTIC FOAMS AND USES IN APPLICATIONS REQUIRING STRENGTH AND LIGHTWEIGHT

(71) Applicant: HONEYWELL INTERNATIONAL INC., Charlotte, NC (US)

(72) Inventors: Hayim Abrevaya, Charlotte, NC (US); Keith Lehuta, Charlotte, NC (US); Susie Martins, Charlotte, NC (US); Aziz Sattar, Charlotte, NC (US); Rodrigo Lobo, Charlotte, NC (US); Erin Broderick, Charlotte, NC (US); Alexey Kruglov, Charlotte, NC (US)

(73) Assignee: HONEYWELL INTERNATIONAL INC., Charlotte, NC (US)

(21) Appl. No.: 18/809,105

(22) Filed: Aug. 19, 2024

Related U.S. Application Data
(60) Provisional application No. 63/534,340, filed on Aug. 23, 2023.
(60) Provisional application No. 63/533,699, filed on Aug. 20, 2023.

(51) Int. Cl. C08J 9/00; C08G 61/12; C08G 63/183; C08G 101/00; C08J 9/14

(52) U.S. Cl. CPC C08J 9/0061; C08G 61/125; C08G 63/183; C08J 9/146; C08G 2101/00; C08G 2110/0041; C08J 2201/03; C08J 2203/142; C08J 2205/052; C08J 2367/03; C08J 2373/00

(57) ABSTRACT

Method of forming extruded thermoplastic foam comprising extruding a foamable composition comprising thermoplastic polymer and blowing agent, wherein said thermoplastic polymer consists essentially of ethylene furanoate moieties and optionally ethylene terephthalate moieties and wherein said extruding step comprises forcing said foamable composition from a relatively high pressure region through a die to a relatively low pressure region.

### CROSS REFERENCE TO RELATED APPLICATIONS

This application claims the priority benefit of each of U.S. 63/534,340, filed Aug. 8, 2023 and U.S. 63/533,699, and each of these applications is incorporated herein by reference as if fully set forth below.

This application also incorporates by reference U.S. Ser. No. 18/113,605, filed Feb. 23, 2023.

### FIELD OF THE INVENTION

This invention relates to foamable thermoplastic compositions, thermoplastic foams, foaming methods, and systems and articles made from same.

### BACKGROUND

While foams are used in a wide variety of applications, it is a desirable but difficult-to-achieve goal in many applications for the foam material to be environmentally friendly while at the same time possessing excellent performance properties and being cost effective to produce. Environmental considerations include not only the recyclability and sustainability of the polymeric resin that forms the structure of the foam but also the low environmental impact of blowing agents used to form the foam, such as the Global Warming Potential (GWP) and Ozone Depletion Potential (ODP) of the blowing agent.

Foams based on certain thermoplastic resins, including polyester resins, have been investigated for potential advantage from the perspective of being recyclable and/or sustainably sourced. However, difficulties have been encountered in connection with the development of such materials. For example, it has been a challenge to develop polyester resins that are truly recyclable, can be produced from sustainable sources, and which are compatible with blowing agents that are able, in combination with the thermoplastic, to produce foams with good performance properties. In many applications the performance properties that are considered highly desirable include the production of high-quality closed cell foam that are low density (and therefore have a low weight in use) and at the same time having relatively high mechanical integrity and strength.

With respect to the selection of thermoplastic resin, EP 3,231,836 acknowledges that while there has been interest in thermoplastic resins, in particularly polyester-based resins, this interest has encountered difficulty in development, including difficulty in identifying suitable foaming grades of such resins. Moreover, while EP 3,231,836 notes that certain polyethylene terephthalate (PET) resins, including recycled versions of PET, can be melt-extruded with a suitable physical and/or chemical blowing agent to yield closed-cell foams with the potential for low density and good mechanical properties, it is not disclosed that any such resins are at once are able to produce foams with good environmental properties and good performance properties, and are also able to be formed from sustainable sources. The '836 application identifies several possible polyester resins to be used in the formation of open-celled foams, including polyethylene terephthalate, poly butylene terephthalate, poly cyclohexane terephthalate, polyethylene naphthalate, polyethylene furanoate or a mixture of two or more of these. While the use of polyester materials to make foams that have essentially no closed cells, as required by EP '836, may be beneficial for some applications, a disadvantage of such structures is that in general open cell foams will exhibit relatively poor mechanical strength properties.

CN 108484959 discloses that making foam products based on 2,5-furan dimethyl copolyester is problematic because of an asserted problem of dissolution of foaming agent into the polyester and proposes the use of a combination of a liquid blowing agent and a gaseous blowing agent and a particular process involving sequential use of these different classes of blowing agent.

US 2020/0308363 and US 2020/0308396 each disclose the production of amorphous polyester copolymers that comprise starting with a recycled polyester, of which only PET is exemplified, as the main component and then proceeding through a series of processing steps to achieve an amorphous co-polymer, that is, as copolymer having no crystallinity. A wide variety of different classes of blowing agent are mentioned for use with such amorphous polymers.

With respect to blowing agents, the use generally of halogenated olefin blowing agents, including hydrofluoroolefins (HFOs) and hydrochlorofluorolefins (HCFOs), is also known, as disclosed for example in US 2009/0305876, which is assigned to the assignee of the present invention, and which is incorporated herein by reference. While the '876 application discloses the use of HFO and HFCO blowing agents with various thermoplastic materials to form foams, including PET, there is no disclosure or suggestion to use any of such blowing agents with any other type of polyester resin.

Applicants have come to appreciate that one or more unexpected advantages can be achieved in connection with the formation of thermoplastic foams, and in particular extruded thermoplastic foams, by using a polyester resin as disclosed herein in combination with a blowing agent comprising one of more hydrohaloolefin as disclosed herein.

### SUMMARY

The present invention includes extruded thermoplastic foam comprising:
(a) thermoplastic polymer cells comprising cell walls forming closed cells, wherein said thermoplastic polymer consists essentially of ethylene furanoate moieties and optionally ethylene terephthalate moieties, wherein said polymer comprises from about 1 mole % to about 100 mole % of ethylene furanoate moieties and optionally at least about 1 mole % ethylene terephthalate moieties; and
(b) one or more HFOs having three or four carbon atoms and/or one or more HFCOs having three or four carbon atoms contained in the closed cells.
   For the purposes of convenience, foams in accordance with this paragraph are referred to herein as Foam 1A.

The present invention includes extruded thermoplastic foam comprising:
(a) thermoplastic polymer cells comprising cell walls forming closed cells, wherein said thermoplastic polymer has a crystallinity of at least about 5% and consists essentially of ethylene furanoate moieties and optionally ethylene terephthalate moieties, wherein said polymer comprises from about 1 mole % to about 100 mole % of ethylene furanoate moieties and optionally at least about 1 mole % ethylene terephthalate moieties; and
(b) one or more HFOs having three or four carbon atoms and/or one or more HFCOs having three or four carbon atoms contained in the closed cells.
   For the purposes of convenience, foams in accordance with this paragraph are referred to herein as Foam 1B.

The present invention includes extruded thermoplastic foam comprising:
(a) thermoplastic polymer cells comprising cell walls forming closed cells, wherein said thermoplastic polymer has a molecular weight of at least about 10,000 kg/mole and a crystallinity of at least about 5% and consists essentially of ethylene furanoate moieties and ethylene terephthalate moieties, wherein said polymer comprises from about 1 mole % to about 20 mole % of ethylene furanoate moieties and at least about 1 mole % ethylene terephthalate moieties; and
(b) one or more HFOs having three or four carbon atoms and/or one or more HFCOs having three or four carbon atoms contained in the closed cells.
   For the purposes of convenience, foams in accordance with this paragraph are referred to herein as Foam 1C.

The present invention includes extruded thermoplastic foam comprising:
(a) thermoplastic polymer cells comprising cell walls forming closed cells, wherein said thermoplastic polymer has a molecular weight of at least about 10,000 kg/mole and a crystallinity of at least about 5% and consists essentially of ethylene furanoate moieties and ethylene terephthalate moieties, wherein said polymer comprises from about 1 mole % to about 20 mole % of ethylene furanoate moieties and from about 80 mole % to about 99 mole % ethylene terephthalate moieties; and
(b) one or more HFOs having three or four carbon atoms and/or one or more HFCOs having three or four carbon atoms contained in the closed cells.
   For the purposes of convenience, foams in accordance with this paragraph are referred to herein as Foam 1D.

The present invention includes extruded thermoplastic foam comprising:
(a) thermoplastic polymer cells comprising cell walls forming closed cells, wherein said thermoplastic polymer has a molecular weight of at least about 10,000 kg/mole and a crystallinity of at least about 5% and consists essentially of ethylene furanoate moieties and ethylene terephthalate moieties, wherein said polymer comprises from about 1 mole % to about 10 mole % of ethylene furanoate moieties and from about 90 mole % to about 99 mole % ethylene terephthalate moieties; and
(b) one or more HFOs having three or four carbon atoms and/or one or more HFCOs having three or four carbon atoms contained in the closed cells.
   For the purposes of convenience, foams in accordance with this paragraph are referred to herein as Foam 1E.

The present invention includes extruded thermoplastic foam comprising:
(a) thermoplastic polymer cells comprising cell walls forming closed cells, wherein said thermoplastic polymer has a molecular weight of at least about 10,000 kg/mole and a crystallinity of at least about 5% and consists essentially of ethylene furanoate moieties and ethylene terephthalate moieties, wherein said polymer comprises from about 1 mole % to about 5 mole % of ethylene furanoate moieties and from about 95 mole % to about 99 mole % ethylene terephthalate moieties; and
(b) one or more HFOs having three or four carbon atoms and/or one or more HFCOs having three or four carbon atoms contained in the closed cells.
   For the purposes of convenience, foams in accordance with this paragraph are referred to herein as Foam 1F.

The present invention includes extruded thermoplastic foam comprising:
(a) thermoplastic polymer cells comprising cell walls forming closed cells, wherein said thermoplastic polymer has a molecular weight of at least about 10,000 kg/mole and a crystallinity of at least about 5% and consists essentially of ethylene furanoate moieties and ethylene terephthalate moieties, wherein said polymer comprises from about 0.5 mole % to about 2 mole % of ethylene furanoate moieties and from about 98 mole % to about 99.5 mole % ethylene terephthalate moieties; and
(b) one or more HFOs having three or four carbon atoms and/or one or more HFCOs having three or four carbon atoms contained in the closed cells.
   For the purposes of convenience, foams in accordance with this paragraph are referred to herein as Foam 1G.

The present invention includes extruded thermoplastic foam comprising:
(a) thermoplastic polymer cells comprising cell walls forming closed cells, wherein said thermoplastic polymer has a molecular weight of at least about 10,000 kg/mole and a crystallinity of at least about 5% and consists essentially of ethylene furanoate moieties and ethylene terephthalate moieties, wherein said polymer comprises about 1 mole % of ethylene furanoate moieties and about 99 mole % ethylene terephthalate moieties; and
(b) one or more HFOs having three or four carbon atoms and/or one or more HFCOs having three or four carbon atoms contained in the closed cells.
   For the purposes of convenience, foams in accordance with this paragraph are referred to herein as Foam 1H.

The present invention includes extruded thermoplastic foam comprising:
(a) thermoplastic polymer cells comprising cell walls forming closed cells, wherein said thermoplastic polymer has a molecular weight of at least about 10,000 kg/mole and a crystallinity of at least about 5% and consists essentially of ethylene furanoate moieties and ethylene terephthalate moieties, wherein said polymer comprises about 0.5 mole % of ethylene furanoate moieties and about 99.5 mole % ethylene terephthalate moieties; and
(b) one or more HFOs having three or four carbon atoms and/or one or more HFCOs having three or four carbon atoms contained in the closed cells.
   For the purposes of convenience, foams in accordance with this paragraph are referred to herein as Foam 1I.

The present invention includes extruded thermoplastic foam comprising:
(a) thermoplastic polymer cells comprising cell walls forming closed cells, wherein said thermoplastic polymer has a molecular weight of at least about 10,000 kg/mole and a crystallinity of at least about 5% and consists essentially of ethylene furanoate moieties and ethylene terephthalate moieties, wherein said polymer comprises about 5 mole % of ethylene furanoate moieties and about 95 mole % ethylene terephthalate moieties; and
(b) one or more HFOs having three or four carbon atoms and/or one or more HFCOs having three or four carbon atoms contained in the closed cells.
   For the purposes of convenience, foams in accordance with this paragraph are referred to herein as Foam 1J.

The present invention includes extruded thermoplastic foam comprising:
(a) thermoplastic polymer cells comprising cell walls forming closed cells, wherein said thermoplastic polymer has a molecular weight of at least about 10,000 kg/mole and a crystallinity of at least about 5% and consists essentially of ethylene furanoate moieties and ethylene terephthalate moieties, wherein said polymer comprises about 10 mole % of ethylene furanoate moieties and about 90 mole % ethylene terephthalate moieties; and
(b) one or more HFOs having three or four carbon atoms and/or one or more HFCOs having three or four carbon atoms contained in the closed cells.
   For the purposes of convenience, foams in accordance with this paragraph are referred to herein as Foam 1K.

The present invention includes extruded thermoplastic foam comprising:
(a) thermoplastic polymer cells comprising cell walls forming closed cells, wherein said thermoplastic polymer has a molecular weight of at least about 10,000 kg/mole and a crystallinity of at least about 5% and consists essentially of ethylene furanoate moieties and ethylene terephthalate moieties, wherein said polymer comprises about 20 mole % of ethylene furanoate moieties and about 80 mole % ethylene terephthalate moieties; and
(b) one or more HFOs having three or four carbon atoms and/or one or more HFCOs having three or four carbon atoms contained in the closed cells.
   For the purposes of convenience, foams in accordance with this paragraph are referred to herein as Foam 1L.

The present invention includes extruded thermoplastic foam comprising:
(a) thermoplastic polymer cells comprising cell walls comprising polyethylene furanoate wherein at least 25% of said cells are closed cells; and
(b) 1234ze(E) contained in the closed cells.
   For the purposes of convenience, foams in accordance with this paragraph are referred to herein as Foam 2A.

The present invention includes extruded thermoplastic foam comprising:
(a) thermoplastic polymer cells comprising cell walls comprising polyethylene furanoate and consists essentially of ethylene furanoate moieties and ethylene terephthalate moieties, wherein said polymer comprises from about 1 mole % to about 20 mole % of ethylene furanoate moieties and about 0.5 mole % or more of ethylene terephthalate moieties, wherein at least 25% of said cells are closed cells; and
(b) 1234ze(E) contained in the closed cells.
   For the purposes of convenience, foams in accordance with this paragraph are referred to herein as Foam 2B.

The present invention includes extruded thermoplastic foam comprising:
(a) thermoplastic polymer cells comprising cell walls comprising polyethylene furanoate and consists essentially of ethylene furanoate moieties and ethylene terephthalate moieties, wherein said polymer comprises from about 1 mole % to about 20 mole % of ethylene furanoate moieties and about 0.5 mole % or more of ethylene terephthalate moieties, wherein at least 25% of said cells are closed cells; and
(b) 1336mzz(Z) contained in the closed cells.
   For the purposes of convenience, foams in accordance with this paragraph are referred to herein as Foam 2C.

The present invention includes extruded thermoplastic foam comprising:
(a) thermoplastic polymer cells comprising cell walls comprising polyethylene furanoate and consists essentially of ethylene furanoate moieties and ethylene terephthalate moieties, wherein said polymer comprises from about 1 mole % to about 20 mole % of ethylene furanoate moieties and about 0.5 mole % or more of ethylene terephthalate moieties, wherein at least 25% of said cells are closed cells; and
(b) 1223zd(E) contained in the closed cells.
   For the purposes of convenience, foams in accordance with this paragraph are referred to herein as Foam 2D.

The present invention includes extruded thermoplastic foam comprising:
(a) thermoplastic polymer cells comprising cell walls comprising polyethylene furanoate and consists essentially of ethylene furanoate moieties and ethylene terephthalate moieties, wherein said polymer comprises from about 1 mole % to about 20 mole % of ethylene furanoate moieties and about 0.5 mole % or more of ethylene terephthalate moieties, wherein at least 25% of said cells are closed cells; and
(b) 1224yd contained in the closed cells.
   For the purposes of convenience, foams in accordance with this paragraph are referred to herein as Foam 2E.

The present invention includes extruded thermoplastic foam comprising:
(a) thermoplastic polymer cells comprising cell walls comprising polyethylene furanoate and consists essentially of ethylene furanoate moieties and ethylene terephthalate moieties, wherein said polymer comprises from about 1 mole % to about 20 mole % of ethylene furanoate moieties and about 0.5 mole % or more of ethylene terephthalate moieties, wherein at least 50% of said cells are closed cells; and
(b) gas in said closed cell, wherein said gas comprises from about 25% by weight to 100% by weight of 1234ze(E). For the purposes of convenience, foams in accordance with this paragraph are referred to herein as Foam 2F.

Reference will be made at various locations herein to a numbered foam (e.g., Foam 1) or to group of numbered foams that have been defined herein, and such reference means each of such numbered systems, including each system having a number within the group, including any suffixed numbered system. For example, reference to Foam 1 includes a separate reference to each of Foams 1A, 1B, 1C, 1D, etc., and reference to Foams 1-2 is understood to include a separate reference to each of Foams 1A, 1B, 1C, 1D, etc., and each of foams 2A, 2B, 2C, 2D, etc. Further, this convention is used throughout the present specification for other defined materials, including Blowing Agents.

The present invention includes extruded thermoplastic foam comprising:
(a) thermoplastic polymer cells comprising cell walls forming closed cells, wherein said thermoplastic polymer consists essentially of ethylene furanoate moieties and optionally ethylene terephthalate moieties, wherein said thermoplastic polymer: (i) comprises from about 10 mole % to about 100 mole % of ethylene furanoate moieties and optionally at least about 1 mole % ethylene terephthalate moieties; and (ii) has a molecular weight of at least about 25,000; and
(b) trans1234ze contained in the closed cells.
   For the purposes of convenience, foams in accordance with this paragraph are referred to herein as Foam 3.

The present invention includes extruded thermoplastic foam comprising:
(a) thermoplastic polymer cells comprising cell walls forming closed cells, wherein said thermoplastic polymer consists essentially of ethylene furanoate moieties and optionally ethylene terephthalate moieties, wherein said thermoplastic polymer: (i) comprises from about 10 mole % to about 100 mole % of ethylene furanoate moieties and optionally at least about 1 mole % ethylene terephthalate moieties; and (ii) has a molecular weight of from about 25,000 to about 140,000; and
(b) trans1234ze contained in the closed cells.
   For the purposes of convenience, foams in accordance with this paragraph are referred to herein as Foam 4.

The present invention includes foamable thermoplastic compositions comprising:
(a) thermoplastic material consists essentially of ethylene furanoate moieties and optionally ethylene terephthalate moieties, wherein said thermoplastic material comprises from about 1 mole % to about 100 mole % of ethylene furanoate moieties and optionally at least about 1 mole % ethylene terephthalate moieties; and
(b) blowing agent comprising one or more HFOs having three or four carbon atoms and/or one or more HFCOs having three or four carbon atoms.
   For the purposes of convenience, foamable compositions in accordance with this paragraph are referred to herein as Foamable Composition 1.

The present invention includes methods of forming thermoplastic compositions having improved crystallinity comprising:
(a) forming a thermoplastic material comprising polymer chains containing ethylene furanoate moieties and/or ethylene terephthalate moieties; and
(b) dissolving at least a portion of said thermoplastic material in a solvent wherein said thermoplastic material comprises from about 1 mole % to about 100 mole % of ethylene furanoate moieties and optionally at least about 1 mole % ethylene terephthalate moieties; and
(c) distilling said solvent from said thermoplastic material.
   For the purposes of convenience, methods of forming thermoplastic compositions according to this paragraph are referred to herein as Thermoplastic Forming Method 1.

The present invention also provides methods for forming thermoplastic foam comprising foaming a foamable composition of the present invention, including Foamable Compositions 1. For the purposes of convenience, methods in accordance with this paragraph are referred to herein as Foaming Method 1.

The present invention also provides methods for forming extruded thermoplastic foam comprising extruding a foamable composition of the present invention, including Foamable Composition 1. For the purposes of convenience, methods in accordance with this paragraph are referred to herein as Foaming Method 2.

The present invention also provides methods for forming extruded thermoplastic foam comprising extruding a foamable composition of the present invention, including Foamable Composition 1, comprising causing said foamable composition to move through a die from a relatively high pressure region to a relatively low pressure region in an extruder. For the purposes of convenience, methods in accordance with this paragraph are referred to herein as Extruding Method 1.

### BRIEF DESCRIPTION OF THE DRAWING

FIG. 1 is a schematic representation of an extrusion system and process according to one embodiment of the invention and according to the examples herein.

FIG. 2A-2C are graphical representations of the results from Examples C1B.

FIGS. 3A and 3B are graphical representations of the results from Example C2B.

FIG. 4 is a graphical representation of the results from Example 1B.

FIGS. 5A and 5B are graphical representations of the results from Example 2B.

FIGS. 6A-6D are graphical representations of the results from Example 3B.

FIG. 7 is a graphical representation of the results from Example 4B.

FIG. 8 is a graphical representation of the results from Example 5B.

FIG. 9 is a graphical representation of the results from Example 6B.

FIG. 10 is a graphical representation of the results from Example 7B.

FIG. 11 is a graphical representation of the results from Example 8B.

FIG. 12 is a graphical representation of the results from Example 9B.

FIG. 13 is a graphical representation of the results from Example 10B

FIG. 14 is a graphical representation of the results from Example 11B

FIG. 15 is a graphical representation of the results from Example 12B

FIG. 16 is a graphical representation of the results from Example 12C

FIG. 17 is a graphical representation of the results from Example 13B1

FIG. 18 is a graphical representation of the results from Example 13B2

FIG. 19 is a graphical representation of the results from Example 13B3

FIG. 20 is a graphical representation of the results from Example 16B1-B3.

FIG. 20A is a graphical representation of the tensile strength results from Examples 20B1, 20B2 and 20B3.

FIG. 20B is a graphical representation of the compressive strength results from Examples 20B1, 20B2 and 20B3.

FIG. 21 is a schematic representation of an exemplary wind turbine

FIG. 22 is a schematic representation of an exemplary wind turbine blade.

FIG. 23A is a cross-sectional view of the exemplary wind turbine blade of FIG. 22.

FIG. 23B is a cross-sectional view of an exemplary wind turbine blade.

FIG. 24 is a cross-sectional view of a faced commercial PET foam as referenced in Comparative Example 7.

FIG. 25 is a graphical representation of the results from Example 21B.

### DEFINITIONS

1234ze means 1,1,1,3-tetrafluoropropene, without limitation as to isomeric form.

Trans1234ze and 1234ze(E) each means trans1,3,3,3-tetrafluoropropene.

Cis1234ze and 1234ze(Z) each means cis1,3,3,3-tetrafluoropropene.

1234yf means 2,3,3,3-tetrafluoropropene.

1233zd means 1-chloro-3,3,3-trifluoropropene, without limitation as to isomeric form.

Trans1233zd and 1233zd(E) each means trans1-chloro-3,3,3-trifluoropropene.

1224yd means cis1-chloro-2,3,3,3-tetrafluoropropane, without limitation as to isomeric form.

1336mzz means 1,1,1,4,4,4-hexafluorobutene, without limitation as to isomeric form.

Trans1336mzz and 1336mzz(E) each means trans1,1,1,4,4,4-hexafluorobutene.

Cis1336mzz and 1336mzz(Z) each means cis1,1,1,4,4,4-hexafluorobutene.

Closed cell foam means that a substantial volume percentage of the cells in the foam are closed, for example, about 20% by volume or more.

Ethylene furanoate moiety means the following structure:

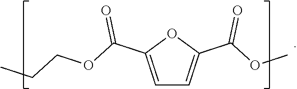

FDCA means 2,5-furandicarboxylic acid and has the following structure:

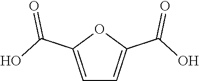 [SMILES: O=C(O)c1ccc(C(=O)O)o1]

MEG means monoethylene glycol and has the following structure:

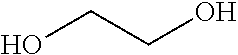

FDME means dimethyl 2,5-furandicarboxylate and has the following structure:

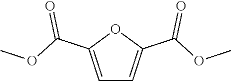

PEF homopolymer means a polymer having at least 99 mole % of ethylene furanoate moieties.

PEF copolymer means a polymer having at least about 10 mole % ethylene furanoate moieties and more than 1% of polymer moieties other than ethylene furanoate moieties.

PEF:PET copolymer means a polymer having at least about 10 mole % ethylene furanoate moieties and at least 1% of ethylene terephthalate moieties.

PEF means poly (ethylene furanoate) and encompasses and is intended to reflect a description of PEF homopolymer and PEF coploymer.

Ethylene terephthalate moiety means the following structure and as understood by those skilled in the art repeating units based on this structure:

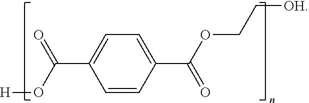

SSP means solid-state polymerization.

PMDA means pyromellitic dianhydride having the following structure:

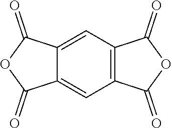 [SMILES: O=c1oc(=O)c2cc3c(=O)oc(=O)c3cc12]

### DETAILED DESCRIPTION

### Poly (Ethylene Furanoate)

The present invention relates to foams and foam article that comprise cell walls comprising poly(ethylene furanoate) (“PEF”).

The PEF which forms the cells walls of the foams and foam articles of the present invention can be PEF homopolymer or PEF copolymer, and particularly PEF:PET copolymer.

PEF homopolymer is a known material that is known to be formed by either: (a) esterification and polycondensation of FDCA with MEG; or (b) transesterification and polycondensation of FDME with MEG as illustrated below for example:

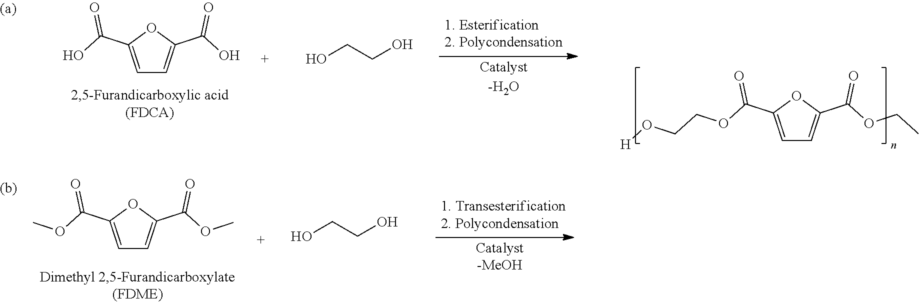

A detailed description of such known esterification and polycondensation synthesis methods is provided in GB Patent 621971 (Drewitt, J. G. N., and Lincocoln, J., entitled “Improvements in Polymers”), which is incorporated herein by reference. A detailed description of such know transesterification and polycondensation synthesis methods is provided in Gandini, A., Silvestre, A. J. D., Neto, C. P., Sousa, A. F., and Gomes, M. (2009), “The furan counterpart of poly(ethylene terephthalate): an alternative material based on renewable resources.”, J. Polym. Sci. Polym. Chem. 47, 295-298. doi: 10.1002/pola.23130, which is incorporated herein by reference.

### Foams

The foams of the present invention, including each of Foams 1-4, are formed from either PEF homopolymers, PEF copolymers, or a combination/mixture of these.

The foams of the present invention, including each of Foams 1-4, may be formed in preferred embodiments from PEF homopolymer in which the polymer has at least 99.5% by weight, or at least 99.9% of by weight, of ethylene furanoate moieties.

It is contemplated that the foams of the present invention, including each of Foams 1-4, may be formed in preferred embodiments from PEF copolymer in which the polymer, including PEF copolymer, has from about 60% to about 99% by weight of ethylene furanoate moieties, or from about 70% to about 99% by weight of ethylene furanoate moieties, or from about 80% to about 99% by weight of ethylene furanoate moieties, or from about 90% to about 99% by weight of ethylene furanoate moieties or from about 95% to about 99.5% by weight of ethylene furanoate moieties.

It is contemplated that the foams of the present invention, including each of Foams 1-4, may be formed in preferred embodiments from PEF copolymer in which the polymer, including PEF copolymer, has from about 40% to about 1% by weight of ethylene furanoate moieties, or from about 30% to about 1% by weight of ethylene furanoate moieties, or from about 20% to about 1% by weight of ethylene furanoate moieties, or from about 10% to about 1% by weight of ethylene furanoate moieties, or from about 5% to about 1% by weight of ethylene furanoate moieties, or from about 5% to about 0.5% by weight of ethylene furanoate moieties.

It is contemplated that the foams of the present invention, including each of Foams 1-4, may be formed in preferred embodiments from PEF copolymer in which the polymer, including PEF copolymer, has from about 40% to about 1% by mole of ethylene furanoate moieties and from about 60% to about 99% by mole of ethylene terephthalate moieties, or from about 30% to about 1% by mole of ethylene furanoate moieties and from about 70% to about 99% by mole of ethylene terephthalate moieties, or from about 20% to about 1% by mole of ethylene furanoate moieties and from about 80% to about 99% by mole of ethylene terephthalate moieties, or from about 10% to about 1% by mole of ethylene furanoate moieties and from about 90% to about 99% by mole of ethylene terephthalate moieties, or from about 5% to about 1% by mole of ethylene furanoate moieties and from about 95% to about 99% by mole of ethylene terephthalate moieties, or from about 5% to about 0.5% by mole of ethylene furanoate moieties and from about 95% to about 99.5% by mole of ethylene terephthalate moieties.

For those embodiments of the present invention involving PEF copolymers, it is contemplated that those skilled in the art will be able, in view of the teachings contained herein, to select the type and amount of co-polymeric materials to be used within each of the ranges described herein to achieve the desired enhancement/modification of the polymer without undue experimentation.

For those embodiments of the present invention involving the use of PEF homopolymer or PEF copolymer, it is contemplated that such material may be formed with a wide variety of molecular weights and physical properties within the scope of the present invention. In preferred embodiments, the foams, including each of Foams 1-4, are formed from PEF having the ranges of characteristics identified in Table 1 below, which are measured as described in the Examples hereof:

TABLE 1

| | | First | Second | |
|---|---|---|---|---|
| | Broad | Intermediate | Intermediate | Narrow |
| Polymer property | Range | Range | Range | Range |
| Molecular weight | 20,000-150,000 | 45,000-130,000 | 45,000-130,000 | 55,000-120,000 |
| Glass Transition | 75-95 | 75-95 | 75-95 | 75-95 |
| Temperature, T_{g}, ° C. | | | | |
| Melting | 190-250 | 190-240 | 190-240 | 200-230 |
| Temperature, Tₘ, ° C. | | | | |
| Decomposition | 310-410 | 320-400 | 320-400 | 330-380 |
| Temperature, T_{d}, ° C. | | | | |
| Crystallinity, % | 5-75 | 25-75 | 30-60 | 35-50 |

In general, it is contemplated that those skilled in the art will be able to formulate PEF polymers within the range of properties described above without undue experimentation in view of the teachings contained herein. In preferred embodiments, however, PEF (including PEF homopolymer and PEF copolymer) having these properties is achieved using one or more of the synthesis methods described above, in combination with a variety of known supplemental processing techniques, including by treatment (including treatment in the extruder) with chain extenders, such as PMDA (and alternatives and supplements to PMDA, such as ADR, PENTA and talc as described in the present examples, and others), chain branching agents, such as trimethylolpropane triacrylate (TMPTA), PMDA (which can provide both chain extension and chain branching), poly (glycolic acid) (which can provide both chain extension and chain branching), triglycidyl isocyanurate (which can provide both chain extension and chain branching), bisphenol A diglycidyl ether (which can provide both chain extension and chain branching) and/or SSP processing. It is believed that, in view of the disclosures contained herein, including the polymer synthesis described in the Examples below, a person skilled in the art will be able to produce PEF polymers within the range of characteristics described in the table above and elsewhere herein, including the use of methods to enhance crystallization of polymers. Such processing conditions include methods of increasing crystallization as described herein, including Thermoplastic Forming Method 1 of the present invention and such methods as are disclosed in the Examples hereof.

An example of the process for chain extension treatment of polyesters is provided in the article “Recycled poly(ethylene terephthalate) chain extension by a reactive extrusion process,” Firas Awaja, Fugen Daver, Edward Kosior, 16 Aug. 2004, available at https://doi.org/10.1002/pen.20155, which is incorporated herein by reference. As explained in US 1009/0264545, which is incorporated herein by reference, chain extenders generally are typically compounds that are at least di-functional with respect to reactive groups which can react with end groups or functional groups in the polyester to extend the length of the polymer chains. In certain cases, as disclosed herein, such a treatment can advantageously increases the average molecular weight of the polyester to improve its melt strength and/or other important properties. The degree of chain extension achieved is related, at least in part, to the structure and functionalities of the compounds used. Various compounds are useful as chain extenders. Non-limiting examples of chain extenders include trimellitic anhydride, pyromellitic dianhydride (PMDA), trimellitic acid, haloformyl derivatives thereof, or compounds containing multi-functional epoxy (e.g., glycidyl), or oxazoline functional groups. Nanocomposite material such as finely dispersed nanoclay may optionally be used for controlling viscosity. Commercial chain extenders include CESA-Extend from Clariant, Joncryl from BASF, or Lotader from Arkema. The amount of chain extender can vary depending on the type and molecular weight of the polyester components. The amount of chain extender used to treat the polymer can vary widely, and in preferred embodiments ranges from about 0.1 to about 5 wt. %, or preferably from about 0.1 to about 1.5 wt. %. Examples of chain extenders are also described in U.S. Pat. No. 4,219,527, which is incorporated herein by reference.

An example of the process for SSP processing of poly(ethylene furanoate) is provided in the article “Solid-State Polymerization of Poly(ethylene furanoate) Biobased Polyester, I: Effect of Catalyst Type on Molecular Weight Increase,” Nejib Kasmi, Mustapha Majdoub, George Z. Papageorgiou, Dimitris S. Achilias, and Dimitrios N. Bikiaris, which is incorporated herein by reference.

The PEF thermoplastic polymers which are especially advantageous for making foamable compositions and foams of the present invention are identified in the following Thermoplastic Polymer Table (Table 2A), wherein all numerical values in the table are understood to be preceded by the word “about.”

TABLE 2A
THERMOPLASTIC POLYMER TABLE

| | Ethylene | | | | |
|---|---|---|---|---|---|
| Thermoplastic | furanoate | Tannin | Other | MW, | Crystal- |
| Polymer (TPP) | moieties, | moieties, | moieties, | Kg/ | linity, |
| Number | wt % | wt % | wt % | mol | % |
| TPP1A | 100 | 0 | 0 | 25-180 | 25-100 |
| TPP1B | 100 | 0 | 0 | 25-75 | 30-60 |
| TPP1C | 100 | 0 | 0 | 80-130 | 30-60 |
| TPP1D | 100 | 0 | 0 | 90-120 | 35-50 |
| TPP1E | 100 | 0 | 0 | 90-110 | 35-45 |
| TPP2A | 85 to <100 | >0 to <15 | 0 | 25-180 | 25-100 |
| TPP2B | 85 to <100 | >0 to <15 | 0 | 25-75 | 30-60 |
| TPP2C | 85 to <100 | >0 to <15 | 0 | 80-130 | 30-60 |
| TPP2D | 85 to <100 | >0 to <15 | 0 | 90-120 | 35-50 |
| TPP2E | 85 to <100 | >0 to <15 | 0 | 90-110 | 35-45 |
| TPP3A | 5 to 95 | 0 | 5 to 95 | 25-180 | 25-100 |
| TPP3B | 5 to 95 | 0 | 5 to 95 | 25-75 | 30-60 |
| TPP3C | 5 to 95 | 0 | 5 to 95 | 80-130 | 30-60 |
| TPP3D | 5 to 95 | 0 | 5 to 95 | 90-120 | 35-50 |
| TPP3E | 5 to 95 | 0 | 5 to 95 | 90-110 | 35-45 |
| TPP4A | 5 to 95 | >0-<15 | 5 to 95 | 25-180 | 25-100 |
| TPP4B | 5 to 95 | >0-<15 | 5 to 95 | 25-75 | 30-60 |
| TPP4C | 5 to 95 | >0-<15 | 5 to 95 | 80-130 | 30-60 |
| TPP4D | 5 to 95 | >0-<15 | 5 to 95 | 90-120 | 35-50 |
| TPP4E | 5 to 95 | >0-<15 | 5 to 95 | 90-110 | 35-45 |
| TPP5A | 10 | 0 | 90 | 25-180 | 25-100 |
| TPP5B | 10 | 0 | 90 | 25-75 | 30-60 |
| TPP5C | 10 | 0 | 90 | 80-130 | 30-60 |
| TPP5D | 10 | 0 | 90 | 90-120 | 35-50 |
| TPP5E | 10 | 0 | 90 | 90-110 | 35-45 |
| TPP6A | 90 | 0 | 10 | 25-180 | 25-100 |
| TPP6B | 90 | 0 | 10 | 25-75 | 30-60 |
| TPP6C | 90 | 0 | 10 | 80-130 | 30-60 |
| TPP6D | 90 | 0 | 10 | 90-120 | 35-50 |
| TPP6E | 90 | 0 | 10 | 90-110 | 35-45 |

The PEF thermoplastic polymers which are especially advantageous for making foamable compositions and foams of the present invention also include those materials identified in the following Thermoplastic Polymer Table (Table 2B), wherein all numerical values in the table are understood to be preceded by the word “about.”

TABLE 2B
THERMOPLASTIC POLYMER TABLE

| Thermo- | | | | | |
|---|---|---|---|---|---|
| plastic | Ethylene | | Ethylene | | |
| Polymer | furanoate | Tannin | Terephalate | MW, | Crystal- |
| (TPP) | moieties, | moieties, | moieties, | Kg/ | linity, |
| Number | wt % | wt % | wt % | mol | % |
| TPP7A | 100 | 0 | 0 | 25-180 | 25-100 |
| TPP7B | 100 | 0 | 0 | 25-75 | 30-60 |
| TPP7C | 100 | 0 | 0 | 80-130 | 30-60 |
| TPP7D | 100 | 0 | 0 | 90-120 | 35-50 |
| TPP7E | 100 | 0 | 0 | 90-110 | 35-45 |
| TPP8A | 85 to <100 | >0 to <15 | 0 | 25-180 | 25-100 |
| TPP8B | 85 to <100 | >0 to <15 | 0 | 25-75 | 30-60 |
| TPP8C | 85 to <100 | >0 to <15 | 0 | 80-130 | 30-60 |
| TPP8D | 85 to <100 | >0 to <15 | 0 | 90-120 | 35-50 |
| TPP8E | 85 to <100 | >0 to <15 | 0 | 90-110 | 35-45 |
| TPP8A | 5 to 95 | 0 | 5 to 95 | 25-180 | 25-100 |
| TPP8B | 5 to 95 | 0 | 5 to 95 | 25-75 | 30-60 |
| TPP8C | 5 to 95 | 0 | 5 to 95 | 80-130 | 30-60 |
| TPP8D | 5 to 95 | 0 | 5 to 95 | 90-120 | 35-50 |
| TPP8E | 5 to 95 | 0 | 5 to 95 | 90-110 | 35-45 |
| TPP9A | 5 to 95 | >0-<15 | 5 to 95 | 25-180 | 25-100 |
| TPP9B | 5 to 95 | >0-<15 | 5 to 95 | 25-75 | 30-60 |
| TPP9C | 5 to 95 | >0-<15 | 5 to 95 | 80-130 | 30-60 |
| TPP9D | 5 to 95 | >0-<15 | 5 to 95 | 90-120 | 35-50 |
| TPP9E | 5 to 95 | >0-<15 | 5 to 95 | 90-110 | 35-45 |
| TPP10A | 10 | 0 | 90 | 25-180 | 25-100 |
| TPP10B | 10 | 0 | 90 | 25-75 | 30-60 |
| TPP10C | 10 | 0 | 90 | 80-130 | 30-60 |
| TPP10D | 10 | 0 | 90 | 90-120 | 35-50 |
| TPP10E | 10 | 0 | 90 | 90-110 | 35-45 |
| TPP11A | 90 | 0 | 10 | 25-180 | 25-100 |
| TPP11B | 90 | 0 | 10 | 25-75 | 30-60 |
| TPP11C | 90 | 0 | 10 | 80-130 | 30-60 |
| TPP11D | 90 | 0 | 10 | 90-120 | 35-50 |
| TPP11E | 90 | 0 | 10 | 90-110 | 35-45 |

The PEF thermoplastic polymers which are especially advantageous for making foamable compositions and foams of the present invention also include those materials identified in the following Thermoplastic Polymer Table (Table 2C), wherein all numerical values in the table are understood to be preceded by the word “about.”

TABLE 2C
THERMOPLASTIC POLYMER TABLE

| Thermo- | | | | | |
|---|---|---|---|---|---|
| plastic | Ethylene | | Ethylene | | |
| Polymer | furanoate | Tannin | Terephalate | MW, | Crystal- |
| (TPP) | moieties, | moieties, | moieties, | Kg/ | linity, |
| Number | mole % | mole % | mole % | mol | % |
| TPP12A | 100 | 0 | 0 | 25-180 | 25-100 |
| TPP12B | 100 | 0 | 0 | 25-75 | 30-60 |
| TPP12C | 100 | 0 | 0 | 80-130 | 30-60 |
| TPP12D | 100 | 0 | 0 | 90-120 | 35-50 |
| TPP12E | 100 | 0 | 0 | 90-110 | 35-45 |
| TPP13A | 85 to <100 | >0 to <15 | 0 | 25-180 | 25-100 |
| TPP13B | 85 to <100 | >0 to <15 | 0 | 25-75 | 30-60 |
| TPP13C | 85 to <100 | >0 to <15 | 0 | 80-130 | 30-60 |
| TPP13D | 85 to <100 | >0 to <15 | 0 | 90-120 | 35-50 |
| TPP13E | 85 to <100 | >0 to <15 | 0 | 90-110 | 35-45 |
| TPP14A | 5 to 95 | 0 | 5 to 95 | 25-180 | 25-100 |
| TPP14B | 5 to 95 | 0 | 5 to 95 | 25-75 | 30-60 |
| TPP14C | 5 to 95 | 0 | 5 to 95 | 80-130 | 30-60 |
| TPP14D | 5 to 95 | 0 | 5 to 95 | 90-120 | 35-50 |
| TPP14E | 5 to 95 | 0 | 5 to 95 | 90-110 | 35-45 |
| TPP15A | 5 to 95 | >0-<15 | 5 to 95 | 25-180 | 25-100 |
| TPP15B | 5 to 95 | >0-<15 | 5 to 95 | 25-75 | 30-60 |
| TPP15C | 5 to 95 | >0-<15 | 5 to 95 | 80-130 | 30-60 |
| TPP16D | 5 to 95 | >0-<15 | 5 to 95 | 90-120 | 35-50 |
| TPP16E | 5 to 95 | >0-<15 | 5 to 95 | 90-110 | 35-45 |
| TPP17A | 10 | 0 | 90 | 25-180 | 25-100 |
| TPP17B | 10 | 0 | 90 | 25-75 | 30-60 |
| TPP17C | 10 | 0 | 90 | 80-130 | 30-60 |
| TPP17D | 10 | 0 | 90 | 90-120 | 35-50 |
| TPP17E | 10 | 0 | 90 | 90-110 | 35-45 |
| TPP18A | 90 | 0 | 10 | 25-180 | 25-100 |
| TPP18B | 90 | 0 | 10 | 25-75 | 30-60 |
| TPP18C | 90 | 0 | 10 | 80-130 | 30-60 |
| TPP18D | 90 | 0 | 10 | 90-120 | 35-50 |
| TPP18E | 90 | 0 | 10 | 90-110 | 35-45 |
| TPP19A | 5 | 0 | 95 | 25-180 | 25-100 |
| TPP19B | 5 | 0 | 95 | 25-75 | 30-60 |
| TPP19C | 5 | 0 | 95 | 80-130 | 30-60 |
| TPP19D | 5 | 0 | 95 | 90-120 | 35-50 |
| TPP19E | 5 | 0 | 95 | 90-110 | 35-45 |
| TPP20A | 1 | 0 | 99 | 25-180 | 25-100 |
| TPP20B | 1 | 0 | 99 | 25-75 | 30-60 |
| TPP20C | 1 | 0 | 99 | 80-130 | 30-60 |
| TPP20D | 1 | 0 | 99 | 90-120 | 35-50 |
| TPP20E | 1 | 0 | 99 | 90-110 | 35-45 |
| TPP21A | 1-20 | 0 | 80-99 | 25-180 | 25-100 |
| TPP21B | 1-20 | 0 | 80-99 | 25-75 | 30-60 |
| TPP21C | 1-20 | 0 | 80-99 | 80-130 | 30-60 |
| TPP21D | 1-20 | 0 | 80-99 | 90-120 | 35-50 |
| TPP21E | 1-20 | 0 | 80-99 | 90-110 | 35-45 |
| TPP22A | 1-10 | 0 | 80-99 | 25-180 | 25-100 |
| TPP22B | 1-10 | 0 | 90-99 | 25-75 | 30-60 |
| TPP22C | 1-10 | 0 | 90-99 | 80-130 | 30-60 |
| TPP22D | 1-10 | 0 | 90-99 | 90-120 | 35-50 |
| TPP22E | 1-10 | 0 | 90-99 | 90-110 | 35-45 |

For the purposes of definition of terms used herein, it is to be noted that reference will be made at various locations herein to the thermoplastic polymers identified in the first column in each of rows in the TPP table above, and reference to each of these numbers is a reference to a thermoplastic polymer as defined in the corresponding columns of that row. Reference to a group of TPPs that have been defined in the table above by reference to a TPP number means separately and individually each such numbered TPP, including each TPP having the indicated number, including any such number that has a suffix. So for example, reference to TPP1 is a separate and independent reference to TPP1A, TPP1B, TPP1C, TPP1D and TPP1E. Reference to TPP1-TPP2 is a separate and independent reference to TPP1A, TPP1B, TPP1C, TPP1D, TTP1E, TPPA, TPP2B, TPP2C, TPP2D and TPP1E. This use convention is used for the Foamable Composition Table and the Foam Table below as well.

### Blowing Agent

As explained in detail herein, the present invention includes, but is not limited to, applicant's discovery that a select group of blowing agents are capable of providing foamable PEF foamable compositions and PEF foams having a difficult-to-achieve and surprising combination of physical properties, including low density as well as good mechanical strength properties.

The blowing agent used in accordance with the present invention preferably comprises one or more hydrohaloolefins having three or four carbon atoms. For the purposes of convenience, a blowing agent in accordance with this paragraph is sometimes referred to herein as Blowing Agent 1.

The blowing agent used in accordance with of the present invention preferably comprises one or more of 1234ze, 1234yf, 1336mzz, 1233zd and 1224ydf (referred to hereinafter for convenience as Blowing Agent 2); or comprises one or more of trans1234ze, 1336mzz, trans1233zd and cis1224yd (referred to hereinafter for convenience as Blowing Agent 3); or comprises one or more of trans1234ze, trans1336mzz, trans1233zd and cis1224yd (referred to hereinafter for convenience as Blowing Agent 4); or comprises one or more of trans1234ze and trans1336mzz (referred to hereinafter for convenience as Blowing Agent 5); or comprises trans1234ze (referred to hereinafter for convenience as Blowing Agent 6); or comprises trans1336mzz (referred to hereinafter for convenience as Blowing Agent 7); or comprises cis1336mzz (referred to hereinafter for convenience as Blowing Agent 8); or comprises 1234yf (referred to hereinafter for convenience as Blowing Agent 9); or comprises 1224yd (referred to hereinafter for convenience as Blowing Agent 10); or comprises trans1233zd(referred to hereinafter for convenience as Blowing Agent 11).

It is thus contemplated that the blowing agent of the present invention, including each of Blowing Agents 1-11, can include, in addition to each of the above-identified blowing agent(s), co-blowing agent including in one or more of the optional potential co-blowing agents as described below. In preferred embodiments, the present foamable compositions, foams, and foaming methods include a blowing agent as described according described herein, wherein the indicated blowing agent (including the compound or group of compound(s) specifically identified in each of Blowing Agent 1-11) is present in an amount, based upon the total weight of all blowing agent present, of at least about 50% by weight, or preferably at least about 60% by weight, preferably at least about 70% by weight, or preferably at least about 80% by weight, or preferably at least about 90% by weight, or preferably at least about 95% by weight, or preferably at least about 99% by weight, based on the total of all blowing agent components.

The blowing agent used in accordance with of the present invention also preferably consists essentially of one or more of 1234ze, 1234yf, 1336mzz, 1233zd and 1224ydf (referred to hereinafter for convenience as Blowing Agent 12); or consists essentially of one or more of trans1234ze, 1336mzz, trans1233zd and cis1224yd (referred to hereinafter for convenience as Blowing Agent 13); or consists essentially of one or more of trans1234ze, trans1336mzz, trans1233zd and cis1224yd (referred to hereinafter for convenience as Blowing Agent 14); or consists essentially of one or more of trans1234ze and trans1336mzz (referred to hereinafter for convenience as Blowing Agent 15); or consists essentially of trans1234ze (referred to hereinafter for convenience as Blowing Agent 16); or consists essentially of trans1336mzz (referred to hereinafter for convenience as Blowing Agent 17); or consists essentially of cis1336mzz (referred to hereinafter for convenience as Blowing Agent 18); or consists essentially of 1234yf (referred to hereinafter for convenience as Blowing Agent 19); or consists essentially of 1224yd (referred to hereinafter for convenience as Blowing Agent 20); or consists essentially of trans1233zd (referred to hereinafter for convenience as Blowing Agent 21).

It is contemplated and understood that blowing agent of the present invention, including each of Blowing Agents 1-21, can include one or more co-blowing agents which are not included in the indicated selection, provided that such co-blowing agent in the amount used does not interfere with or negate the ability to achieve relatively low-density foams as described herein, including each of Foams 1-4, and preferably further does not interfere with or negate the ability to achieve foam with mechanical strengths properties as described herein. It is contemplated, therefore, that given the teachings contained herein a person of skill in the art will be able to select, by way of example, one or more of the following potential co-blowing agents for use with a particular application without undue experimentation: one or more saturated hydrocarbons or hydrofluorocarbons (HFCs), particularly C4-C6 hydrocarbons or C1-C4 HFCs, that are known in the art. Examples of such HFC co-blowing agents include, but are not limited to, one or a combination of difluoromethane (HFC-32), fluoroethane (HFC-161), difluoroethane (HFC-152), trifluoroethane (HFC-143), tetrafluoroethane (HFC-134), pentafluoroethane (HFC-125), pentafluoropropane (HFC-245), hexafluoropropane (HFC-236), heptafluoropropane (HFC-227ea), pentafluorobutane (HFC-365), hexafluorobutane (HFC-356) and all isomers of all such HFC's. With respect to hydrocarbons, the present blowing agent compositions also may include in certain preferred embodiments, for example, iso, normal and/or cyclopentane and butane and/or isobutane. Other materials, such as water, CO2, CFCs (such as trichlorofluoromethane (CFC-11) and dichlorodifluoromethane (CFC-12)), hydrochlorocarbons (HCCs such as dichloroethylene (preferably trans-dichloroethylene), ethyl chloride and chloropropane), HCFCs, C1-C5 alcohols (such as, for example, ethanol and/or propanol and/or butanol), C1-C4 aldehydes, C1-C4 ketones, C1-C4 ethers (including ethers (such as dimethyl ether and diethyl ether), diethers (such as dimethoxy methane and diethoxy methane)), and methyl formate, organic acids (such as but not limited to formic acid), including combinations of any of these may be included, although such components are not necessarily preferred in many embodiments due to negative environmental impact.

The blowing agent used in accordance with the present invention also preferably consists of one or more of 1234ze, 1234yf, 1336mzz, 1233zd and 1224ydf (referred to hereinafter for convenience as Blowing Agent 22); or consists of one or more of trans1234ze, 1336mzz, trans1233zd and cis1224yd (referred to hereinafter for convenience as Blowing Agent 23); or consists of one or more of trans1234ze, trans1336mzz, trans1233zd and cis1224yd (referred to hereinafter for convenience as Blowing Agent 24); or consists of one or more of trans1234ze and trans1336mzz (referred to hereinafter for convenience as Blowing Agent 25); or consists of trans1234ze (referred to hereinafter for convenience as Blowing Agent 26); or consists of trans1336mzz (referred to hereinafter for convenience as Blowing Agent 27); or consists of cis1336mzz (referred to hereinafter for convenience as Blowing Agent 28); or consists of 1234yf (referred to hereinafter for convenience as Blowing Agent 29); or consists of 1224yd (referred to hereinafter for convenience as Blowing Agent 30); or consists of trans1233zd (referred to hereinafter for convenience as Blowing Agent 31).

### Foams and Foaming Process

The foams of the present invention, including each of Foams 1-4, or foam made from PEF polymer of the present invention, including Thermoplastic Polymer TPP1A-TPP22E, or any of the foams described in Examples 1-22, may generally be formed from a foamable composition of the present invention. In general, the foamable compositions of the present invention may be formed by combining a PEF polymer of the present invention, including each of Thermoplastic Polymer TPP1A-TPP22E, with a blowing agent of the present invention, including each of Blowing Agents 1-31.

Foamable compositions that are included within the present invention and which provide particular advantage in connection with forming the foams of the present invention, are described in the following Foamable Composition Tables (Table 3A and Table 3B), in which all numerical values in the table are understood to be preceded by the word “about” and in which the following terms used in the table have the following meanings:

CBAG1 means co-blowing agent selected from the group consisting of 1336mzz(Z), 1336mzzm(E), 1224yd(Z), 1233zd(E), 1234yf and combinations of two or more of these.

CBAG2 means co-blowing agent selected from the group consisting of water, CO2, C1-C6 hydrocarbons (HCs) HCFCs, C1-C5 HFCs, C2-C4 hydrohaloolefins, C1-C5 alcohols, C1-C4 aldehydes, C1-C4 ketones, C1-C4 ethers, C1-C4 esters, organic acids and combinations of two or more of these.

CCBAG3 means co-blowing agent selected from the group consisting of water, CO2, isobutane, n-butane, isopentane, cyclopentane, cyclohexane, trans-dichloroethylene, ethanol, propanol, butanol, acetone, dimethyl ether, diethyl ether, dimethoxy methane, diethoxy methane, methyl formate, difluoromethane (HFC-32), fluoroethane (HFC-161), 1,1-difluoroethane (HFC-152a), trifluoroethane (HFC-143), 1,1,1,2-tetrafluoroethane (HFC-134a), pentafluoroethane (HFC-125), pentafluoropropane (HFC-245), hexafluoropropane (HFC-236), heptafluoropropane (HFC-227ea), pentafluorobutane (HFC-365), hexafluorobutane (HFC-356), and combinations of any two or more of these.

NR means not required.

TABLE 3A
FOAMABLE COMPOSITION TABLE

| | Foamable Composition Components | | | | |
|---|---|---|---|---|---|
| | | Blowing Agent(s) and Amounts, wt % of All Blowing Agents | | | |
| Foamable | | Blowing | | Co Blowing | |
| Composition | Polymer, | Agent 1 | Wt % | Agent(s) | Wt % |
| Number | TPP No. | (BA1) | BA1 | (CB) | CB |
| FC1A1 | TPP1A | 1234ze(E) | 100 | NR | 0 |
| FC1B1 | TPP1B | 1234ze(E) | 100 | NR | 0 |
| FC1C1 | TPP1C | 1234ze(E) | 100 | NR | 0 |
| FC1D1 | TPP1D | 1234ze(E) | 100 | NR | 0 |
| FC1E1 | TPP1E | 1234ze(E) | 100 | NR | 0 |
| FC1A2 | TPP2A | 1234ze(E) | 100 | NR | 0 |
| FC1B2 | TPP2B | 1234ze(E) | 100 | NR | 0 |
| FC1C2 | TPP2C | 1234ze(E) | 100 | NR | 0 |
| FC1D2 | TPP2D | 1234ze(E) | 100 | NR | 0 |
| FC1E2 | TPP2E | 1234ze(E) | 100 | NR | 0 |
| FC1A3 | TPP3A | 1234ze(E) | 100 | NR | 0 |
| FC1B3 | TPP3B | 1234ze(E) | 100 | NR | 0 |
| FC1C3 | TPP3C | 1234ze(E) | 100 | NR | 0 |
| FC1D3 | TPP3D | 1234ze(E) | 100 | NR | 0 |
| FC1E3 | TPP3E | 1234ze(E) | 100 | NR | 0 |
| FC1A4 | TPP4A | 1234ze(E) | 100 | NR | 0 |
| FC1B4 | TPP4B | 1234ze(E) | 100 | NR | 0 |
| FC1C4 | TPP4C | 1234ze(E) | 100 | NR | 0 |
| FC1D4 | TPP4D | 1234ze(E) | 100 | NR | 0 |
| FC1E4 | TPP4E | 1234ze(E) | 100 | NR | 0 |
| FC1A5 | TPP5A | 1234ze(E) | 100 | NR | 0 |
| FC1B5 | TPP5B | 1234ze(E) | 100 | NR | 0 |
| FC1C5 | TPP5C | 1234ze(E) | 100 | NR | 0 |
| FC1D5 | TPP5D | 1234ze(E) | 100 | NR | 0 |
| FC1E5 | TPP5E | 1234ze(E) | 100 | NR | 0 |
| FC1A6 | TPP6A | 1234ze(E) | 100 | NR | 0 |
| FC1B6 | TPP6B | 1234ze(E) | 100 | NR | 0 |
| FC1C6 | TPP6C | 1234ze(E) | 100 | NR | 0 |
| FC1D6 | TPP6D | 1234ze(E) | 100 | NR | 0 |
| FC1E6 | TPP6E | 1234ze(E) | 100 | NR | 0 |
| FC2A1 | TPP1A | 1234ze(E) | 5-95 | CBAG1 | 5-95 |
| FC2B1 | TPP1B | 1234ze(E) | 5-95 | CBAG1 | 5-95 |
| FC2C1 | TPP1C | 1234ze(E) | 5-95 | CBAG1 | 5-95 |
| FC2D1 | TPP1D | 1234ze(E) | 5-95 | CBAG1 | 5-95 |
| FC2E1 | TPP1E | 1234ze(E) | 5-95 | CBAG1 | 5-95 |
| FC2A2 | TPP2A | 1234ze(E) | 5-95 | CBAG1 | 5-95 |
| FC2B2 | TPP2B | 1234ze(E) | 5-95 | CBAG1 | 5-95 |
| FC2C2 | TPP2C | 1234ze(E) | 5-95 | CBAG1 | 5-95 |
| FC2D2 | TPP2D | 1234ze(E) | 5-95 | CBAG1 | 5-95 |
| FC2E2 | TPP2E | 1234ze(E) | 5-95 | CBAG1 | 5-95 |
| FC2A3 | TPP3A | 1234ze(E) | 5-95 | CBAG1 | 5-95 |
| FC2B3 | TPP3B | 1234ze(E) | 5-95 | CBAG1 | 5-95 |
| FC2C3 | TPP3C | 1234ze(E) | 5-95 | CBAG1 | 5-95 |
| FC2D3 | TPP3D | 1234ze(E) | 5-95 | CBAG1 | 5-95 |
| FC2E3 | TPP3E | 1234ze(E) | 5-95 | CBAG1 | 5-95 |
| FC2A4 | TPP4A | 1234ze(E) | 5-95 | CBAG1 | 5-95 |
| FC2B4 | TPP4B | 1234ze(E) | 5-95 | CBAG1 | 5-95 |
| FC2C4 | TPP4C | 1234ze(E) | 5-95 | CBAG1 | 5-95 |
| FC2D4 | TPP4D | 1234ze(E) | 5-95 | CBAG1 | 5-95 |
| FC2E4 | TPP4E | 1234ze(E) | 5-95 | CBAG1 | 5-95 |
| FC2A5 | TPP5A | 1234ze(E) | 5-95 | CBAG1 | 5-95 |
| FC2B5 | TPP5B | 1234ze(E) | 5-95 | CBAG1 | 5-95 |
| FC2C5 | TPP5C | 1234ze(E) | 5-95 | CBAG1 | 5-95 |
| FC2D5 | TPP5D | 1234ze(E) | 5-95 | CBAG1 | 5-95 |
| FC2E5 | TPP5E | 1234ze(E) | 5-95 | CBAG1 | 5-95 |
| FC2A6 | TPP6A | 1234ze(E) | 5-95 | CBAG1 | 5-95 |
| FC2B6 | TPP6B | 1234ze(E) | 5-95 | CBAG1 | 5-95 |
| FC2C6 | TPP6C | 1234ze(E) | 5-95 | CBAG1 | 5-95 |
| FC2D6 | TPP6D | 1234ze(E) | 5-95 | CBAG1 | 5-95 |
| FC2E6 | TPP6E | 1234ze(E) | 5-95 | CBAG1 | 5-95 |
| FC3A1 | TPP1A | 1234ze(E) | 5-95 | CBAG2 | 5-95 |
| FC3B1 | TPP1B | 1234ze(E) | 5-95 | CBAG2 | 5-95 |
| FC3C1 | TPP1C | 1234ze(E) | 5-95 | CBAG2 | 5-95 |
| FC3D1 | TPP1D | 1234ze(E) | 5-95 | CBAG2 | 5-95 |
| FC3E1 | TPP1E | 1234ze(E) | 5-95 | CBAG2 | 5-95 |
| FC3A2 | TPP2A | 1234ze(E) | 5-95 | CBAG2 | 5-95 |
| FC3B2 | TPP2B | 1234ze(E) | 5-95 | CBAG2 | 5-95 |
| FC3C2 | TPP2C | 1234ze(E) | 5-95 | CBAG2 | 5-95 |
| FC3D2 | TPP2D | 1234ze(E) | 5-95 | CBAG2 | 5-95 |
| FC3E2 | TPP2E | 1234ze(E) | 5-95 | CBAG2 | 5-95 |
| FC3A3 | TPP3A | 1234ze(E) | 5-95 | CBAG2 | 5-95 |
| FC3B3 | TPP3B | 1234ze(E) | 5-95 | CBAG2 | 5-95 |
| FC3C3 | TPP3C | 1234ze(E) | 5-95 | CBAG2 | 5-95 |
| FC3D3 | TPP3D | 1234ze(E) | 5-95 | CBAG2 | 5-95 |
| FC3E3 | TPP3E | 1234ze(E) | 5-95 | CBAG2 | 5-95 |
| FC3A4 | TPP4A | 1234ze(E) | 5-95 | CBAG2 | 5-95 |
| FC3B4 | TPP4B | 1234ze(E) | 5-95 | CBAG2 | 5-95 |
| FC3C4 | TPP4C | 1234ze(E) | 5-95 | CBAG2 | 5-95 |
| FC3D4 | TPP4D | 1234ze(E) | 5-95 | CBAG2 | 5-95 |
| FC3E4 | TPP4E | 1234ze(E) | 5-95 | CBAG2 | 5-95 |
| FC3A5 | TPP5A | 1234ze(E) | 5-95 | CBAG2 | 5-95 |
| FC3B5 | TPP5B | 1234ze(E) | 5-95 | CBAG2 | 5-95 |
| FC3C5 | TPP5C | 1234ze(E) | 5-95 | CBAG2 | 5-95 |
| FC3D5 | TPP5D | 1234ze(E) | 5-95 | CBAG2 | 5-95 |
| FC3E5 | TPP5E | 1234ze(E) | 5-95 | CBAG2 | 5-95 |
| FC3A6 | TPP6A | 1234ze(E) | 5-95 | CBAG2 | 5-95 |
| FC3B6 | TPP6B | 1234ze(E) | 5-95 | CBAG2 | 5-95 |
| FC3C6 | TPP6C | 1234ze(E) | 5-95 | CBAG2 | 5-95 |
| FC3D6 | TPP6D | 1234ze(E) | 5-95 | CBAG2 | 5-95 |
| FC3E6 | TPP6E | 1234ze(E) | 5-95 | CBAG2 | 5-95 |
| FC4A1 | TPP1A | 1234ze(E) | 5-95 | CBAG3 | 5-95 |
| FC4B1 | TPP1B | 1234ze(E) | 5-95 | CBAG3 | 5-95 |
| FC4C1 | TPP1C | 1234ze(E) | 5-95 | CBAG3 | 5-95 |
| FC4D1 | TPP1D | 1234ze(E) | 5-95 | CBAG3 | 5-95 |
| FC4E1 | TPP1E | 1234ze(E) | 5-95 | CBAG3 | 5-95 |
| FC4A2 | TPP2A | 1234ze(E) | 5-95 | CBAG3 | 5-95 |
| FC4B2 | TPP2B | 1234ze(E) | 5-95 | CBAG3 | 5-95 |
| FC4C2 | TPP2C | 1234ze(E) | 5-95 | CBAG3 | 5-95 |
| FC4D2 | TPP2D | 1234ze(E) | 5-95 | CBAG3 | 5-95 |
| FC4E2 | TPP2E | 1234ze(E) | 5-95 | CBAG3 | 5-95 |
| FC4A3 | TPP3A | 1234ze(E) | 5-95 | CBAG3 | 5-95 |
| FC4B3 | TPP3B | 1234ze(E) | 5-95 | CBAG3 | 5-95 |
| FC4C3 | TPP3C | 1234ze(E) | 5-95 | CBAG3 | 5-95 |
| FC4D3 | TPP3D | 1234ze(E) | 5-95 | CBAG3 | 5-95 |
| FC4E3 | TPP3E | 1234ze(E) | 5-95 | CBAG3 | 5-95 |
| FC4A4 | TPP4A | 1234ze(E) | 5-95 | CBAG3 | 5-95 |
| FC4B4 | TPP4B | 1234ze(E) | 5-95 | CBAG3 | 5-95 |
| FC4C4 | TPP4C | 1234ze(E) | 5-95 | CBAG3 | 5-95 |
| FC4D4 | TPP4D | 1234ze(E) | 5-95 | CBAG3 | 5-95 |
| FC4E4 | TPP4E | 1234ze(E) | 5-95 | CBAG3 | 5-95 |
| FC4A5 | TPP5A | 1234ze(E) | 5-95 | CBAG3 | 5-95 |
| FC4B5 | TPP5B | 1234ze(E) | 5-95 | CBAG3 | 5-95 |
| FC4C5 | TPP5C | 1234ze(E) | 5-95 | CBAG3 | 5-95 |
| FC4D5 | TPP5D | 1234ze(E) | 5-95 | CBAG3 | 5-95 |
| FC4E5 | TPP5E | 1234ze(E) | 5-95 | CBAG3 | 5-95 |
| FC4A6 | TPP6A | 1234ze(E) | 5-95 | CBAG3 | 5-95 |
| FC4B6 | TPP6B | 1234ze(E) | 5-95 | CBAG3 | 5-95 |
| FC4C6 | TPP6C | 1234ze(E) | 5-95 | CBAG3 | 5-95 |
| FC4D6 | TPP6D | 1234ze(E) | 5-95 | CBAG3 | 5-95 |
| FC4E6 | TPP6E | 1234ze(E) | 5-95 | CBAG3 | 5-95 |
| FC5A1 | TPP1A | 1234ze(E) | 5-95 | cyclopentane | 5-95 |
| FC5B1 | TPP1B | 1234ze(E) | 5-95 | cyclopentane | 5-95 |
| FC5C1 | TPP1C | 1234ze(E) | 5-95 | cyclopentane | 5-95 |
| FC5D1 | TPP1D | 1234ze(E) | 5-95 | cyclopentane | 5-95 |
| FC5E1 | TPP1E | 1234ze(E) | 5-95 | cyclopentane | 5-95 |
| FC5A2 | TPP2A | 1234ze(E) | 5-95 | cyclopentane | 5-95 |
| FC5B2 | TPP2B | 1234ze(E) | 5-95 | cyclopentane | 5-95 |
| FC5C2 | TPP2C | 1234ze(E) | 5-95 | cyclopentane | 5-95 |
| FC5D2 | TPP2D | 1234ze(E) | 5-95 | cyclopentane | 5-95 |
| FC5E2 | TPP2E | 1234ze(E) | 5-95 | cyclopentane | 5-95 |
| FC5A3 | TPP3A | 1234ze(E) | 5-95 | cyclopentane | 5-95 |
| FC5B3 | TPP3B | 1234ze(E) | 5-95 | cyclopentane | 5-95 |
| FC5C3 | TPP3C | 1234ze(E) | 5-95 | cyclopentane | 5-95 |
| FC5D3 | TPP3D | 1234ze(E) | 5-95 | cyclopentane | 5-95 |
| FC5E3 | TPP3E | 1234ze(E) | 5-95 | cyclopentane | 5-95 |
| FC5A4 | TPP4A | 1234ze(E) | 5-95 | cyclopentane | 5-95 |
| FC5B4 | TPP4B | 1234ze(E) | 5-95 | cyclopentane | 5-95 |
| FC5C4 | TPP4C | 1234ze(E) | 5-95 | cyclopentane | 5-95 |
| FC5D4 | TPP4D | 1234ze(E) | 5-95 | cyclopentane | 5-95 |
| FC5E4 | TPP4E | 1234ze(E) | 5-95 | cyclopentane | 5-95 |
| FC5A5 | TPP5A | 1234ze(E) | 5-95 | cyclopentane | 5-95 |
| FC5B5 | TPP5B | 1234ze(E) | 5-95 | cyclopentane | 5-95 |
| FC5C5 | TPP5C | 1234ze(E) | 5-95 | cyclopentane | 5-95 |
| FC5D5 | TPP5D | 1234ze(E) | 5-95 | cyclopentane | 5-95 |
| FC5E5 | TPP5E | 1234ze(E) | 5-95 | cyclopentane | 5-95 |
| FC5A6 | TPP6A | 1234ze(E) | 5-95 | cyclopentane | 5-95 |
| FC5B6 | TPP6B | 1234ze(E) | 5-95 | cyclopentane | 5-95 |
| FC5C6 | TPP6C | 1234ze(E) | 5-95 | cyclopentane | 5-95 |
| FC5D6 | TPP6D | 1234ze(E) | 5-95 | cyclopentane | 5-95 |
| FC5E6 | TPP6E | 1234ze(E) | 5-95 | cyclopentane | 5-95 |
| FC6A1 | TPP1A | 1234ze(E) | 5-95 | HFC-134a | 5-95 |
| FC6B1 | TPP1B | 1234ze(E) | 5-95 | HFC-134a | 5-95 |
| FC6C1 | TPP1C | 1234ze(E) | 5-95 | HFC-134a | 5-95 |
| FC6D1 | TPP1D | 1234ze(E) | 5-95 | HFC-134a | 5-95 |
| FC6E1 | TPP1E | 1234ze(E) | 5-95 | HFC-134a | 5-95 |
| FC6A2 | TPP2A | 1234ze(E) | 5-95 | HFC-134a | 5-95 |
| FC6B2 | TPP2B | 1234ze(E) | 5-95 | HFC-134a | 5-95 |
| FC6C2 | TPP2C | 1234ze(E) | 5-95 | HFC-134a | 5-95 |
| FC6D2 | TPP2D | 1234ze(E) | 5-95 | HFC-134a | 5-95 |
| FC6E2 | TPP2E | 1234ze(E) | 5-95 | HFC-134a | 5-95 |
| FC6A3 | TPP3A | 1234ze(E) | 5-95 | HFC-134a | 5-95 |
| FC6B3 | TPP3B | 1234ze(E) | 5-95 | HFC-134a | 5-95 |
| FC6C3 | TPP3C | 1234ze(E) | 5-95 | HFC-134a | 5-95 |
| FC6D3 | TPP3D | 1234ze(E) | 5-95 | HFC-134a | 5-95 |
| FC6E3 | TPP3E | 1234ze(E) | 5-95 | HFC-134a | 5-95 |
| FC6A4 | TPP4A | 1234ze(E) | 5-95 | HFC-134a | 5-95 |
| FC6B4 | TPP4B | 1234ze(E) | 5-95 | HFC-134a | 5-95 |
| FC6C4 | TPP4C | 1234ze(E) | 5-95 | HFC-134a | 5-95 |
| FC6D4 | TPP4D | 1234ze(E) | 5-95 | HFC-134a | 5-95 |
| FC6E4 | TPP4E | 1234ze(E) | 5-95 | HFC-134a | 5-95 |
| FC6A5 | TPP5A | 1234ze(E) | 5-95 | HFC-134a | 5-95 |
| FC6B5 | TPP5B | 1234ze(E) | 5-95 | HFC-134a | 5-95 |
| FC6C5 | TPP5C | 1234ze(E) | 5-95 | HFC-134a | 5-95 |
| FC6D5 | TPP5D | 1234ze(E) | 5-95 | HFC-134a | 5-95 |
| FC6E5 | TPP5E | 1234ze(E) | 5-95 | HFC-134a | 5-95 |
| FC6A6 | TPP6A | 1234ze(E) | 5-95 | HFC-134a | 5-95 |
| FC6B6 | TPP6B | 1234ze(E) | 5-95 | HFC-134a | 5-95 |
| FC6C6 | TPP6C | 1234ze(E) | 5-95 | HFC-134a | 5-95 |
| FC6D6 | TPP6D | 1234ze(E) | 5-95 | HFC-134a | 5-95 |
| FC6E6 | TPP6E | 1234ze(E) | 5-95 | HFC-134a | 5-95 |
| FC7A1 | TPP1A | 1234ze(E) | 5-95 | CO₂ | 5-95 |
| FC7B1 | TPP1B | 1234ze(E) | 5-95 | CO₂ | 5-95 |
| FC7C1 | TPP1C | 1234ze(E) | 5-95 | CO₂ | 5-95 |
| FC7D1 | TPP1D | 1234ze(E) | 5-95 | CO₂ | 5-95 |
| FC7E1 | TPP1E | 1234ze(E) | 5-95 | CO₂ | 5-95 |
| FC7A2 | TPP2A | 1234ze(E) | 5-95 | CO₂ | 5-95 |
| FC7B2 | TPP2B | 1234ze(E) | 5-95 | CO₂ | 5-95 |
| FC7C2 | TPP2C | 1234ze(E) | 5-95 | CO₂ | 5-95 |
| FC7D2 | TPP2D | 1234ze(E) | 5-95 | CO₂ | 5-95 |
| FC7E2 | TPP2E | 1234ze(E) | 5-95 | CO₂ | 5-95 |
| FC7A3 | TPP3A | 1234ze(E) | 5-95 | CO₂ | 5-95 |
| FC7B3 | TPP3B | 1234ze(E) | 5-95 | CO₂ | 5-95 |
| FC7C3 | TPP3C | 1234ze(E) | 5-95 | CO₂ | 5-95 |
| FC7D3 | TPP3D | 1234ze(E) | 5-95 | CO₂ | 5-95 |
| FC7E3 | TPP3E | 1234ze(E) | 5-95 | CO₂ | 5-95 |
| FC7A4 | TPP4A | 1234ze(E) | 5-95 | CO₂ | 5-95 |
| FC7B4 | TPP4B | 1234ze(E) | 5-95 | CO₂ | 5-95 |
| FC7C4 | TPP4C | 1234ze(E) | 5-95 | CO₂ | 5-95 |
| FC7D4 | TPP4D | 1234ze(E) | 5-95 | CO₂ | 5-95 |
| FC7E4 | TPP4E | 1234ze(E) | 5-95 | CO₂ | 5-95 |
| FC7A5 | TPP5A | 1234ze(E) | 5-95 | CO₂ | 5-95 |
| FC7B5 | TPP5B | 1234ze(E) | 5-95 | CO₂ | 5-95 |
| FC7C5 | TPP5C | 1234ze(E) | 5-95 | CO₂ | 5-95 |
| FC7D5 | TPP5D | 1234ze(E) | 5-95 | CO₂ | 5-95 |
| FC7E5 | TPP5E | 1234ze(E) | 5-95 | CO₂ | 5-95 |
| FC7A6 | TPP6A | 1234ze(E) | 5-95 | CO₂ | 5-95 |
| FC7B6 | TPP6B | 1234ze(E) | 5-95 | CO₂ | 5-95 |
| FC7C6 | TPP6C | 1234ze(E) | 5-95 | CO₂ | 5-95 |
| FC7D6 | TPP6D | 1234ze(E) | 5-95 | CO₂ | 5-95 |
| FC7E6 | TPP6E | 1234ze(E) | 5-95 | CO₂ | 5-95 |
| FC8A1 | TPP1A | 1234ze(E) | 5-95 | 1233zd(E) | 5-95 |
| FC8B1 | TPP1B | 1234ze(E) | 5-95 | 1233zd(E) | 5-95 |
| FC8C1 | TPP1C | 1234ze(E) | 5-95 | 1233zd(E) | 5-95 |
| FC8D1 | TPP1D | 1234ze(E) | 5-95 | 1233zd(E) | 5-95 |
| FC8E1 | TPP1E | 1234ze(E) | 5-95 | 1233zd(E) | 5-95 |
| FC8A2 | TPP2A | 1234ze(E) | 5-95 | 1233zd(E) | 5-95 |
| FC8B2 | TPP2B | 1234ze(E) | 5-95 | 1233zd(E) | 5-95 |
| FC8C2 | TPP2C | 1234ze(E) | 5-95 | 1233zd(E) | 5-95 |
| FC8D2 | TPP2D | 1234ze(E) | 5-95 | 1233zd(E) | 5-95 |
| FC8E2 | TPP2E | 1234ze(E) | 5-95 | 1233zd(E) | 5-95 |
| FC8A3 | TPP3A | 1234ze(E) | 5-95 | 1233zd(E) | 5-95 |
| FC8B3 | TPP3B | 1234ze(E) | 5-95 | 1233zd(E) | 5-95 |
| FC8C3 | TPP3C | 1234ze(E) | 5-95 | 1233zd(E) | 5-95 |
| FC8D3 | TPP3D | 1234ze(E) | 5-95 | 1233zd(E) | 5-95 |
| FC8E3 | TPP3E | 1234ze(E) | 5-95 | 1233zd(E) | 5-95 |
| FC8A4 | TPP4A | 1234ze(E) | 5-95 | 1233zd(E) | 5-95 |
| FC8B4 | TPP4B | 1234ze(E) | 5-95 | 1233zd(E) | 5-95 |
| FC8C4 | TPP4C | 1234ze(E) | 5-95 | 1233zd(E) | 5-95 |
| FC8D4 | TPP4D | 1234ze(E) | 5-95 | 1233zd(E) | 5-95 |
| FC8E4 | TPP4E | 1234ze(E) | 5-95 | 1233zd(E) | 5-95 |
| FC8A5 | TPP5A | 1234ze(E) | 5-95 | 1233zd(E) | 5-95 |
| FC8B5 | TPP5B | 1234ze(E) | 5-95 | 1233zd(E) | 5-95 |
| FC8C5 | TPP5C | 1234ze(E) | 5-95 | 1233zd(E) | 5-95 |
| FC8D5 | TPP5D | 1234ze(E) | 5-95 | 1233zd(E) | 5-95 |
| FC8E5 | TPP5E | 1234ze(E) | 5-95 | 1233zd(E) | 5-95 |
| FC8A6 | TPP6A | 1234ze(E) | 5-95 | 1233zd(E) | 5-95 |
| FC8B6 | TPP6B | 1234ze(E) | 5-95 | 1233zd(E) | 5-95 |
| FC8C6 | TPP6C | 1234ze(E) | 5-95 | 1233zd(E) | 5-95 |
| FC8D6 | TPP6D | 1234ze(E) | 5-95 | 1233zd(E) | 5-95 |
| FC8E6 | TPP6E | 1234ze(E) | 5-95 | 1233zd(E) | 5-95 |

TABLE 3BA
FOAMABLE COMPOSITION TABLE

| | Foamable Composition Components | | | | |
|---|---|---|---|---|---|
| | | Blowing Agent(s) and Amounts, wt % of All Blowing Agents | | | |
| Foamable | | Blowing | | Co Blowing | |
| Composition | Polymer, | Agent 1 | Wt % | Agent(s) | Wt % |
| Number | TPP No. | (BA1) | BA1 | (CB) | CB |
| FC9A1 | TPP17A | 1234ze(E) | 100 | NR | 0 |
| FC9B1 | TPP17B | 1234ze(E) | 100 | NR | 0 |
| FC9C1 | TPP17C | 1234ze(E) | 100 | NR | 0 |
| FC9D1 | TPP17D | 1234ze(E) | 100 | NR | 0 |
| FC9E1 | TPP17E | 1234ze(E) | 100 | NR | 0 |
| FC9A2 | TPP18A | 1234ze(E) | 100 | NR | 0 |
| FC9B2 | TPP18B | 1234ze(E) | 100 | NR | 0 |
| FC9C2 | TPP18C | 1234ze(E) | 100 | NR | 0 |
| FC9D2 | TPP18D | 1234ze(E) | 100 | NR | 0 |
| FC9E2 | TPP18E | 1234ze(E) | 100 | NR | 0 |
| FC9A3 | TPP18A | 1234ze(E) | 100 | NR | 0 |
| FC9B3 | TPP18B | 1234ze(E) | 100 | NR | 0 |
| FC9C3 | TPP18C | 1234ze(E) | 100 | NR | 0 |
| FC9D3 | TPP18 | 1234ze(E) | 100 | NR | 0 |
| FC9E3 | TPP18 | 1234ze(E) | 100 | NR | 0 |
| FC9A4 | TPP19A | 1234ze(E) | 100 | NR | 0 |
| FC9B4 | TPP19B | 1234ze(E) | 100 | NR | 0 |
| FC9C4 | TPP19C | 1234ze(E) | 100 | NR | 0 |
| FC9D4 | TPP19D | 1234ze(E) | 100 | NR | 0 |
| FC9E4 | TPP19E | 1234ze(E) | 100 | NR | 0 |
| FC9A5 | TPP20A | 1234ze(E) | 100 | NR | 0 |
| FC9B5 | TPP20B | 1234ze(E) | 100 | NR | 0 |
| FC9C5 | TPP20C | 1234ze(E) | 100 | NR | 0 |
| FC9D5 | TPP20D | 1234ze(E) | 100 | NR | 0 |
| FC9E5 | TPP20E | 1234ze(E) | 100 | NR | 0 |
| FC9A6 | TPP17A | 1234ze(E) | 100 | NR | 0 |
| FC9B6 | TPP17B | 1234ze(E) | 100 | NR | 0 |
| FC9C6 | TPP17C | 1234ze(E) | 100 | NR | 0 |
| FC9D6 | TPP17D | 1234ze(E) | 100 | NR | 0 |
| FC9E6 | TPP17E | 1234ze(E) | 100 | NR | 0 |
| FC10A1 | TPP17A | 1234ze(E) | 5-95 | CBAG1 | 5-95 |
| FC10B1 | TPP17B | 1234ze(E) | 5-95 | CBAG1 | 5-95 |
| FC10C1 | TPP17C | 1234ze(E) | 5-95 | CBAG1 | 5-95 |
| FC10D1 | TPP17D | 1234ze(E) | 5-95 | CBAG1 | 5-95 |
| FC10E1 | TPP17E | 1234ze(E) | 5-95 | CBAG1 | 5-95 |
| FC10A2 | TPP18A | 1234ze(E) | 5-95 | CBAG1 | 5-95 |
| FC10B2 | TPP18B | 1234ze(E) | 5-95 | CBAG1 | 5-95 |
| FC10C2 | TPP18C | 1234ze(E) | 5-95 | CBAG1 | 5-95 |
| FC10D2 | TPP18D | 1234ze(E) | 5-95 | CBAG1 | 5-95 |
| FC10E2 | TPP18E | 1234ze(E) | 5-95 | CBAG1 | 5-95 |
| FC10A3 | TPP18A | 1234ze(E) | 5-95 | CBAG1 | 5-95 |
| FC10B3 | TPP18B | 1234ze(E) | 5-95 | CBAG1 | 5-95 |
| FC10C3 | TPP18C | 1234ze(E) | 5-95 | CBAG1 | 5-95 |
| FC10D3 | TPP19D | 1234ze(E) | 5-95 | CBAG1 | 5-95 |
| FC10E3 | TPP19E | 1234ze(E) | 5-95 | CBAG1 | 5-95 |
| FC10A4 | TPP20A | 1234ze(E) | 5-95 | CBAG1 | 5-95 |
| FC10B4 | TPP20B | 1234ze(E) | 5-95 | CBAG1 | 5-95 |
| FC10C4 | TPP20C | 1234ze(E) | 5-95 | CBAG1 | 5-95 |
| FC10D4 | TPP20D | 1234ze(E) | 5-95 | CBAG1 | 5-95 |
| FC10E4 | TPP20E | 1234ze(E) | 5-95 | CBAG1 | 5-95 |
| FC10A5 | TPP20A | 1234ze(E) | 5-95 | CBAG1 | 5-95 |
| FC10B5 | TPP20B | 1234ze(E) | 5-95 | CBAG1 | 5-95 |
| FC10C5 | TPP20C | 1234ze(E) | 5-95 | CBAG1 | 5-95 |
| FC10D5 | TPP20D | 1234ze(E) | 5-95 | CBAG1 | 5-95 |
| FC10E5 | TPP20E | 1234ze(E) | 5-95 | CBAG1 | 5-95 |
| FC10A6 | TPP21A | 1234ze(E) | 5-95 | CBAG1 | 5-95 |
| FC10B6 | TPP21B | 1234ze(E) | 5-95 | CBAG1 | 5-95 |
| FC10C6 | TPP21C | 1234ze(E) | 5-95 | CBAG1 | 5-95 |
| FC10D6 | TPP21D | 1234ze(E) | 5-95 | CBAG1 | 5-95 |
| FC10E6 | TPP21E | 1234ze(E) | 5-95 | CBAG1 | 5-95 |
| FC11A1 | TPP17A | 1234ze(E) | 5-95 | CBAG2 | 5-95 |
| FC11B1 | TPP17B | 1234ze(E) | 5-95 | CBAG2 | 5-95 |
| FC11C1 | TPP17C | 1234ze(E) | 5-95 | CBAG2 | 5-95 |
| FC11D1 | TPP17D | 1234ze(E) | 5-95 | CBAG2 | 5-95 |
| FC11E1 | TPP17E | 1234ze(E) | 5-95 | CBAG2 | 5-95 |
| FC11A2 | TPP18A | 1234ze(E) | 5-95 | CBAG2 | 5-95 |
| FC11B2 | TPP18B | 1234ze(E) | 5-95 | CBAG2 | 5-95 |
| FC11C2 | TPP18C | 1234ze(E) | 5-95 | CBAG2 | 5-95 |
| FC11D2 | TPP18D | 1234ze(E) | 5-95 | CBAG2 | 5-95 |
| FC11E2 | TPP18E | 1234ze(E) | 5-95 | CBAG2 | 5-95 |
| FC11A3 | TPP19A | 1234ze(E) | 5-95 | CBAG2 | 5-95 |
| FC11B3 | TPP19B | 1234ze(E) | 15-95 | CBAG2 | 5-95 |
| FC11C3 | TPP19C | 1234ze(E) | 5-95 | CBAG2 | 5-95 |
| FC11D3 | TPP19D | 1234ze(E) | 5-95 | CBAG2 | 5-95 |
| FC11E3 | TPP19E | 1234ze(E) | 5-95 | CBAG2 | 5-95 |
| FC11A4 | TPP20A | 1234ze(E) | 5-95 | CBAG2 | 5-95 |
| FC11B4 | TPP20B | 1234ze(E) | 5-95 | CBAG2 | 5-95 |
| FC11C4 | TPP20C | 1234ze(E) | 5-95 | CBAG2 | 5-95 |
| FC11D4 | TPP20D | 1234ze(E) | 5-95 | CBAG2 | 5-95 |
| FC11E4 | TPP20E | 1234ze(E) | 5-95 | CBAG2 | 5-95 |
| FC11A5 | TPP21A | 1234ze(E) | 5-95 | CBAG2 | 5-95 |
| FC11B5 | TPP21B | 1234ze(E) | 5-95 | CBAG2 | 5-95 |
| FC11C5 | TPP21C | 1234ze(E) | 5-95 | CBAG2 | 5-95 |
| FC11D5 | TPP21D | 1234ze(E) | 5-95 | CBAG2 | 5-95 |
| FC11E5 | TPP21E | 1234ze(E) | 5-95 | CBAG2 | 5-95 |
| FC11A6 | TPP22A | 1234ze(E) | 5-95 | CBAG2 | 5-95 |
| FC11B6 | TPP22B | 1234ze(E) | 5-95 | CBAG2 | 5-95 |
| FC11C6 | TPP22C | 1234ze(E) | 5-95 | CBAG2 | 5-95 |
| FC11D6 | TPP22D | 1234ze(E) | 5-95 | CBAG2 | 5-95 |
| FC11E6 | TPP22E | 1234ze(E) | 5-95 | CBAG2 | 5-95 |

It is contemplated that any one or more of a variety of known techniques for forming a thermoplastic foam can be used in view of the disclosures contained herein to form a foam of the present invention, including each of Foams 1-4, and Formable Compositions 1-11, all such techniques and all foams formed thereby or within the broad scope of the present invention. For clarity, it will be noted that definition of the foams in the Table below all begin with only the letter F, in contrast to the foams defined by the paragraphs in the summary above, which begin with the capitalized phrase Foamable Composition.

In general, the forming step involves first introducing into a PEF polymer of the present invention, including each of TPP1-TPP22, a blowing agent of the present invention, including each of Blowing Agents 1-31, to form a foamable PEF composition comprising PEF and blowing agent. One example of a preferred method for forming a foamable PEF composition of the present invention is to plasticize the PEF, preferably comprising heating the PEF to its melt temperature, preferably above its melt temperature, and thereafter exposing the PEF melt to the blowing agent under conditions effective to incorporate (preferably by solubilizing) the desired amount of blowing agent into the polymer melt.

In preferred embodiments, the foaming methods of the present invention comprise providing a foamable composition of the present invention, including each of FC1-FC11 and foaming the provided foamable composition. In preferred embodiments, the foaming methods of the present invention comprising providing a foamable composition of the present invention, including each of FC1-FC11, and extruding the provided foamable composition to form a foam of the present invention, including each of Foams 1-4 and each of foams F1-F8.

Foaming processes of the present invention can include batch, semi-batch, continuous processes, and combinations of two or more of these. Batch processes generally involve preparation of at least one portion of the foamable polymer composition, including each of FC1-FC11, in a storable state and then using that portion of foamable polymer composition at some future point in time to prepare a foam. Semi-batch process involves preparing at least a portion of a foamable polymer composition, including each of FC1-FC11, and intermittently expanding that foamable polymer composition into a foam including each of Foams 1-4 and each of foams F1-F11, all in a single process. For example, U.S. Pat. No. 4,323,528, herein incorporated by reference, discloses a process for making thermoplastic foams via an accumulating extrusion process. The present invention thus includes processes that comprises: 1) mixing homopolymeric PEF thermoplastic polymer and/or copolymeric PEF foam (preferably with PET copolymer), including each of TPP1-TPP22, a blowing agent composition of the present invention, including each of Blowing Agents 1-31, and preferably one or more foaming additives, under conditions to form a foamable PEF composition, wherein at least a substantial portion, and preferably substantially all, of said blowing agent composition is dissolved in the polymeric components of the foamable composition; 2) extruding the foamable PEF composition, including each of FC1-FC11, by maintaining said foamable PEF composition in a holding zone maintained at temperature(s) and pressure(s) which do not allow the foamable composition to foam, where the end of the holding zone preferably comprises a die defining an orifice opening into a zone of lower pressure and temperature, at which the foamable polymer composition, including each of FC1-FC11, foams and an openable gate closing the die orifice; 3) periodically opening the gate while substantially concurrently applying mechanical pressure by means of a movable ram on the foamable polymer composition, including each of FC1-FC11, to eject it from the holding zone through the die orifice into the zone of lower pressure and temperature, and 4) allowing the ejected foamable polymer composition to expand, under the influence of the blowing agent, to form the foam, including each of Foams 1-4 and each of foams F1-F8.

The present invention also can use continuous processes for forming the foam. By way of example such a continuous process involves forming a foamable PEF composition, including each of FC1-FC11, and then expanding that foamable PEF composition without substantial interruption. For example, a foamable PEF composition, including each of FC1-FC11, may be prepared in an extruder by heating the selected PEF homopolymeric and/or copolymeric resin, including each of TPP1-TPP22, to form a PEF melt, incorporating into the PEF melt a blowing agent composition of the present invention, including each of Blowing Agents 1-31 and optionally but preferably one or more foaming additives, preferably by solubilizing the blowing agent composition, and additives when present, into the PEF melt, at an initial pressure to form a foamable PEF composition comprising a substantially homogeneous combination of PEF and blowing agent, including each of FC1-FC11, and then extruding that foamable PEF composition through a die into a zone at a selected foaming pressure and allowing the foamable PEF composition to expand into a foam, including each of Foams 1-4 and each of foams F1-F8 described below, under the influence of the blowing agent. Optionally, the foamable PEF composition which comprises the PEF homopolymer and/or copolymer, including each of FC1-FC11, and the incorporated blowing agent, including each of Blowing Agents 1-31 and foaming additives when present, may be partially cooled prior to extruding the composition through the die to enhance certain desired properties of the resulting foam, including each of Foams 1-6 and each of foams F1-F8.

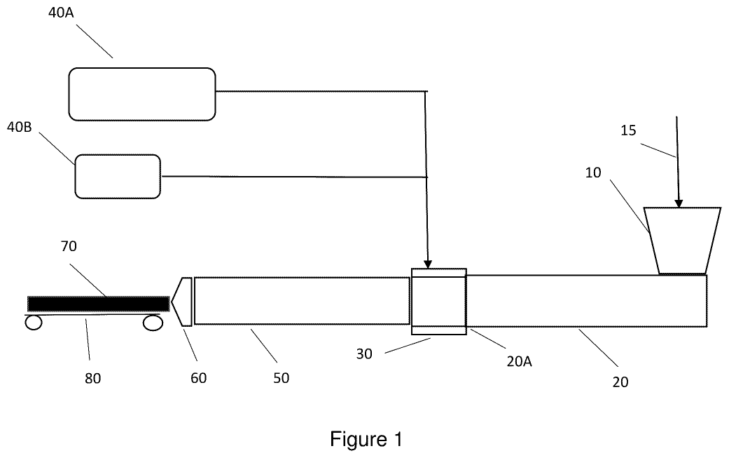

The methods can be carried out, by way of example, using extrusion equipment of the general type disclosed in FIG. 1. In particular, the extrusion apparatus can include a raw material feed hopper 10 for holding the PEF polymer 15 of the present invention, including each of TPP1-TPP22, and one or more optional components (which may be added with the PEF in the hopper or optionally elsewhere in the process depending on the particular needs of the user). The feed materials 15, which may include some portion of the blowing agent and/or foaming additives, can be charged to the hopper 10 and delivered to the screw extruder 20. The extruder 20 generally has a cooling section 50 located upstream of the die 60 and in which cooling of the foamable composition can take place and a mixing section 30 upstream of the cooling section into which blowing agent, including each of Blowing Agents 1-31, and optionally foaming additives can be added. The extruder preferably includes thermocouples (not shown) located at three points along the length thereof and a pressure sensor (not shown), preferably intermediate between at the discharge end of the extruder mixing section 30. One or more metering pumps 40A and 40B are preferably provided for introducing the one or more of the blowing agent components, and preferably one or more foam additives, into the PEF melt into the mixer section 30. Sensors (not shown) can be included for monitoring the temperature and pressure of the mixer section 30. The mixer section 30 can then discharge the foamable composition melt of the present invention, including each of FC1-FC11, into a one or more melt coolers 50, preferably oriented in series, with temperature sensors (not shown) located in each cooler to monitor the melt temperature. The melt is then extruded through a die 60, which also has temperature and pressure sensors (not shown) for monitoring the pressure and temperature at the die. The die pressure and temperature can be varied, according to the needs of each particular extrusion application to produce a foam 70 of the present invention, including each of including each of Foams 1-4 and each of foams F1-F8 described below. A melt pump is preferably provided before the die plate to help maintain desired pressure. The foam can then be carried away from the extrusion equipment by a conveyor belt 80.

The foamable polymer compositions of the present invention, including each of FC1-FC11, may optionally contain additional additives, including but not limited to chain extension agents (including preferred chain extension agents as described hereinafter and in the Examples), chain branching agents (including preferred chain branching agents as described hereinafter and in the Examples), nucleating agents, cell-controlling agents, glass and carbon fibers, dyes, pigments, fillers, antioxidants, extrusion aids, stabilizing agents, antistatic agents, fire retardants, IR attenuating agents and thermally insulating additives. Nucleating agents include, among others, materials such as talc, calcium carbonate, sodium benzoate, and chemical blowing agents such azodicarbonamide or sodium bicarbonate and citric acid. IR attenuating agents and thermally insulating additives can include carbon black, graphite, silicon dioxide, metal flake or powder, among others. Flame retardants can include, among others, brominated materials such as hexabromocyclodecane and polybrominated biphenyl ether. Each of the above-noted additional optional additives can be introduced into the foam at various times and that various locations in the process according to known techniques, and all such additives and methods of addition or within the broad scope of the present invention.

### Foams

In preferred embodiments, the foams of the present invention are formed in a commercial extrusion apparatus and have the properties as indicated in the following Table 4, with the values being measured as described in the Examples hereof:

TABLE 4

| | | First | Second | First | Second |
|---|---|---|---|---|---|
| | Broad | Intermediate | Intermediate | Narrow | Narrow |
| | Range | Range | Range | Range | Range |
| Foam property | | | | | |
| Foam density, g/cc | 0.04-.35 | .06-0.14 | .06-0.14 | 0.06-0.11 | 0.06-0.11 |
| (ISO 845) | | | | | |
| Compressive | 0.5-11 | 0.6-4.9 | 0.9-5.0 | 0.6-2.5 | 0.9-3.5 |
| Strength | | | | | |
| (perpendicular to | | | | | |
| the plane for batch | | | | | |
| and extrusion | | | | | |
| direction for | | | | | |
| continuous and for | | | | | |
| foam samples | | | | | |
| without weld lines | | | | | |
| or seams) (ISO | | | | | |
| 844), Mpa | | | | | |
| Tensile strength | 1.8-6.2 | 2-4.0 | 2.2-5.0 | 2.0-3.1 | 2.2-4.7 |
| perpendicular to the | | | | | |
| plane for batch and | | | | | |
| extrusion direction | | | | | |
| for continuous and | | | | | |
| for foam samples | | | | | |
| without weld lines | | | | | |
| or seams (ASTM | | | | | |
| C297), Mpa | | | | | |
| Average Cell Size, | 10-200 | 20-150 | 20-150 | 20-100 | 20-100 |
| (SEM) | | | | | |

Foams that are included within the present invention and which provide particular advantage are described in the following Table 5-Foam Table, and in which all numerical values in the table are understood to be preceded by the word “about” and in which the designation NR means “not required.”

TABLE 5
FOAM TABLE

| | | Foam Properties | | | |
|---|---|---|---|---|---|
| | | | | | Tensile |
| | | | | Compressive | Strength, |
| | Foamable | % | | Strength, | ((ASTM |
| Foam | Compo- | Closed | Density, | (ISO 844), | C297), |
| Number | sition, No. | Cell | g/cc³ | megapascal | megapascal |
| F1A1A | FC1A1 | >25 | NR | NR | NR |
| F1B1A | FC1B1 | >25 | NR | NR | NR |
| F1C1A | FC1C1 | >25 | NR | NR | NR |
| F1D1A | FC1D1 | >25 | NR | NR | NR |
| F1E1A | FC1E1 | >25 | NR | NR | NR |
| F1A2A | FC1A2 | >25 | NR | NR | NR |
| F1B2A | FC1B2 | >25 | NR | NR | NR |
| F1C2A | FC1C2 | >25 | NR | NR | NR |
| F1D2A | FC1D2 | >25 | NR | NR | NR |
| F1E2A | FC1E2 | >25 | NR | NR | NR |
| F1A3A | FC1A3 | >25 | NR | NR | NR |
| F1B3A | FC1B3 | >25 | NR | NR | NR |
| F1C3A | FC1C3 | >25 | NR | NR | NR |
| F1D3A | FC1D3 | >25 | NR | NR | NR |
| F1E3A | FC1E3 | >25 | NR | NR | NR |
| F1A4A | FC1A4 | >25 | NR | NR | NR |
| F1B4A | FC1B4 | >25 | NR | NR | NR |
| F1C4A | FC1C4 | >25 | NR | NR | NR |
| F1D4A | FC1D4 | >25 | NR | NR | NR |
| F1E4A | FC1E4 | >25 | NR | NR | NR |
| F1A5A | FC1A5 | >25 | NR | NR | NR |
| F1B5A | FC1B5 | >25 | NR | NR | NR |
| F1C5A | FC1C5 | >25 | NR | NR | NR |
| F1D5A | FC1D5 | >25 | NR | NR | NR |
| F1E5A | FC1E5 | >25 | NR | NR | NR |
| F1A6A | FC1A6 | >25 | NR | NR | NR |
| F1B6A | FC1B6 | >25 | NR | NR | NR |
| F1C6A | FC1C6 | >25 | NR | NR | NR |
| F1D6A | FC1D6 | >25 | NR | NR | NR |
| F1E6A | FC1E6 | >25 | NR | NR | NR |
| F2A1A | FC2A1 | >25 | NR | NR | NR |
| F2B1A | FC2B1 | >25 | NR | NR | NR |
| F2C1A | FC2C1 | >25 | NR | NR | NR |
| F2D1A | FC2D1 | >25 | NR | NR | NR |
| F2E1A | FC2E1 | >25 | NR | NR | NR |
| F2A2A | FC2A2 | >25 | NR | NR | NR |
| F2B2A | FC2B2 | >25 | NR | NR | NR |
| F2C2A | FC2C2 | >25 | NR | NR | NR |
| F2D2A | FC2D2 | >25 | NR | NR | NR |
| F2E2A | FC2E2 | >25 | NR | NR | NR |
| F2A3A | FC2A3 | >25 | NR | NR | NR |
| F2B3A | FC2B3 | >25 | NR | NR | NR |
| F2C3A | FC2C3 | >25 | NR | NR | NR |
| F2D3A | FC2D3 | >25 | NR | NR | NR |
| F2E3A | FC2E3 | >25 | NR | NR | NR |
| F2A4A | FC2A4 | >25 | NR | NR | NR |
| F2B4A | FC2B4 | >25 | NR | NR | NR |
| F2C4A | FC2C4 | >25 | NR | NR | NR |
| F2D4A | FC2D4 | >25 | NR | NR | NR |
| F2E4A | FC2E4 | >25 | NR | NR | NR |
| F2A5A | FC2A5 | >25 | NR | NR | NR |
| F2B5A | FC2B5 | >25 | NR | NR | NR |
| F2C5A | FC2C5 | >25 | NR | NR | NR |
| F2D5A | FC2D5 | >25 | NR | NR | NR |
| F2E5A | FC2E5 | >25 | NR | NR | NR |
| F2A6A | FC2A6 | >25 | NR | NR | NR |
| F2B6A | FC2B6 | >25 | NR | NR | NR |
| F2C6A | FC2C6 | >25 | NR | NR | NR |
| F2D6A | FC2D6 | >25 | NR | NR | NR |
| F2E6A | FC2E6 | >25 | NR | NR | NR |
| F3A1A | FC3A1 | >25 | NR | NR | NR |
| F3B1A | FC3B1 | >25 | NR | NR | NR |
| F3C1A | FC3C1 | >25 | NR | NR | NR |
| F3D1A | FC3D1 | >25 | NR | NR | NR |
| F3E1A | FC3E1 | >25 | NR | NR | NR |
| F3A2A | FC3A2 | >25 | NR | NR | NR |
| F3B2A | FC3B2 | >25 | NR | NR | NR |
| F3C2A | FC3C2 | >25 | NR | NR | NR |
| F3D2A | FC3D2 | >25 | NR | NR | NR |
| F3E2A | FC3E2 | >25 | NR | NR | NR |
| F3A3A | FC3A3 | >25 | NR | NR | NR |
| F3B3A | FC3B3 | >25 | NR | NR | NR |
| F3C3A | FC3C3 | >25 | NR | NR | NR |
| F3D3A | FC3D3 | >25 | NR | NR | NR |
| F3E3A | FC3E3 | >25 | NR | NR | NR |
| F3A4A | FC3A4 | >25 | NR | NR | NR |
| F3B4A | FC3B4 | >25 | NR | NR | NR |
| F3C4A | FC3C4 | >25 | NR | NR | NR |
| F3D4A | FC3D4 | >25 | NR | NR | NR |
| F3E4A | FC3E4 | >25 | NR | NR | NR |
| F3A5A | FC3A5 | >25 | NR | NR | NR |
| F3B5A | FC3B5 | >25 | NR | NR | NR |
| F3C5A | FC3C5 | >25 | NR | NR | NR |
| F3D5A | FC3D5 | >25 | NR | NR | NR |
| F3E5A | FC3E5 | >25 | NR | NR | NR |
| F3A6A | FC3A6 | >25 | NR | NR | NR |
| F3B6A | FC3B6 | >25 | NR | NR | NR |
| F3C6A | FC3C6 | >25 | NR | NR | NR |
| F3D6A | FC3D6 | >25 | NR | NR | NR |
| F3E6A | FC3E6 | >25 | NR | NR | NR |
| F4A1A | FC4A1 | >25 | R | NR | NR |
| F4B1A | FC4B1 | >25 | NR | NR | NR |
| F4C1A | FC4C1 | >25 | NR | NR | NR |
| F4D1A | FC4D1 | >25 | NR | NR | NR |
| F4E1A | FC4E1 | >25 | NR | NR | NR |
| F4A2A | FC4A2 | >25 | NR | NR | NR |
| F4B2A | FC4B2 | >25 | NR | NR | NR |
| F4C2A | FC4C2 | >25 | NR | NR | NR |
| F4D2A | FC4D2 | >25 | NR | NR | NR |
| F4E2A | FC4E2 | >25 | NR | NR | NR |
| F4A3A | FC4A3 | >25 | NR | NR | NR |
| F4B3A | FC4B3 | >25 | NR | NR | NR |
| FC4C3A | FC4C3 | >25 | NR | NR | NR |
| F4D3A | FC4D3 | >25 | NR | NR | NR |
| F4E3A | FC4E3 | >25 | NR | NR | NR |
| F4A4A | FC4A4 | >25 | NR | NR | NR |
| F4B4A | FC4B4 | >25 | NR | NR | NR |
| F4C4A | FC4C4 | >25 | NR | NR | NR |
| F4D4A | FC4D4 | >25 | NR | NR | NR |
| F4E4A | FC4E4 | >25 | NR | NR | NR |
| F4A5A | FC4A5 | >25 | NR | NR | NR |
| F4B5A | FC4B5 | >25 | NR | NR | NR |
| F4C5A | FC4C5 | >25 | NR | NR | NR |
| F4D5A | FC4D5 | >25 | NR | NR | NR |
| F4E5A | FC4E5 | >25 | NR | NR | NR |
| F4A6A | FC4A6 | >25 | NR | NR | NR |
| F4B6A | FC4B6 | >25 | NR | NR | NR |
| F4C6A | FC4C6 | >25 | NR | NR | NR |
| F4D6A | FC4D6 | >25 | NR | NR | NR |
| F4E6A | FC4E6 | >25 | NR | NR | NR |
| F5A1A | FC5A1 | >25 | NR | NR | NR |
| F5B1A | FC5B1 | >25 | NR | NR | NR |
| F5C1A | FC5C1 | >25 | NR | NR | NR |
| F5D1A | FC5D1 | >25 | NR | NR | NR |
| F5E1A | FC5E1 | >25 | NR | NR | NR |
| F5A2A | FC5A2 | >25 | NR | NR | NR |
| F5B2A | FC5B2 | >25 | NR | NR | NR |
| F5C2A | FC5C2 | >25 | NR | NR | NR |
| F5D2A | FC5D2 | >25 | NR | NR | NR |
| F5E2A | FC5E2 | >25 | NR | NR | NR |
| F5A3A | FC5A3 | >25 | NR | NR | NR |
| F5B3A | FC5B3 | >25 | NR | NR | NR |
| F5C3A | FC5C3 | >25 | NR | NR | NR |
| F5D3A | FC5D3 | >25 | NR | NR | NR |
| F5E3A | FC5E3 | >25 | NR | NR | NR |
| F5A4A | FC5A4 | >25 | NR | NR | NR |
| F5B4A | FC5B4 | >25 | NR | NR | NR |
| F5C4A | FC5C4 | >25 | NR | NR | NR |
| F5D4A | FC5D4 | >25 | NR | NR | NR |
| F5E4A | FC5E4 | >25 | NR | NR | NR |
| F5A5A | FC5A5 | >25 | NR | NR | NR |
| F5B5A | FC5B5 | >25 | NR | NR | NR |
| F5C5A | FC5C5 | >25 | NR | NR | NR |
| F5D5A | FC5D5 | >25 | NR | NR | NR |
| F5E5A | FC5E5 | >25 | NR | NR | NR |
| F5A6A | FC5A6 | >25 | NR | NR | NR |
| F5B6A | FC5B6 | >25 | NR | NR | NR |
| F5C6A | FC5C6 | >25 | NR | NR | NR |
| F5D6A | FC5D6 | >25 | NR | NR | NR |
| F5E6A | FC5E6 | >25 | NR | NR | NR |
| F6A1A | FC6A1 | >25 | NR | NR | NR |
| F6B1A | FC6B1 | >25 | NR | NR | NR |
| F6C1A | FC6C1 | >25 | NR | NR | NR |
| F6D1A | FC6D1 | >25 | NR | NR | NR |
| F6E1A | FC6E1 | >25 | NR | NR | NR |
| F6A2A | FC6A2 | >25 | NR | NR | NR |
| F6B2A | FC6B2 | >25 | NR | NR | NR |
| F6C2A | FC6C2 | >25 | NR | NR | NR |
| F6D2A | FC6D2 | >25 | NR | NR | NR |
| F6E2A | FC6E2 | >25 | NR | NR | NR |
| F6A3A | FC6A3 | >25 | NR | NR | NR |
| F6B3A | FC6B3 | >25 | NR | NR | NR |
| F6C3A | FC6C3 | >25 | NR | NR | NR |
| F6D3A | FC6D3 | >25 | NR | NR | NR |
| F6E3A | FC6E3 | >25 | NR | NR | NR |
| F6B4A | FC6B4 | >25 | NR | NR | NR |
| F6C4A | FC6C4 | >25 | NR | NR | NR |
| F6D4A | FC6D4 | >25 | NR | NR | NR |
| F6E4A | FC6E4 | >25 | NR | NR | NR |
| F6A5A | FC6A5 | >25 | NR | NR | NR |
| F6B5A | FC6B5 | >25 | NR | NR | NR |
| F6C5A | FC6C5 | >25 | NR | NR | NR |
| F6D5A | FC6D5 | >25 | NR | NR | NR |
| F6E5A | FC6E5 | >25 | NR | NR | NR |
| F6A6A | FC6A6 | >25 | NR | NR | NR |
| F6B6A | FC6B6 | >25 | NR | NR | NR |
| F6C6A | FC6C6 | >25 | NR | NR | NR |
| F6D6A | FC6D6 | >25 | NR | NR | NR |
| F6E6A | FC6E6 | >25 | NR | NR | NR |
| F7A1A | FC7A1 | >25 | NR | NR | NR |
| F7B1A | FC7B1 | >25 | NR | NR | NR |
| F7C1A | FC7C1 | >25 | NR | NR | NR |
| F7D1A | FC7D1 | >25 | NR | NR | NR |
| F7E1A | FC7E1 | >25 | NR | NR | NR |
| F7A2A | FC7A2 | >25 | NR | NR | NR |
| F7B2 | FC7B2 | >25 | NR | NR | NR |
| F7C2A | FC7C2 | >25 | NR | NR | NR |
| F7D2A | FC7D2 | >25 | NR | NR | NR |
| F7E2A | FC7E2 | >25 | NR | NR | NR |
| F7A3A | FC7A3 | >25 | NR | NR | NR |
| F7B3A | FC7B3 | >25 | NR | NR | NR |
| F7C3A | FC7C3 | >25 | NR | NR | NR |
| F7D3A | FC7D3 | >25 | NR | NR | NR |
| F7E3A | FC7E3 | >25 | NR | NR | NR |
| F7A4A | FC7A4 | >25 | NR | NR | NR |
| F7B4A | FC7B4 | >25 | NR | NR | NR |
| F7C4A | FC7C4 | >25 | NR | NR | NR |
| F7D4A | FC7D4 | >25 | NR | NR | NR |
| F7E4A | FC7E4 | >25 | NR | NR | NR |
| F7A5A | FC7A5 | >25 | NR | NR | NR |
| F7B5A | FC7B5 | >25 | NR | NR | NR |
| F7C5A | FC7C5 | >25 | NR | NR | NR |
| F7D5A | FC7D5 | >25 | NR | NR | NR |
| F7E5A | FC7E5 | >25 | NR | NR | NR |
| F7A6A | FC7A6 | >25 | NR | NR | NR |
| F7B6A | FC7B6 | >25 | NR | NR | NR |
| F7C6A | FC7C6 | >25 | NR | NR | NR |
| F7D6A | FC7D6 | >25 | NR | NR | NR |
| F7E6A | FC7E6 | >25 | NR | NR | NR |
| F8A1A | FC8A1 | >25 | NR | NR | NR |
| F8B1A | FC8B1 | >25 | NR | NR | NR |
| F8C1A | FC8C1 | >25 | NR | NR | NR |
| F8D1A | FC8D1 | >25 | NR | NR | NR |
| F8E1A | FC8E1 | >25 | NR | NR | NR |
| F8A2A | FC8A2 | >25 | NR | NR | NR |
| F8B2A | FC8B2 | >25 | NR | NR | NR |
| F8C2A | FC8C2 | >25 | NR | NR | NR |
| F8D2A | FC8D2 | >25 | NR | NR | NR |
| F8E2A | FC8E2 | >25 | NR | NR | NR |
| F8A3A | FC8A3 | >25 | NR | NR | NR |
| F8B3A | FC8B3 | >25 | NR | NR | NR |
| F8C3A | FC8C3 | >25 | NR | NR | NR |
| F8D3A | FC8D3 | >25 | NR | NR | NR |
| F8E3A | FC8E3 | >25 | NR | NR | NR |
| F8A4A | FC8A4 | >25 | NR | NR | NR |
| F8B4A | FC8B4 | >25 | NR | NR | NR |
| F8C4A | FC8C4 | >25 | NR | NR | NR |
| F8D4A | FC8D4 | >25 | NR | NR | NR |
| F8E4A | FC8E4 | >25 | NR | NR | NR |
| F8A5A | FC8A5 | >25 | NR | NR | NR |
| F8B5A | FC8B5 | >25 | NR | NR | NR |
| F8C5A | FC8C5 | >25 | NR | NR | NR |
| F8D5A | FC8D5 | >25 | NR | NR | NR |
| F8E5A | FC8E5 | >25 | NR | NR | NR |
| F8A6A | FC8A6 | >25 | NR | NR | NR |
| F8B6A | FC8B6 | >25 | NR | NR | NR |
| F8C6A | FC8C6 | >25 | NR | NR | NR |
| F8D6A | FC8D6 | >25 | NR | NR | NR |
| F8E6A | FC8E6 | >25 | NR | NR | NR |
| F1A1B | FC1A1 | NR | <0.3 | NR | NR |
| F1B1B | FC1B1 | NR | <0.3 | NR | NR |
| F1C1B | FC1C1 | NR | <0.3 | NR | NR |
| F1D1B | FC1D1 | NR | <0.3 | NR | NR |
| F1E1B | FC1E1 | NR | <0.3 | NR | NR |
| F1A2B | FC1A2 | NR | <0.3 | NR | NR |
| F1B2B | FC1B2 | NR | <0.3 | NR | NR |
| F1C2B | FC1C2 | NR | <0.3 | NR | NR |
| F1D2B | FC1D2 | NR | <0.3 | NR | NR |
| F1E2B | FC1E2 | NR | <0.3 | NR | NR |
| F1A3B | FC1A3 | NR | <0.3 | NR | NR |
| F1B3B | FC1B3 | NR | <0.3 | NR | NR |
| F1C3B | FC1C3 | NR | <0.3 | NR | NR |
| F1D3B | FC1D3 | NR | <0.3 | NR | NR |
| F1E3B | FC1E3 | NR | <0.3 | NR | NR |
| F1A4B | FC1A4 | NR | <0.3 | NR | NR |
| F1B4B | FC1B4 | NR | <0.3 | NR | NR |
| F1C4B | FC1C4 | NR | <0.3 | NR | NR |
| F1D4B | FC1D4 | NR | <0.3 | NR | NR |
| F1E4B | FC1E4 | NR | <0.3 | NR | NR |
| F1A5B | FC1A5 | NR | <0.3 | NR | NR |
| F1B5B | FC1B5 | NR | <0.3 | NR | NR |
| F1C5B | FC1C5 | NR | <0.3 | NR | NR |
| F1D5B | FC1D5 | NR | <0.3 | NR | NR |
| F1E5B | FC1E5 | NR | <0.3 | NR | NR |
| F1A6B | FC1A6 | NR | <0.3 | NR | NR |
| F1B6B | FC1B6 | NR | <0.3 | NR | NR |
| F1C6B | FC1C6 | NR | <0.3 | NR | NR |
| F1D6B | FC1D6 | NR | <0.3 | NR | NR |
| F1E6B | FC1E6 | NR | <0.3 | NR | NR |
| F2A1B | FC2A1 | NR | <0.3 | NR | NR |
| F2B1B | FC2B1 | NR | <0.3 | NR | NR |
| F2C1B | FC2C1 | NR | <0.3 | NR | NR |
| F2D1B | FC2D1 | NR | <0.3 | NR | NR |
| F2E1B | FC2E1 | NR | <0.3 | NR | NR |
| F2A2B | FC2A2 | NR | <0.3 | NR | NR |
| F2B2B | FC2B2 | NR | <0.3 | NR | NR |
| F2C2B | FC2C2 | NR | <0.3 | NR | NR |
| F2D2B | FC2D2 | NR | <0.3 | NR | NR |
| F2E2B | FC2E2 | NR | <0.3 | NR | NR |
| F2A3B | FC2A3 | NR | <0.3 | NR | NR |
| F2B3B | FC2B3 | NR | <0.3 | NR | NR |
| F2C3B | FC2C3 | NR | <0.3 | NR | NR |
| F2D3B | FC2D3 | NR | <0.3 | NR | NR |
| F2E3B | FC2E3 | NR | <0.3 | NR | NR |
| F2A4B | FC2A4 | NR | <0.3 | NR | NR |
| F2B4B | FC2B4 | NR | <0.3 | NR | NR |
| F2C4B | FC2C4 | NR | <0.3 | NR | NR |
| F2D4B | FC2D4 | NR | <0.3 | NR | NR |
| F2E4B | FC2E4 | NR | <0.3 | NR | NR |
| F2A5B | FC2A5 | NR | <0.3 | NR | NR |
| F2B5B | FC2B5 | NR | <0.3 | NR | NR |
| F2C5B | FC2C5 | NR | <0.3 | NR | NR |
| F2D5B | FC2D5 | NR | <0.3 | NR | NR |
| F2E5B | FC2E5 | NR | <0.3 | NR | NR |
| F2A6B | FC2A6 | NR | <0.3 | NR | NR |
| F2B6B | FC2B6 | NR | <0.3 | NR | NR |
| F2C6B | FC2C6 | NR | <0.3 | NR | NR |
| F2D6B | FC2D6 | NR | <0.3 | NR | NR |
| F2E6B | FC2E6 | NR | <0.3 | NR | NR |
| F3A1B | FC3A1 | NR | <0.3 | NR | NR |
| F3B1B | FC3B1 | NR | <0.3 | NR | NR |
| F3C1B | FC3C1 | NR | <0.3 | NR | NR |
| F3D1B | FC3D1 | NR | <0.3 | NR | NR |
| F3E1B | FC3E1 | NR | <0.3 | NR | NR |
| F3A2B | FC3A2 | NR | <0.3 | NR | NR |
| F3B2B | FC3B2 | NR | <0.3 | NR | NR |
| F3C2B | FC3C2 | NR | <0.3 | NR | NR |
| F3D2B | FC3D2 | NR | <0.3 | NR | NR |
| F3E2B | FC3E2 | NR | <0.3 | NR | NR |
| F3A3B | FC3A3 | NR | <0.3 | NR | NR |
| F3B3B | FC3B3 | NR | <0.3 | NR | NR |
| F3C3B | FC3C3 | NR | <0.3 | NR | NR |
| F3D3B | FC3D3 | NR | <0.3 | NR | NR |
| F3E3B | FC3E3 | NR | <0.3 | NR | NR |
| F3A4B | FC3A4 | NR | <0.3 | NR | NR |
| F3B4B | FC3B4 | NR | <0.3 | NR | NR |
| F3C4B | FC3C4 | NR | <0.3 | NR | NR |
| F3D4B | FC3D4 | NR | <0.3 | NR | NR |
| F3E4B | FC3E4 | NR | <0.3 | NR | NR |
| F3A5B | FC3A5 | NR | <0.3 | NR | NR |
| F3B5B | FC3B5 | NR | <0.3 | NR | NR |
| F3C5B | FC3C5 | NR | <0.3 | NR | NR |
| F3D5B | FC3D5 | NR | <0.3 | NR | NR |
| F3E5B | FC3E5 | NR | <0.3 | NR | NR |
| F3A6B | FC3A6 | NR | <0.3 | NR | NR |
| F3B6B | FC3B6 | NR | <0.3 | NR | NR |
| F3C6B | FC3C6 | NR | <0.3 | NR | NR |
| F3D6B | FC3D6 | NR | <0.3 | NR | NR |
| F3E6B | FC3E6 | NR | <0.3 | NR | NR |
| F4A1B | FC4A1 | NR | <0.3 | NR | NR |
| F4B1B | FC4B1 | NR | <0.3 | NR | NR |
| F4C1B | FC4C1 | NR | <0.3 | NR | NR |
| F4D1B | FC4D1 | NR | <0.3 | NR | NR |
| F4E1B | FC4E1 | NR | <0.3 | NR | NR |
| F4A2B | FC4A2 | NR | <0.3 | NR | NR |
| F4B2B | FC4B2 | NR | <0.3 | NR | NR |
| F4C2B | FC4C2 | NR | <0.3 | NR | NR |
| F4D2B | FC4D2 | NR | <0.3 | NR | NR |
| F4E2B | FC4E2 | NR | <0.3 | NR | NR |
| F4A3B | FC4A3 | NR | <0.3 | NR | NR |
| F4B3B | FC4B3 | NR | <0.3 | NR | NR |
| F4C3B | FC4C3 | NR | <0.3 | NR | NR |
| F4D3B | FC4D3 | NR | <0.3 | NR | NR |
| F4E3B | FC4E3 | NR | <0.3 | NR | NR |
| F4A4B | FC4A4 | NR | <0.3 | NR | NR |
| F4B4B | FC4B4 | NR | <0.3 | NR | NR |
| F4C4B | FC4C4 | NR | <0.3 | NR | NR |
| F4D4B | FC4D4 | NR | <0.3 | NR | NR |
| F4E4B | FC4E4 | NR | <0.3 | NR | NR |
| F4A5B | FC4A5 | NR | <0.3 | NR | NR |
| F4B5B | FC4B5 | NR | <0.3 | NR | NR |
| F4C5B | FC4C5 | NR | <0.3 | NR | NR |
| F4D5B | FC4D5 | NR | <0.3 | NR | NR |
| F4E5B | FC4E5 | NR | <0.3 | NR | NR |
| F4A6B | FC4A6 | NR | <0.3 | NR | NR |
| F4B6B | FC4B6 | NR | <0.3 | VR | NR |
| F4C6B | FC4C6 | NR | <0.3 | NR | NR |
| F4D6B | FC4D6 | NR | <0.3 | NR | NR |
| F4E6B | FC4E6 | NR | <0.3 | NR | NR |
| F5A1B | FC5A1 | NR | <0.3 | NR | NR |
| F5B1B | FC5B1 | NR | <0.3 | NR | NR |
| F5C1B | FC5C1 | NR | <0.3 | NR | NR |
| F5D1B | FC5D1 | NR | <0.3 | NR | NR |
| F5E1B | FC5E1 | NR | <0.3 | NR | NR |
| F5A2B | FC5A2 | NR | <0.3 | NR | NR |
| F5B2B | FC5B2 | NR | <0.3 | NR | NR |
| F5C2B | FC5C2 | NR | <0.3 | NR | NR |
| F5D2B | FC5D2 | NR | <0.3 | NR | NR |
| F5E2B | FC5E2 | NR | <0.3 | NR | NR |
| F5A3B | FC5A3 | NR | <0.3 | NR | NR |
| F5B3B | FC5B3 | NR | <0.3 | NR | NR |
| F5C3B | FC5C3 | NR | <0.3 | NR | NR |
| F5D3B | FC5D3 | NR | <0.3 | NR | NR |
| F5E3B | FC5E3 | NR | <0.3 | NR | NR |
| F5A4B | FC5A4 | NR | <0.3 | NR | NR |
| F5B4B | FC5B4 | NR | <0.3 | NR | NR |
| F5C4B | FC5C4 | NR | <0.3 | NR | NR |
| F5D4B | FC5D4 | NR | <0.3 | NR | NR |
| F5E4B | FC5E4 | NR | <0.3 | NR | NR |
| F5A5B | FC5A5 | NR | <0.3 | NR | NR |
| F5B5B | FC5B5 | NR | <0.3 | NR | NR |
| F5C5B | FC5C5 | NR | <0.3 | NR | NR |
| F5D5B | FC5D5 | NR | <0.3 | NR | NR |
| F5E5B | FC5E5 | NR | <0.3 | NR | NR |
| F5A6B | FC5A6 | NR | <0.3 | NR | NR |
| F5B6B | FC5B6 | NR | <0.3 | NR | NR |
| F5C6B | FC5C6 | NR | <0.3 | NR | NR |
| F5D6B | FC5D6 | NR | <0.3 | NR | NR |
| F5E6B | FC5E6 | NR | <0.3 | NR | NR |
| F6A1B | FC6A1 | NR | <0.3 | NR | NR |
| F6B1B | FC6B1 | NR | <0.3 | NR | NR |
| F6C1B | FC6C1 | NR | <0.3 | NR | NR |
| F6D1B | FC6D1 | NR | <0.3 | NR | NR |
| F6E1B | FC6E1 | NR | <0.3 | NR | NR |
| F6A2B | FC6A2 | NR | <0.3 | NR | NR |
| F6B2B | FC6B2 | NR | <0.3 | NR | NR |
| F6C2B | FC6C2 | NR | <0.3 | NR | NR |
| F6D2B | FC6D2 | NR | <0.3 | NR | NR |
| F6E2B | FC6E2 | NR | <0.3 | NR | NR |
| F6A3B | FC6A3 | NR | <0.3 | NR | NR |
| F6B3B | FC6B3 | NR | <0.3 | NR | NR |
| F6C3B | FC6C3 | NR | <0.3 | NR | NR |
| F6D3B | FC6D3 | NR | <0.3 | NR | NR |
| F6E3B | FC6E3 | NR | <0.3 | NR | NR |
| F6B4B | FC6B4 | NR | <0.3 | NR | NR |
| F6C4B | FC6C4 | NR | <0.3 | NR | NR |
| F6D4B | FC6D4 | NR | <0.3 | NR | NR |
| F6E4B | FC6E4 | NR | <0.3 | NR | NR |
| F6A5B | FC6A5 | NR | <0.3 | NR | NR |
| F6B5B | FC6B5 | NR | <0.3 | NR | NR |
| F6C5B | FC6C5 | NR | <0.3 | NR | NR |
| F6D5B | FC6D5 | NR | <0.3 | NR | NR |
| F6E5B | FC6E5 | NR | <0.3 | NR | NR |
| F6A6B | FC6A6 | NR | <0.3 | NR | NR |
| F6B6B | FC6B6 | NR | <0.3 | NR | NR |
| F6C6B | FC6C6 | NR | <0.3 | NR | NR |
| F6D6B | FC6D6 | NR | <0.3 | NR | NR |
| F6E6B | FC6E6 | NR | <0.3 | NR | NR |
| F7A1B | FC7A1 | NR | <0.3 | NR | NR |
| F7B1B | FC7B1 | NR | <0.3 | NR | NR |
| F7C1B | FC7C1 | NR | <0.3 | NR | NR |
| F7D1B | FC7D1 | NR | <0.3 | NR | NR |
| F7E1B | FC7E1 | NR | <0.3 | NR | NR |
| F7A2B | FC7A2 | NR | <0.3 | NR | NR |
| F7B2B | FC7B2 | NR | <0.3 | NR | NR |
| F7C2B | FC7C2 | NR | <0.3 | NR | NR |
| F7D2B | FC7D2 | NR | <0.3 | NR | NR |
| F7E2B | FC7E2 | NR | <0.3 | NR | NR |
| F7A3B | FC7A3 | NR | <0.3 | NR | NR |
| F7B3B | FC7B3 | NR | <0.3 | NR | NR |
| F7C3B | FC7C3 | NR | <0.3 | NR | NR |
| F7D3B | FC7D3 | NR | <0.3 | NR | NR |
| F7E3B | FC7E3 | NR | <0.3 | NR | NR |
| F7A4B | FC7A4 | NR | <0.3 | NR | NR |
| F7B4B | FC7B4 | NR | <0.3 | NR | NR |
| F7C4B | FC7C4 | NR | <0.3 | NR | NR |
| F7D4B | FC7D4 | NR | <0.3 | NR | NR |
| F7E4B | FC7E4 | NR | <0.3 | NR | NR |
| F7A5B | FC7A5 | NR | <0.3 | NR | NR |
| F7B5B | FC7B5 | NR | <0.3 | NR | NR |
| F7C5B | FC7C5 | NR | <0.3 | NR | NR |
| F7D5B | FC7D5 | NR | <0.3 | NR | NR |
| F7E5B | FC7E5 | NR | <0.3 | NR | NR |
| F7A6B | FC7A6 | NR | <0.3 | NR | NR |
| F7B6B | FC7B6 | NR | <0.3 | NR | NR |
| F7C6B | FC7C6 | NR | <0.3 | NR | NR |
| F7D6B | FC7D6 | NR | <0.3 | NR | NR |
| F7E6B | FC7E6 | NR | <0.3 | NR | NR |
| F8A1B | FC8A1 | NR | <0.3 | NR | NR |
| F8B1B | FC8B1 | NR | <0.3 | NR | NR |
| F8C1B | FC8C1 | NR | <0.3 | NR | NR |
| F8D1B | FC8D1 | NR | <0.3 | NR | NR |
| F8E1B | FC8E1 | NR | <0.3 | NR | NR |
| F8A2B | FC8A2 | NR | <0.3 | NR | NR |
| F8B2B | FC8B2 | NR | <0.3 | NR | NR |
| F8C2B | FC8C2 | NR | <0.3 | NR | NR |
| F8D2B | FC8D2 | NR | <0.3 | NR | NR |
| F8E2B | FC8E2 | NR | <0.3 | NR | NR |
| F8A3B | FC8A3 | NR | <0.3 | NR | NR |
| F8B3B | FC8B3 | NR | <0.3 | NR | NR |
| F8C3B | FC8C3 | NR | <0.3 | NR | NR |
| F8D3B | FC8D3 | NR | <0.3 | NR | NR |
| F8E3B | FC8E3 | NR | <0.3 | NR | NR |
| F8A4B | FC8A4 | NR | <0.3 | NR | NR |
| F8B4B | FC8B4 | NR | <0.3 | NR | NR |
| F8C4B | FC8C4 | NR | <0.3 | NR | NR |
| F8D4B | FC8D4 | NR | <0.3 | NR | NR |
| F8E4B | FC8E4 | NR | <0.3 | NR | NR |
| F8A5B | FC8A5 | NR | <0.3 | NR | NR |
| F8B5B | FC8B5 | NR | <0.3 | NR | NR |
| F8C5B | FC8C5 | NR | <0.3 | NR | NR |
| F8D5B | FC8D5 | NR | <0.3 | NR | NR |
| F8E5B | FC8E5 | NR | <0.3 | NR | NR |
| F8A6B | FC8A6 | NR | <0.3 | NR | NR |
| F8B6B | FC8B6 | NR | <0.3 | NR | NR |
| F8C6B | FC8C6 | NR | <0.3 | NR | NR |
| F8D6B | FC8D6 | NR | <0.3 | NR | NR |
| F8E6B | FC8E6 | NR | <0.3 | NR | NR |
| F1A1C | FC1A1 | NR | 0.04-0.22 | NR | NR |
| F1B1C | FC1B1 | NR | 0.04-0.22 | NR | NR |
| F1C1C | FC1C1 | NR | 0.04-0.22 | NR | NR |
| F1D1C | FC1D1 | NR | 0.04-0.22 | NR | NR |
| F1E1C | FC1E1 | NR | 0.04-0.22 | NR | NR |
| F1A2C | FC1A2 | NR | 0.04-0.22 | NR | NR |
| F1B2C | FC1B2 | NR | 0.04-0.22 | NR | NR |
| F1C2C | FC1C2 | NR | 0.04-0.22 | NR | NR |
| F1D2C | FC1D2 | NR | 0.04-0.22 | NR | NR |
| F1E2C | FC1E2 | NR | 0.04-0.22 | NR | NR |
| F1A3C | FC1A3 | NR | 0.04-0.22 | NR | NR |
| F1B3C | FC1B3 | NR | 0.04-0.22 | NR | NR |
| F1C3C | FC1C3 | NR | 0.04-0.22 | NR | NR |
| F1D3C | FC1D3 | NR | 0.04-0.22 | NR | NR |
| F1E3C | FC1E3 | NR | 0.04-0.22 | NR | NR |
| F1A4C | FC1A4 | NR | 0.04-0.22 | NR | NR |
| F1B4C | FC1B4 | NR | 0.04-0.22 | NR | NR |
| F1C4C | FC1C4 | NR | 0.04-0.22 | NR | NR |
| F1D4C | FC1D4 | NR | 0.04-0.22 | NR | NR |
| F1E4C | FC1E4 | NR | 0.04-0.22 | NR | NR |
| F1A5C | FC1A5 | NR | 0.04-0.22 | NR | NR |
| F1B5C | FC1B5 | NR | 0.04-0.22 | NR | NR |
| F1C5C | FC1C5 | NR | 0.04-0.22 | NR | NR |
| F1D5C | FC1D5 | NR | 0.04-0.22 | NR | NR |
| F1E5C | FC1E5 | NR | 0.04-0.22 | NR | NR |
| F1A6C | FC1A6 | NR | 0.04-0.22 | NR | NR |
| F1B6C | FC1B6 | NR | 0.04-0.22 | NR | NR |
| F1C6C | FC1C6 | NR | 0.04-0.22 | NR | NR |
| F1D6C | FC1D6 | NR | 0.04-0.22 | NR | NR |
| F1E6C | FC1E6 | NR | 0.04-0.22 | NR | NR |
| F2A1C | FC2A1 | NR | 0.04-0.22 | NR | NR |
| F2B1C | FC2B1 | NR | 0.04-0.22 | NR | NR |
| F2C1C | FC2C1 | NR | 0.04-0.22 | NR | NR |
| F2D1C | FC2D1 | NR | 0.04-0.22 | NR | NR |
| F2E1C | FC2E1 | NR | 0.04-0.22 | NR | NR |
| F2A2C | FC2A2 | NR | 0.04-0.22 | NR | NR |
| F2B2C | FC2B2 | NR | 0.04-0.22 | NR | NR |
| F2C2C | FC2C2 | NR | 0.04-0.22 | NR | NR |
| F2D2C | FC2D2 | NR | 0.04-0.22 | NR | NR |
| F2E2C | FC2E2 | NR | 0.04-0.22 | NR | NR |
| F2A3C | FC2A3 | NR | 0.04-0.22 | NR | NR |
| F2B3C | FC2B3 | NR | 0.04-0.22 | NR | NR |
| F2C3C | FC2C3 | NR | 0.04-0.22 | NR | NR |
| F2D3C | FC2D3 | NR | 0.04-0.22 | NR | NR |
| F2E3C | FC2E3 | NR | 0.04-0.22 | NR | NR |
| F2A4C | FC2A4 | NR | 0.04-0.22 | NR | NR |
| F2B4C | FC2B4 | NR | 0.04-0.22 | NR | NR |
| F2C4C | FC2C4 | NR | 0.04-0.22 | NR | NR |
| F2D4C | FC2D4 | NR | 0.04-0.22 | NR | NR |
| F2E4C | FC2E4 | NR | 0.04-0.22 | NR | NR |
| F2A5C | FC2A5 | NR | 0.04-0.22 | NR | NR |
| F2B5C | FC2B5 | NR | 0.04-0.22 | NR | NR |
| F2C5C | FC2C5 | NR | 0.04-0.22 | NR | NR |
| F2D5C | FC2D5 | NR | 0.04-0.22 | NR | NR |
| F2E5C | FC2E5 | NR | 0.04-0.22 | NR | NR |
| F2A6C | FC2A6 | NR | 0.04-0.22 | NR | NR |
| F2B6C | FC2B6 | NR | 0.04-0.22 | NR | NR |
| F2C6C | FC2C6 | NR | 0.04-0.22 | NR | NR |
| F2D6C | FC2D6 | NR | 0.04-0.22 | NR | NR |
| F2E6C | FC2E6 | NR | 0.04-0.22 | NR | NR |
| F3A1C | FC3A1 | NR | 0.04-0.22 | NR | NR |
| F3B1C | FC3B1 | NR | 0.04-0.22 | NR | NR |
| F3C1C | FC3C1 | NR | 0.04-0.22 | NR | NR |
| F3D1C | FC3D1 | NR | 0.04-0.22 | NR | NR |
| F3E1C | FC3E1 | NR | 0.04-0.22 | NR | NR |
| F3A2C | FC3A2 | NR | 0.04-0.22 | NR | NR |
| F3B2C | FC3B2 | NR | 0.04-0.22 | NR | NR |
| F3C2C | FC3C2 | NR | 0.04-0.22 | NR | NR |
| F3D2C | FC3D2 | NR | 0.04-0.22 | NR | NR |
| F3E2C | FC3E2 | NR | 0.04-0.22 | NR | NR |
| F3A3C | FC3A3 | NR | 0.04-0.22 | NR | NR |
| F3B3C | FC3B3 | NR | 0.04-0.22 | NR | NR |
| F3C3C | FC3C3 | NR | 0.04-0.22 | NR | NR |
| F3D3C | FC3D3 | NR | 0.04-0.22 | NR | NR |
| F3E3C | FC3E3 | NR | 0.04-0.22 | NR | NR |
| F3A4C | FC3A4 | NR | 0.04-0.22 | NR | NR |
| F3B4C | FC3B4 | NR | 0.04-0.22 | NR | NR |
| F3C4C | FC3C4 | NR | 0.04-0.22 | NR | NR |
| F3D4C | FC3D4 | NR | 0.04-0.22 | NR | NR |
| F3E4C | FC3E4 | NR | 0.04-0.22 | NR | NR |
| F3A5C | FC3A5 | NR | 0.04-0.22 | NR | NR |
| F3B5C | FC3B5 | NR | 0.04-0.22 | NR | NR |
| F3C5C | FC3C5 | NR | 0.04-0.22 | NR | NR |
| F3D5C | FC3D5 | NR | 0.04-0.22 | NR | NR |
| F3E5C | FC3E5 | NR | 0.04-0.22 | NR | NR |
| F3A6C | FC3A6 | NR | 0.04-0.22 | NR | NR |
| F3B6C | FC3B6 | NR | 0.04-0.22 | NR | NR |
| F3C6C | FC3C6 | NR | 0.04-0.22 | NR | NR |
| F3D6C | FC3D6 | NR | 0.04-0.22 | NR | NR |
| F3E6C | FC3E6 | NR | 0.04-0.22 | NR | NR |
| F4A1C | FC4A1 | NR | 0.04-0.22 | NR | NR |
| F4B1C | FC4B1 | NR | 0.04-0.22 | NR | NR |
| F4C1C | FC4C1 | NR | 0.04-0.22 | NR | NR |
| F4D1C | FC4D1 | NR | 0.04-0.22 | NR | NR |
| F4E1C | FC4E1 | NR | 0.04-0.22 | NR | NR |
| F4A2C | FC4A2 | NR | 0.04-0.22 | NR | NR |
| F4B2C | FC4B2 | NR | 0.04-0.22 | NR | NR |
| F4C2C | FC4C2 | NR | 0.04-0.22 | NR | NR |
| F4D2C | FC4D2 | NR | 0.04-0.22 | NR | NR |
| F4E2C | FC4E2 | NR | 0.04-0.22 | NR | NR |
| F4A3C | FC4A3 | NR | 0.04-0.22 | NR | NR |
| F4B3C | FC4B3 | NR | 0.04-0.22 | NR | NR |
| F4C3C | FC4C3 | NR | 0.04-0.22 | NR | NR |
| F4D3C | FC4D3 | NR | 0.04-0.22 | NR | NR |
| F4E3C | FC4E3 | NR | 0.04-0.22 | NR | NR |
| F4A4C | FC4A4 | NR | 0.04-0.22 | NR | NR |
| F4B4C | FC4B4 | NR | 0.04-0.22 | NR | NR |
| F4C4C | FC4C4 | NR | 0.04-0.22 | NR | NR |
| F4D4C | FC4D4 | NR | 0.04-0.22 | NR | NR |
| F4E4C | FC4E4 | NR | 0.04-0.22 | NR | NR |
| F4A5C | FC4A5 | NR | 0.04-0.22 | NR | NR |
| F4B5C | FC4B5 | NR | 0.04-0.22 | NR | NR |
| F4C5C | FC4C5 | NR | 0.04-0.22 | NR | NR |
| F4D5C | FC4D5 | NR | 0.04-0.22 | NR | NR |
| F4E5C | FC4E5 | NR | 0.04-0.22 | NR | NR |
| F4A6C | FC4A6 | NR | 0.04-0.22 | NR | NR |
| F4B6C | FC4B6 | NR | 0.04-0.22 | NR | NR |
| F4C6C | FC4C6 | NR | 0.04-0.22 | NR | NR |
| F4D6C | FC4D6 | NR | 0.04-0.22 | NR | NR |
| F4E6C | FC4E6 | NR | 0.04-0.22 | NR | NR |
| F5A1C | FC5A1 | NR | 0.04-0.22 | NR | NR |
| F5B1C | FC5B1 | NR | 0.04-0.22 | NR | NR |
| F5C1C | FC5C1 | NR | 0.04-0.22 | NR | NR |
| F5D1C | FC5D1 | NR | 0.04-0.22 | NR | NR |
| F5E1C | FC5E1 | NR | 0.04-0.22 | NR | NR |
| F5A2C | FC5A2 | NR | 0.04-0.22 | NR | NR |
| F5B2C | FC5B2 | NR | 0.04-0.22 | NR | NR |
| F5C2C | FC5C2 | NR | 0.04-0.22 | NR | NR |
| F5D2C | FC5D2 | NR | 0.04-0.22 | NR | NR |
| F5E2C | FC5E2 | NR | 0.04-0.22 | NR | NR |
| F5A3C | FC5A3 | NR | 0.04-0.22 | NR | NR |
| F5B3C | FC5B3 | NR | 0.04-0.22 | NR | NR |
| F5C3C | FC5C3 | NR | 0.04-0.22 | NR | NR |
| F5D3C | FC5D3 | NR | 0.04-0.22 | NR | NR |
| F5E3C | FC5E3 | NR | 0.04-0.22 | NR | NR |
| F5A4C | FC5A4 | NR | 0.04-0.22 | NR | NR |
| F5B4C | FC5B4 | NR | 0.04-0.22 | NR | NR |
| F5C4C | FC5C4 | NR | 0.04-0.22 | NR | NR |
| F5D4C | FC5D4 | NR | 0.04-0.22 | NR | NR |
| F5E4C | FC5E4 | NR | 0.04-0.22 | NR | NR |
| F5A5C | FC5A5 | NR | 0.04-0.22 | NR | NR |
| F5B5C | FC5B5 | NR | 0.04-0.22 | NR | NR |
| F5C5C | FC5C5 | NR | 0.04-0.22 | NR | NR |
| F5D5C | FC5D5 | NR | 0.04-0.22 | NR | NR |
| F5E5C | FC5E5 | NR | 0.04-0.22 | NR | NR |
| F5A6C | FC5A6 | NR | 0.04-0.22 | NR | NR |
| F5B6C | FC5B6 | NR | 0.04-0.22 | NR | NR |
| F5C6C | FC5C6 | NR | 0.04-0.22 | NR | NR |
| F5D6C | FC5D6 | NR | 0.04-0.22 | NR | NR |
| F5E6C | FC5E6 | NR | 0.04-0.22 | NR | NR |
| F6A1C | FC6A1 | NR | 0.04-0.22 | NR | NR |
| F6B1C | FC6B1 | NR | 0.04-0.22 | NR | NR |
| F6C1C | FC6C1 | NR | 0.04-0.22 | NR | NR |
| F6D1C | FC6D1 | NR | 0.04-0.22 | NR | NR |
| F6E1C | FC6E1 | NR | 0.04-0.22 | NR | NR |
| F6A2C | FC6A2 | NR | 0.04-0.22 | NR | NR |
| F6B2C | FC6B2 | NR | 0.04-0.22 | NR | NR |
| F6C2C | FC6C2 | NR | 0.04-0.22 | NR | NR |
| F6D2C | FC6D2 | NR | 0.04-0.22 | NR | NR |
| F6E2C | FC6E2 | NR | 0.04-0.22 | NR | NR |
| F6A3C | FC6A3 | NR | 0.04-0.22 | NR | NR |
| F6B3C | FC6B3 | NR | 0.04-0.22 | NR | NR |
| F6C3C | FC6C3 | NR | 0.04-0.22 | NR | NR |
| F6D3C | FC6D3 | NR | 0.04-0.22 | NR | NR |
| F6E3C | FC6E3 | NR | 0.04-0.22 | NR | NR |
| F6B4C | FC6B4 | NR | 0.04-0.22 | NR | NR |
| F6C4C | FC6C4 | NR | 0.04-0.22 | NR | NR |
| F6D4C | FC6D4 | NR | 0.04-0.22 | NR | NR |
| F6E4C | FC6E4 | NR | 0.04-0.22 | NR | NR |
| F6A5C | FC6A5 | NR | 0.04-0.22 | NR | NR |
| F6B5C | FC6B5 | NR | 0.04-0.22 | NR | NR |
| F6C5C | FC6C5 | NR | 0.04-0.22 | NR | NR |
| F6D5C | FC6D5 | NR | 0.04-0.22 | NR | NR |
| F6E5C | FC6E5 | NR | 0.04-0.22 | NR | NR |
| F6A6C | FC6A6 | NR | 0.04-0.22 | NR | NR |
| F6B6C | FC6B6 | NR | 0.04-0.22 | NR | NR |
| F6C6C | FC6C6 | NR | 0.04-0.22 | NR | NR |
| F6D6C | FC6D6 | NR | 0.04-0.22 | NR | NR |
| F6E6C | FC6E6 | NR | 0.04-0.22 | NR | NR |
| F7A1C | FC7A1 | NR | 0.04-0.22 | NR | NR |
| F7B1C | FC7B1 | NR | 0.04-0.22 | NR | NR |
| F7C1C | FC7C1 | NR | 0.04-0.22 | NR | NR |
| F7D1C | FC7D1 | NR | 0.04-0.22 | NR | NR |
| F7E1C | FC7E1 | NR | 0.04-0.22 | NR | NR |
| F7A2C | FC7A2 | NR | 0.04-0.22 | NR | NR |
| F7B2C | FC7B2 | NR | 0.04-0.22 | NR | NR |
| F7C2C | FC7C2 | NR | 0.04-0.22 | NR | NR |
| F7D2C | FC7D2 | NR | 0.04-0.22 | NR | NR |
| F7E2C | FC7E2 | NR | 0.04-0.22 | NR | NR |
| F7A3C | FC7A3 | NR | 0.04-0.22 | NR | NR |
| F7B3C | FC7B3 | NR | 0.04-0.22 | NR | NR |
| F7C3C | FC7C3 | NR | 0.04-0.22 | NR | NR |
| F7D3C | FC7D3 | NR | 0.04-0.22 | NR | NR |
| F7E3C | FC7E3 | NR | 0.04-0.22 | NR | NR |
| F7A4C | FC7A4 | NR | 0.04-0.22 | NR | NR |
| F7B4C | FC7B4 | NR | 0.04-0.22 | NR | NR |
| F7C4C | FC7C4 | NR | 0.04-0.22 | NR | NR |
| F7D4C | FC7D4 | NR | 0.04-0.22 | NR | NR |
| F7E4C | FC7E4 | NR | 0.04-0.22 | NR | NR |
| F7A5C | FC7A5 | NR | 0.04-0.22 | NR | NR |
| F7B5C | FC7B5 | NR | 0.04-0.22 | NR | NR |
| F7C5C | FC7C5 | NR | 0.04-0.22 | NR | NR |
| F7D5C | FC7D5 | NR | 0.04-0.22 | NR | NR |
| F7E5C | FC7E5 | NR | 0.04-0.22 | NR | NR |
| F7A6C | FC7A6 | NR | 0.04-0.22 | NR | NR |
| F7B6C | FC7B6 | NR | 0.04-0.22 | NR | NR |
| F7C6C | FC7C6 | NR | 0.04-0.22 | NR | NR |
| F7D6C | FC7D6 | NR | 0.04-0.22 | NR | NR |
| F7E6C | FC7E6 | NR | 0.04-0.22 | NR | NR |
| F8A1C | FC8A1 | NR | 0.04-0.22 | NR | NR |
| F8B1C | FC8B1 | NR | 0.04-0.22 | NR | NR |
| F8C1C | FC8C1 | NR | 0.04-0.22 | NR | NR |
| F8D1C | FC8D1 | NR | 0.04-0.22 | NR | NR |
| F8E1C | FC8E1 | NR | 0.04-0.22 | NR | NR |
| F8A2C | FC8A2 | NR | 0.04-0.22 | NR | NR |
| F8B2C | FC8B2 | NR | 0.04-0.22 | NR | NR |
| F8C2C | FC8C2 | NR | 0.04-0.22 | NR | NR |
| F8D2C | FC8D2 | NR | 0.04-0.22 | NR | NR |
| F8E2C | FC8E2 | NR | 0.04-0.22 | NR | NR |
| F8A3C | FC8A3 | NR | 0.04-0.22 | NR | NR |
| F8B3C | FC8B3 | NR | 0.04-0.22 | NR | NR |
| F8C3C | FC8C3 | NR | 0.04-0.22 | NR | NR |
| F8D3C | FC8D3 | NR | 0.04-0.22 | NR | NR |
| F8E3C | FC8E3 | NR | 0.04-0.22 | NR | NR |
| F8A4C | FC8A4 | NR | 0.04-0.22 | NR | NR |
| F8B4C | FC8B4 | NR | 0.04-0.22 | NR | NR |
| F8C4C | FC8C4 | NR | 0.04-0.22 | NR | NR |
| F8D4C | FC8D4 | NR | 0.04-0.22 | NR | NR |
| F8E4C | FC8E4 | NR | 0.04-0.22 | NR | NR |
| F8A5C | FC8A5 | NR | 0.04-0.22 | NR | NR |
| F8B5C | FC8B5 | NR | 0.04-0.22 | NR | NR |
| F8C5C | FC8C5 | NR | 0.04-0.22 | NR | NR |
| F8D5C | FC8D5 | NR | 0.04-0.22 | NR | NR |
| F8E5C | FC8E5 | NR | 0.04-0.22 | NR | NR |
| F8A6C | FC8A6 | NR | 0.04-0.22 | NR | NR |
| F8B6C | FC8B6 | NR | 0.04-0.22 | NR | NR |
| F8C6C | FC8C6 | NR | 0.04-0.22 | NR | NR |
| F8D6C | FC8D6 | NR | 0.04-0.22 | NR | NR |
| F8E6C | FC8E6 | NR | 0.04-0.22 | NR | NR |
| F1A1D | FC1A1 | NR | NR | 0.6-2.5 | 1.0-6.2 |
| F1B1D | FC1B1 | NR | NR | 0.6-2.5 | 1.0-6.2 |
| F1C1D | FC1C1 | NR | NR | 0.6-2.5 | 1.0-6.2 |
| F1D1D | FC1D1 | NR | NR | 0.6-2.5 | 1.0-6.2 |
| F1E1D | FC1E1 | NR | NR | 0.6-2.5 | 1.0-6.2 |
| F1A2D | FC1A2 | NR | NR | 0.6-2.5 | 1.0-6.2 |
| F1B2D | FC1B2 | NR | NR | 0.6-2.5 | 1.0-6.2 |
| F1C2D | FC1C2 | NR | NR | 0.6-2.5 | 1.0-6.2 |
| F1D2D | FC1D2 | NR | NR | 0.6-2.5 | 1.0-6.2 |
| F1E2D | FC1E2 | NR | NR | 0.6-2.5 | 1.0-6.2 |
| F1A3D | FC1A3 | NR | NR | 0.6-2.5 | 1.0-6.2 |
| F1B3D | FC1B3 | NR | NR | 0.6-2.5 | 1.0-6.2 |
| F1C3D | FC1C3 | NR | NR | 0.6-2.5 | 1.0-6.2 |
| F1D3D | FC1D3 | NR | NR | 0.6-2.5 | 1.0-6.2 |
| F1E3D | FC1E3 | NR | NR | 0.6-2.5 | 1.0-6.2 |
| F1A4D | FC1A4 | NR | NR | 0.6-2.5 | 1.0-6.2 |
| F1B4D | FC1B4 | NR | NR | 0.6-2.5 | 1.0-6.2 |
| F1C4D | FC1C4 | NR | NR | 0.6-2.5 | 1.0-6.2 |
| F1D4D | FC1D4 | NR | NR | 0.6-2.5 | 1.0-6.2 |
| F1E4D | FC1E4 | NR | NR | 0.6-2.5 | 1.0-6.2 |
| F1A5D | FC1A5 | NR | NR | 0.6-2.5 | 1.0-6.2 |
| F1B5D | FC1B5 | NR | NR | 0.6-2.5 | 1.0-6.2 |
| F1C5D | FC1C5 | NR | NR | 0.6-2.5 | 1.0-6.2 |
| F1D5D | FC1D5 | NR | NR | 0.6-2.5 | 1.0-6.2 |
| F1E5D | FC1E5 | NR | NR | 0.6-2.5 | 1.0-6.2 |
| F1A6D | FC1A6 | NR | NR | 0.6-2.5 | 1.0-6.2 |
| F1B6D | FC1B6 | NR | NR | 0.6-2.5 | 1.0-6.2 |
| F1C6D | FC1C6 | NR | NR | 0.6-2.5 | 1.0-6.2 |
| F1D6D | FC1D6 | NR | NR | 0.6-2.5 | 1.0-6.2 |
| F1E6D | FC1E6 | NR | NR | 0.6-2.5 | 1.0-6.2 |
| F2A1D | FC2A1 | NR | NR | 0.6-2.5 | 1.0-6.2 |
| F2B1D | FC2B1 | NR | NR | 0.6-2.5 | 1.0-6.2 |
| F2C1D | FC2C1 | NR | NR | 0.6-2.5 | 1.0-6.2 |
| F2D1D | FC2D1 | NR | NR | 0.6-2.5 | 1.0-6.2 |
| F2E1D | FC2E1 | NR | NR | 0.6-2.5 | 1.0-6.2 |
| F2A2D | FC2A2 | NR | NR | 0.6-2.5 | 1.0-6.2 |
| F2B2D | FC2B2 | NR | NR | 0.6-2.5 | 1.0-6.2 |
| F2C2D | FC2C2 | NR | NR | 0.6-2.5 | 1.0-6.2 |
| F2D2D | FC2D2 | NR | NR | 0.6-2.5 | 1.0-6.2 |
| F2E2D | FC2E2 | NR | NR | 0.6-2.5 | 1.0-6.2 |
| F2A3D | FC2A3 | NR | NR | 0.6-2.5 | 1.0-6.2 |
| F2B3D | FC2B3 | NR | NR | 0.6-2.5 | 1.0-6.2 |
| F2C3D | FC2C3 | NR | NR | 0.6-2.5 | 1.0-6.2 |
| F2D3D | FC2D3 | NR | NR | 0.6-2.5 | 1.0-6.2 |
| F2E3D | FC2E3 | NR | NR | 0.6-2.5 | 1.0-6.2 |
| F2A4D | FC2A4 | NR | NR | 0.6-2.5 | 1.0-6.2 |
| F2B4D | FC2B4 | NR | NR | 0.6-2.5 | 1.0-6.2 |
| F2C4D | FC2C4 | NR | NR | 0.6-2.5 | 1.0-6.2 |
| F2D4D | FC2D4 | NR | NR | 0.6-2.5 | 1.0-6.2 |
| F2E4D | FC2E4 | NR | NR | 0.6-2.5 | 1.0-6.2 |
| F2A5D | FC2A5 | NR | NR | 0.6-2.5 | 1.0-6.2 |
| F2B5D | FC2B5 | NR | NR | 0.6-2.5 | 1.0-6.2 |
| F2C5D | FC2C5 | NR | NR | 0.6-2.5 | 1.0-6.2 |
| F2D5D | FC2D5 | NR | NR | 0.6-2.5 | 1.0-6.2 |
| F2E5D | FC2E5 | NR | NR | 0.6-2.5 | 1.0-6.2 |
| F2A6D | FC2A6 | NR | NR | 0.6-2.5 | 1.0-6.2 |
| F2B6D | FC2B6 | NR | NR | 0.6-2.5 | 1.0-6.2 |
| F2C6D | FC2C6 | NR | NR | 0.6-2.5 | 1.0-6.2 |
| F2D6D | FC2D6 | NR | NR | 0.6-2.5 | 1.0-6.2 |
| F2E6D | FC2E6 | NR | NR | 0.6-2.5 | 1.0-6.2 |
| F3A1D | FC3A1 | NR | NR | 0.6-2.5 | 1.0-6.2 |
| F3B1D | FC3B1 | NR | NR | 0.6-2.5 | 1.0-6.2 |
| F3C1D | FC3C1 | NR | NR | 0.6-2.5 | 1.0-6.2 |
| F3D1D | FC3D1 | NR | NR | 0.6-2.5 | 1.0-6.2 |
| F3E1D | FC3E1 | NR | NR | 0.6-2.5 | 1.0-6.2 |
| F3A2D | FC3A2 | NR | NR | 0.6-2.5 | 1.0-6.2 |
| F3B2D | FC3B2 | NR | NR | 0.6-2.5 | 1.0-6.2 |
| F3C2D | FC3C2 | NR | NR | 0.6-2.5 | 1.0-6.2 |
| F3D2D | FC3D2 | NR | NR | 0.6-2.5 | 1.0-6.2 |
| F3E2D | FC3E2 | NR | NR | 0.6-2.5 | 1.0-6.2 |
| F3A3D | FC3A3 | NR | NR | 0.6-2.5 | 1.0-6.2 |
| F3B3D | FC3B3 | NR | NR | 0.6-2.5 | 1.0-6.2 |
| F3C3D | FC3C3 | NR | NR | 0.6-2.5 | 1.0-6.2 |
| F3D3D | FC3D3 | NR | NR | 0.6-2.5 | 1.0-6.2 |
| F3E3D | FC3E3 | NR | NR | 0.6-2.5 | 1.0-6.2 |
| F3A4D | FC3A4 | NR | NR | 0.6-2.5 | 1.0-6.2 |
| F3B4D | FC3B4 | NR | NR | 0.6-2.5 | 1.0-6.2 |
| F3C4D | FC3C4 | NR | NR | 0.6-2.5 | 1.0-6.2 |
| F3D4D | FC3D4 | NR | NR | 0.6-2.5 | 1.0-6.2 |
| F3E4D | FC3E4 | NR | NR | 0.6-2.5 | 1.0-6.2 |
| F3A5D | FC3A5 | NR | NR | 0.6-2.5 | 1.0-6.2 |
| F3B5D | FC3B5 | NR | NR | 0.6-2.5 | 1.0-6.2 |
| F3C5D | FC3C5 | NR | NR | 0.6-2.5 | 1.0-6.2 |
| F3D5D | FC3D5 | NR | NR | 0.6-2.5 | 1.0-6.2 |
| F3E5D | FC3E5 | NR | NR | 0.6-2.5 | 1.0-6.2 |
| F3A6D | FC3A6 | NR | NR | 0.6-2.5 | 1.0-6.2 |
| F3B6D | FC3B6 | NR | NR | 0.6-2.5 | 1.0-6.2 |
| F3C6D | FC3C6 | NR | NR | 0.6-2.5 | 1.0-6.2 |
| F3D6D | FC3D6 | NR | NR | 0.6-2.5 | 1.0-6.2 |
| F3E6D | FC3E6 | NR | NR | 0.6-2.5 | 1.0-6.2 |
| F4A1D | FC4A1 | NR | NR | 0.6-2.5 | 1.0-6.2 |
| F4B1D | FC4B1 | NR | NR | 0.6-2.5 | 1.0-6.2 |
| F4C1D | FC4C1 | NR | NR | 0.6-2.5 | 1.0-6.2 |
| F4D1D | FC4D1 | NR | NR | 0.6-2.5 | 1.0-6.2 |
| F4E1D | FC4E1 | NR | NR | 0.6-2.5 | 1.0-6.2 |
| F4A2D | FC4A2 | NR | NR | 0.6-2.5 | 1.0-6.2 |
| F4B2D | FC4B2 | NR | NR | 0.6-2.5 | 1.0-6.2 |
| F4C2D | FC4C2 | NR | NR | 0.6-2.5 | 1.0-6.2 |
| F4D2D | FC4D2 | NR | NR | 0.6-2.5 | 1.0-6.2 |
| F4E2D | FC4E2 | NR | NR | 0.6-2.5 | 1.0-6.2 |
| F4A3D | FC4A3 | NR | NR | 0.6-2.5 | 1.0-6.2 |
| F4B3D | FC4B3 | NR | NR | 0.6-2.5 | 1.0-6.2 |
| FC4C3D | FC4C3 | NR | NR | 0.6-2.5 | 1.0-6.2 |
| F4D3D | FC4D3 | NR | NR | 0.6-2.5 | 1.0-6.2 |
| F4E3D | FC4E3 | NR | NR | 0.6-2.5 | 1.0-6.2 |
| F4A4D | FC4A4 | NR | NR | 0.6-2.5 | 1.0-6.2 |
| F4B4D | FC4B4 | NR | NR | 0.6-2.5 | 1.0-6.2 |
| F4C4D | FC4C4 | NR | NR | 0.6-2.5 | 1.0-6.2 |
| F4D4D | FC4D4 | NR | NR | 0.6-2.5 | 1.0-6.2 |
| F4E4D | FC4E4 | NR | NR | 0.6-2.5 | 1.0-6.2 |
| F4A5D | FC4A5 | NR | NR | 0.6-2.5 | 1.0-6.2 |
| F4B5D | FC4B5 | NR | NR | 0.6-2.5 | 1.0-6.2 |
| F4C5D | FC4C5 | NR | NR | 0.6-2.5 | 1.0-6.2 |
| F4D5D | FC4D5 | NR | NR | 0.6-2.5 | 1.0-6.2 |
| F4E5D | FC4E5 | NR | NR | 0.6-2.5 | 1.0-6.2 |
| F4A6D | FC4A6 | NR | NR | 0.6-2.5 | 1.0-6.2 |
| F4B6D | FC4B6 | NR | NR | 0.6-2.5 | 1.0-6.2 |
| F4C6D | FC4C6 | NR | NR | 0.6-2.5 | 1.0-6.2 |
| F4D6D | FC4D6 | NR | NR | 0.6-2.5 | 1.0-6.2 |
| F4E6D | FC4E6 | NR | NR | 0.6-2.5 | 1.0-6.2 |
| F5A1D | FC5A1 | NR | NR | 0.6-2.5 | 1.0-6.2 |
| F5B1D | FC5B1 | NR | NR | 0.6-2.5 | 1.0-6.2 |
| F5C1D | FC5C1 | NR | NR | 0.6-2.5 | 1.0-6.2 |
| F5D1D | FC5D1 | NR | NR | 0.6-2.5 | 1.0-6.2 |
| F5E1D | FC5E1 | NR | NR | 0.6-2.5 | 1.0-6.2 |
| F5A2D | FC5A2 | NR | NR | 0.6-2.5 | 1.0-6.2 |
| F5B2D | FC5B2 | NR | NR | 0.6-2.5 | 1.0-6.2 |
| F5C2D | FC5C2 | NR | NR | 0.6-2.5 | 1.0-6.2 |
| F5D2D | FC5D2 | NR | NR | 0.6-2.5 | 1.0-6.2 |
| F5E2D | FC5E2 | NR | NR | 0.6-2.5 | 1.0-6.2 |
| F5A3D | FC5A3 | NR | NR | 0.6-2.5 | 1.0-6.2 |
| F5B3D | FC5B3 | NR | NR | 0.6-2.5 | 1.0-6.2 |
| F5C3D | FC5C3 | NR | NR | 0.6-2.5 | 1.0-6.2 |
| F5D3D | FC5D3 | NR | NR | 0.6-2.5 | 1.0-6.2 |
| F5E3D | FC5E3 | NR | NR | 0.6-2.5 | 1.0-6.2 |
| F5A4D | FC5A4 | NR | NR | 0.6-2.5 | 1.0-6.2 |
| F5B4D | FC5B4 | NR | NR | 0.6-2.5 | 1.0-6.2 |
| F5C4D | FC5C4 | NR | NR | 0.6-2.5 | 1.0-6.2 |
| F5D4D | FC5D4 | NR | NR | 0.6-2.5 | 1.0-6.2 |
| F5E4D | FC5E4 | NR | NR | 0.6-2.5 | 1.0-6.2 |
| F5A5D | FC5A5 | NR | NR | 0.6-2.5 | 1.0-6.2 |
| F5B5D | FC5B5 | NR | NR | 0.6-2.5 | 1.0-6.2 |
| F5C5D | FC5C5 | NR | NR | 0.6-2.5 | 1.0-6.2 |
| F5D5D | FC5D5 | NR | NR | 0.6-2.5 | 1.0-6.2 |
| F5E5D | FC5E5 | NR | NR | 0.6-2.5 | 1.0-6.2 |
| F5A6D | FC5A6 | NR | NR | 0.6-2.5 | 1.0-6.2 |
| F5B6D | FC5B6 | NR | NR | 0.6-2.5 | 1.0-6.2 |
| F5C6D | FC5C6 | NR | NR | 0.6-2.5 | 1.0-6.2 |
| F5D6D | FC5D6 | NR | NR | 0.6-2.5 | 1.0-6.2 |
| F5E6D | FC5E6 | NR | NR | 0.6-2.5 | 1.0-6.2 |
| F6A1D | FC6A1 | NR | NR | 0.6-2.5 | 1.0-6.2 |
| F6B1D | FC6B1 | NR | NR | 0.6-2.5 | 1.0-6.2 |
| F6C1D | FC6C1 | NR | NR | 0.6-2.5 | 1.0-6.2 |
| F6D1D | FC6D1 | NR | NR | 0.6-2.5 | 1.0-6.2 |
| F6E1D | FC6E1 | NR | NR | 0.6-2.5 | 1.0-6.2 |
| F6A2D | FC6A2 | NR | NR | 0.6-2.5 | 1.0-6.2 |
| F6B2D | FC6B2 | NR | NR | 0.6-2.5 | 1.0-6.2 |
| F6C2D | FC6C2 | NR | NR | 0.6-2.5 | 1.0-6.2 |
| F6D2D | FC6D2 | NR | NR | 0.6-2.5 | 1.0-6.2 |
| F6E2D | FC6E2 | NR | NR | 0.6-2.5 | 1.0-6.2 |
| F6A3D | FC6A3 | NR | NR | 0.6-2.5 | 1.0-6.2 |
| F6B3D | FC6B3 | NR | NR | 0.6-2.5 | 1.0-6.2 |
| F6C3D | FC6C3 | NR | NR | 0.6-2.5 | 1.0-6.2 |
| F6D3D | FC6D3 | NR | NR | 0.6-2.5 | 1.0-6.2 |
| F6E3D | FC6E3 | NR | NR | 0.6-2.5 | 1.0-6.2 |
| F6B4D | FC6B4 | NR | NR | 0.6-2.5 | 1.0-6.2 |
| F6C4D | FC6C4 | NR | NR | 0.6-2.5 | 1.0-6.2 |
| F6D4D | FC6D4 | NR | NR | 0.6-2.5 | 1.0-6.2 |
| F6E4D | FC6E4 | NR | NR | 0.6-2.5 | 1.0-6.2 |
| F6A5D | FC6A5 | NR | NR | 0.6-2.5 | 1.0-6.2 |
| F6B5D | FC6B5 | NR | NR | 0.6-2.5 | 1.0-6.2 |
| F6C5D | FC6C5 | NR | NR | 0.6-2.5 | 1.0-6.2 |
| F6D5D | FC6D5 | NR | NR | 0.6-2.5 | 1.0-6.2 |
| F6E5D | FC6E5 | NR | NR | 0.6-2.5 | 1.0-6.2 |
| F6A6D | FC6A6 | NR | NR | 0.6-2.5 | 1.0-6.2 |
| F6B6D | FC6B6 | NR | NR | 0.6-2.5 | 1.0-6.2 |
| F6C6D | FC6C6 | NR | NR | 0.6-2.5 | 1.0-6.2 |
| F6D6D | FC6D6 | NR | NR | 0.6-2.5 | 1.0-6.2 |
| F6E6D | FC6E6 | NR | NR | 0.6-2.5 | 1.0-6.2 |
| F7A1D | FC7A1 | NR | NR | 0.6-2.5 | 1.0-6.2 |
| F7B1D | FC7B1 | NR | NR | 0.6-2.5 | 1.0-6.2 |
| F7C1D | FC7C1 | NR | NR | 0.6-2.5 | 1.0-6.2 |
| F7D1D | FC7D1 | NR | NR | 0.6-2.5 | 1.0-6.2 |
| F7E1D | FC7E1 | NR | NR | 0.6-2.5 | 1.0-6.2 |
| F7A2D | FC7A2 | NR | NR | 0.6-2.5 | 1.0-6.2 |
| F7B2D | FC7B2 | NR | NR | 0.6-2.5 | 1.0-6.2 |
| F7C2D | FC7C2 | NR | NR | 0.6-2.5 | 1.0-6.2 |
| F7D2D | FC7D2 | NR | NR | 0.6-2.5 | 1.0-6.2 |
| F7E2D | FC7E2 | NR | NR | 0.6-2.5 | 1.0-6.2 |
| F7A3D | FC7A3 | NR | NR | 0.6-2.5 | 1.0-6.2 |
| F7B3D | FC7B3 | NR | NR | 0.6-2.5 | 1.0-6.2 |
| F7C3D | FC7C3 | NR | NR | 0.6-2.5 | 1.0-6.2 |
| F7D3D | FC7D3 | NR | NR | 0.6-2.5 | 1.0-6.2 |
| F7E3D | FC7E3 | NR | NR | 0.6-2.5 | 1.0-6.2 |
| F7A4D | FC7A4 | NR | NR | 0.6-2.5 | 1.0-6.2 |
| F7B4D | FC7B4 | NR | NR | 0.6-2.5 | 1.0-6.2 |
| F7C4D | FC7C4 | NR | NR | 0.6-2.5 | 1.0-6.2 |
| F7D4D | FC7D4 | NR | NR | 0.6-2.5 | 1.0-6.2 |
| F7E4D | FC7E4 | NR | NR | 0.6-2.5 | 1.0-6.2 |
| F7A5D | FC7A5 | NR | NR | 0.6-2.5 | 1.0-6.2 |
| F7B5D | FC7B5 | NR | NR | 0.6-2.5 | 1.0-6.2 |
| F7C5D | FC7C5 | NR | NR | 0.6-2.5 | 1.0-6.2 |
| F7D5D | FC7D5 | NR | NR | 0.6-2.5 | 1.0-6.2 |
| F7E5D | FC7E5 | NR | NR | 0.6-2.5 | 1.0-6.2 |
| F7A6D | FC7A6 | NR | NR | 0.6-2.5 | 1.0-6.2 |
| F7B6D | FC7B6 | NR | NR | 0.6-2.5 | 1.0-6.2 |
| F7C6D | FC7C6 | NR | NR | 0.6-2.5 | 1.0-6.2 |
| F7D6D | FC7D6 | NR | NR | 0.6-2.5 | 1.0-6.2 |
| F7E6D | FC7E6 | NR | NR | 0.6-2.5 | 1.0-6.2 |
| F8A1D | FC8A1 | NR | NR | 0.6-2.5 | 1.0-6.2 |
| F8B1D | FC8B1 | NR | NR | 0.6-2.5 | 1.0-6.2 |
| F8C1D | FC8C1 | NR | NR | 0.6-2.5 | 1.0-6.2 |
| F8D1B | FC8D1 | NR | NR | 0.6-2.5 | 1.0-6.2 |
| F8E1D | FC8E1 | NR | NR | 0.6-2.5 | 1.0-6.2 |
| F8A2B | FC8A2 | NR | NR | 0.6-2.5 | 1.0-6.2 |
| F8B2D | FC8B2 | NR | NR | 0.6-2.5 | 1.0-6.2 |
| F8C2D | FC8C2 | NR | NR | 0.6-2.5 | 1.0-6.2 |
| F8D2D | FC8D2 | NR | NR | 0.6-2.5 | 1.0-6.2 |
| F8E2D | FC8E2 | NR | NR | 0.6-2.5 | 1.0-6.2 |
| F8A3D | FC8A3 | NR | NR | 0.6-2.5 | 1.0-6.2 |
| F8B3D | FC8B3 | NR | NR | 0.6-2.5 | 1.0-6.2 |
| F8C3D | FC8C3 | NR | NR | 0.6-2.5 | 1.0-6.2 |
| F8D3D | FC8D3 | NR | NR | 0.6-2.5 | 1.0-6.2 |
| F8E3D | FC8E3 | NR | NR | 0.6-2.5 | 1.0-6.2 |
| F8A4D | FC8A4 | NR | NR | 0.6-2.5 | 1.0-6.2 |
| F8B4D | FC8B4 | NR | NR | 0.6-2.5 | 1.0-6.2 |
| F8C4D | FC8C4 | NR | NR | 0.6-2.5 | 1.0-6.2 |
| F8D4D | FC8D4 | NR | NR | 0.6-2.5 | 1.0-6.2 |
| F8E4D | FC8E4 | NR | NR | 0.6-2.5 | 1.0-6.2 |
| F8A5D | FC8A5 | NR | NR | 0.6-2.5 | 1.0-6.2 |
| F8B5D | FC8B5 | NR | NR | 0.6-2.5 | 1.0-6.2 |
| F8C5D | FC8C5 | NR | NR | 0.6-2.5 | 1.0-6.2 |
| F8D5D | FC8D5 | NR | NR | 0.6-2.5 | 1.0-6.2 |
| F8E5D | FC8E5 | NR | NR | 0.6-2.5 | 1.0-6.2 |
| F8A6D | FC8A6 | NR | NR | 0.6-2.5 | 1.0-6.2 |
| F8B6D | FC8B6 | NR | NR | 0.6-2.5 | 1.0-6.2 |
| F8C6D | FC8C6 | NR | NR | 0.6-2.5 | 1.0-6.2 |
| F8D6D | FC8D6 | NR | NR | 0.6-2.5 | 1.0-6.2 |
| F8E6D | FC8E6 | NR | NR | 0.6-2.5 | 1.0-6.2 |
| F1A1E | FC1A1 | >25% | 0.05-0.1 | 0.6-2.5 | 1.0-6.2 |
| F1B1E | FC1B1 | NR | NR | 0.6-2.5 | 1.0-6.2 |
| F1C1E | FC1C1 | NR | NR | 0.6-2.5 | 1.0-6.2 |
| F1D1E | FC1D1 | NR | NR | 0.6-2.5 | 1.0-6.2 |
| F1E1E | FC1E1 | NR | NR | 0.6-2.5 | 1.0-6.2 |
| F1A2E | FC1A2 | NR | NR | 0.6-2.5 | 1.0-6.2 |
| F1B2E | FC1B2 | NR | NR | 0.6-2.5 | 1.0-6.2 |
| F1C2E | FC1C2 | NR | NR | 0.6-2.5 | 1.0-6.2 |
| F1D2E | FC1D2 | NR | NR | 0.6-2.5 | 1.0-6.2 |
| F1E2E | FC1E2 | NR | NR | 0.6-2.5 | 1.0-6.2 |
| F1A3E | FC1A3 | NR | NR | 0.6-2.5 | 1.0-6.2 |
| F1B3E | FC1B3 | NR | NR | 0.6-2.5 | 1.0-6.2 |
| F1C3E | FC1C3 | NR | NR | 0.6-2.5 | 1.0-6.2 |
| F1D3E | FC1D3 | NR | NR | 0.6-2.5 | 1.0-6.2 |
| F1E3E | FC1E3 | NR | NR | 0.6-2.5 | 1.0-6.2 |
| F1A4E | FC1A4 | NR | NR | 0.6-2.5 | 1.0-6.2 |
| F1B4E | FC1B4 | NR | NR | 0.6-2.5 | 1.0-6.2 |
| F1C4E | FC1C4 | NR | NR | 0.6-2.5 | 1.0-6.2 |
| F1D4E | FC1D4 | NR | NR | 0.6-2.5 | 1.0-6.2 |
| F1E4E | FC1E4 | NR | NR | 0.6-2.5 | 1.0-6.2 |
| F1A5E | FC1A5 | NR | NR | 0.6-2.5 | 1.0-6.2 |
| F1B5E | FC1B5 | NR | NR | 0.6-2.5 | 1.0-6.2 |
| F1C5E | FC1C5 | NR | NR | 0.6-2.5 | 1.0-6.2 |
| F1D5E | FC1D5 | NR | NR | 0.6-2.5 | 1.0-6.2 |
| F1E5E | FC1E5 | NR | NR | 0.6-2.5 | 1.0-6.2 |
| F1A6E | FC1A6 | NR | NR | 0.6-2.5 | 1.0-6.2 |
| F1B6E | FC1B6 | NR | NR | 0.6-2.5 | 1.0-6.2 |
| F1C6E | FC1C6 | NR | NR | 0.6-2.5 | 1.0-6.2 |
| F1D6E | FC1D6 | NR | NR | 0.6-2.5 | 1.0-6.2 |
| F1E6E | FC1E6 | NR | NR | 0.6-2.5 | 1.0-6.2 |
| F2A1E | FC2A1 | NR | NR | 0.6-2.5 | 1.0-6.2 |
| F2B1E | FC2B1 | NR | NR | 0.6-2.5 | 1.0-6.2 |
| F2C1E | FC2C1 | NR | NR | 0.6-2.5 | 1.0-6.2 |
| F2D1E | FC2D1 | NR | NR | 0.6-2.5 | 1.0-6.2 |
| F2E1E | FC2E1 | NR | NR | 0.6-2.5 | 1.0-6.2 |
| F2A2E | FC2A2 | NR | NR | 0.6-2.5 | 1.0-6.2 |
| F2B2E | FC2B2 | NR | NR | 0.6-2.5 | 1.0-6.2 |
| F2C2E | FC2C2 | NR | NR | 0.6-2.5 | 1.0-6.2 |
| F2D2E | FC2D2 | NR | NR | 0.6-2.5 | 1.0-6.2 |
| F2E2E | FC2E2 | NR | NR | 0.6-2.5 | 1.0-6.2 |
| F2A3E | FC2A3 | NR | NR | 0.6-2.5 | 1.0-6.2 |
| F2B3E | FC2B3 | NR | NR | 0.6-2.5 | 1.0-6.2 |
| F2C3E | FC2C3 | NR | NR | 0.6-2.5 | 1.0-6.2 |
| F2D3E | FC2D3 | NR | NR | 0.6-2.5 | 1.0-6.2 |
| F2E3E | FC2E3 | NR | NR | 0.6-2.5 | 1.0-6.2 |
| F2A4E | FC2A4 | NR | NR | 0.6-2.5 | 1.0-6.2 |
| F2B4E | FC2B4 | NR | NR | 0.6-2.5 | 1.0-6.2 |
| F2C4E | FC2C4 | NR | NR | 0.6-2.5 | 1.0-6.2 |
| F2D4E | FC2D4 | NR | NR | 0.6-2.5 | 1.0-6.2 |
| F2E4E | FC2E4 | NR | NR | 0.6-2.5 | 1.0-6.2 |
| F2A5E | FC2A5 | NR | NR | 0.6-2.5 | 1.0-6.2 |
| F2B5E | FC2B5 | NR | NR | 0.6-2.5 | 1.0-6.2 |
| F2C5E | FC2C5 | NR | NR | 0.6-2.5 | 1.0-6.2 |
| F2D5E | FC2D5 | NR | NR | 0.6-2.5 | 1.0-6.2 |
| F2E5E | FC2E5 | NR | NR | 0.6-2.5 | 1.0-6.2 |
| F2A6E | FC2A6 | NR | NR | 0.6-2.5 | 1.0-6.2 |
| F2B6E | FC2B6 | NR | NR | 0.6-2.5 | 1.0-6.2 |
| F2C6E | FC2C6 | NR | NR | 0.6-2.5 | 1.0-6.2 |
| F2D6E | FC2D6 | NR | NR | 0.6-2.5 | 1.0-6.2 |
| F2E6E | FC2E6 | NR | NR | 0.6-2.5 | 1.0-6.2 |
| F3A1E | FC3A1 | NR | NR | 0.6-2.5 | 1.0-6.2 |
| F3B1E | FC3B1 | NR | NR | 0.6-2.5 | 1.0-6.2 |
| F3C1E | FC3C1 | NR | NR | 0.6-2.5 | 1.0-6.2 |
| F3D1E | FC3D1 | NR | NR | 0.6-2.5 | 1.0-6.2 |
| F3E1E | FC3E1 | NR | NR | 0.6-2.5 | 1.0-6.2 |
| F3A2E | FC3A2 | NR | NR | 0.6-2.5 | 1.0-6.2 |
| F3B2E | FC3B2 | NR | NR | 0.6-2.5 | 1.0-6.2 |
| F3C2E | FC3C2 | NR | NR | 0.6-2.5 | 1.0-6.2 |
| F3D2E | FC3D2 | NR | NR | 0.6-2.5 | 1.0-6.2 |
| F3E2E | FC3E2 | NR | NR | 0.6-2.5 | 1.0-6.2 |
| F3A3E | FC3A3 | NR | NR | 0.6-2.5 | 1.0-6.2 |
| F3B3E | FC3B3 | NR | NR | 0.6-2.5 | 1.0-6.2 |
| F3C3E | FC3C3 | NR | NR | 0.6-2.5 | 1.0-6.2 |
| F3D3E | FC3D3 | NR | NR | 0.6-2.5 | 1.0-6.2 |
| F3E3E | FC3E3 | NR | NR | 0.6-2.5 | 1.0-6.2 |
| F3A4E | FC3A4 | NR | NR | 0.6-2.5 | 1.0-6.2 |
| F3B4E | FC3B4 | NR | NR | 0.6-2.5 | 1.0-6.2 |
| F3C4E | FC3C4 | NR | NR | 0.6-2.5 | 1.0-6.2 |
| F3D4E | FC3D4 | NR | NR | 0.6-2.5 | 1.0-6.2 |
| F3E4E | FC3E4 | NR | NR | 0.6-2.5 | 1.0-6.2 |
| F3A5E | FC3A5 | NR | NR | 0.6-2.5 | 1.0-6.2 |
| F3B5E | FC3B5 | NR | NR | 0.6-2.5 | 1.0-6.2 |
| F3C5E | FC3C5 | NR | NR | 0.6-2.5 | 1.0-6.2 |
| F3D5E | FC3D5 | NR | NR | 0.6-2.5 | 1.0-6.2 |
| F3E5E | FC3E5 | NR | NR | 0.6-2.5 | 1.0-6.2 |
| F3A6E | FC3A6 | NR | NR | 0.6-2.5 | 1.0-6.2 |
| F3B6E | FC3B6 | NR | NR | 0.6-2.5 | 1.0-6.2 |
| F3C6E | FC3C6 | NR | NR | 0.6-2.5 | 1.0-6.2 |
| F3D6E | FC3D6 | NR | NR | 0.6-2.5 | 1.0-6.2 |
| F3E6E | FC3E6 | NR | NR | 0.6-2.5 | 1.0-6.2 |
| F4A1E | FC4A1 | NR | NR | 0.6-2.5 | 1.0-6.2 |
| F4B1E | FC4B1 | NR | NR | 0.6-2.5 | 1.0-6.2 |
| F4C1E | FC4C1 | NR | NR | 0.6-2.5 | 1.0-6.2 |
| F4D1E | FC4D1 | NR | NR | 0.6-2.5 | 1.0-6.2 |
| F4E1E | FC4E1 | NR | NR | 0.6-2.5 | 1.0-6.2 |
| F4A2E | FC4A2 | NR | NR | 0.6-2.5 | 1.0-6.2 |
| F4B2E | FC4B2 | NR | NR | 0.6-2.5 | 1.0-6.2 |
| F4C2E | FC4C2 | NR | NR | 0.6-2.5 | 1.0-6.2 |
| F4D2E | FC4D2 | NR | NR | 0.6-2.5 | 1.0-6.2 |
| F4E2E | FC4E2 | NR | NR | 0.6-2.5 | 1.0-6.2 |
| F4A3E | FC4A3 | NR | NR | 0.6-2.5 | 1.0-6.2 |
| F4B3E | FC4B3 | NR | NR | 0.6-2.5 | 1.0-6.2 |
| F4C3E | FC4C3 | NR | NR | 0.6-2.5 | 1.0-6.2 |
| F4D3E | FC4D3 | NR | NR | 0.6-2.5 | 1.0-6.2 |
| F4E3E | FC4E3 | NR | NR | 0.6-2.5 | 1.0-6.2 |
| F4A4E | FC4A4 | NR | NR | 0.6-2.5 | 1.0-6.2 |
| F4B4E | FC4B4 | NR | NR | 0.6-2.5 | 1.0-6.2 |
| F4C4E | FC4C4 | NR | NR | 0.6-2.5 | 1.0-6.2 |
| F4D4E | FC4D4 | NR | NR | 0.6-2.5 | 1.0-6.2 |
| F4E4E | FC4E4 | NR | NR | 0.6-2.5 | 1.0-6.2 |
| F4A5E | FC4A5 | NR | NR | 0.6-2.5 | 1.0-6.2 |
| F4B5E | FC4B5 | NR | NR | 0.6-2.5 | 1.0-6.2 |
| F4C5E | FC4C5 | NR | NR | 0.6-2.5 | 1.0-6.2 |
| F4D5E | FC4D5 | NR | NR | 0.6-2.5 | 1.0-6.2 |
| F4E5E | FC4E5 | NR | NR | 0.6-2.5 | 1.0-6.2 |
| F4A6E | FC4A6 | NR | NR | 0.6-2.5 | 1.0-6.2 |
| F4B6E | FC4B6 | NR | NR | 0.6-2.5 | 1.0-6.2 |
| F4C6E | FC4C6 | NR | NR | 0.6-2.5 | 1.0-6.2 |
| F4D6E | FC4D6 | NR | NR | 0.6-2.5 | 1.0-6.2 |
| F4E6E | FC4E6 | NR | NR | 0.6-2.5 | 1.0-6.2 |
| F5A1E | FC5A1 | NR | NR | 0.6-2.5 | 1.0-6.2 |
| F5B1E | FC5B1 | NR | NR | 0.6-2.5 | 1.0-6.2 |
| F5C1E | FC5C1 | NR | NR | 0.6-2.5 | 1.0-6.2 |
| F5D1E | FC5D1 | NR | NR | 0.6-2.5 | 1.0-6.2 |
| F5E1E | FC5E1 | NR | NR | 0.6-2.5 | 1.0-6.2 |
| F5A2E | FC5A2 | NR | NR | 0.6-2.5 | 1.0-6.2 |
| F5B2E | FC5B2 | NR | NR | 0.6-2.5 | 1.0-6.2 |
| F5C2E | FC5C2 | NR | NR | 0.6-2.5 | 1.0-6.2 |
| F5D2E | FC5D2 | NR | NR | 0.6-2.5 | 1.0-6.2 |
| F5E2E | FC5E2 | NR | NR | 0.6-2.5 | 1.0-6.2 |
| F5A3E | FC5A3 | NR | NR | 0.6-2.5 | 1.0-6.2 |
| F5B3E | FC5B3 | NR | NR | 0.6-2.5 | 1.0-6.2 |
| F5C3E | FC5C3 | NR | NR | 0.6-2.5 | 1.0-6.2 |
| F5D3E | FC5D3 | NR | NR | 0.6-2.5 | 1.0-6.2 |
| F5E3E | FC5E3 | NR | NR | 0.6-2.5 | 1.0-6.2 |
| F5A4E | FC5A4 | NR | NR | 0.6-2.5 | 1.0-6.2 |
| F5B4E | FC5B4 | NR | NR | 0.6-2.5 | 1.0-6.2 |
| F5C4E | FC5C4 | NR | NR | 0.6-2.5 | 1.0-6.2 |
| F5D4E | FC5D4 | NR | NR | 0.6-2.5 | 1.0-6.2 |
| F5E4E | FC5E4 | NR | NR | 0.6-2.5 | 1.0-6.2 |
| F5A5E | FC5A5 | NR | NR | 0.6-2.5 | 1.0-6.2 |
| F5B5B | FC5E5 | NR | NR | 0.6-2.5 | 1.0-6.2 |
| F5C5E | FC5C5 | NR | NR | 0.6-2.5 | 1.0-6.2 |
| F5D5E | FC5D5 | NR | NR | 0.6-2.5 | 1.0-6.2 |
| F5E5E | FC5E5 | NR | NR | 0.6-2.5 | 1.0-6.2 |
| F5A6E | FC5A6 | NR | NR | 0.6-2.5 | 1.0-6.2 |
| F5B6E | FC5B6 | NR | NR | 0.6-2.5 | 1.0-6.2 |
| F5C6E | FC5C6 | NR | NR | 0.6-2.5 | 1.0-6.2 |
| F5D6E | FC5D6 | NR | NR | 0.6-2.5 | 1.0-6.2 |
| F5E6E | FC5E6 | NR | NR | 0.6-2.5 | 1.0-6.2 |
| F6A1E | FC6A1 | NR | NR | 0.6-2.5 | 1.0-6.2 |
| F6B1E | FC6B1 | NR | NR | 0.6-2.5 | 1.0-6.2 |
| F6C1E | FC6C1 | NR | NR | 0.6-2.5 | 1.0-6.2 |
| F6D1E | FC6D1 | NR | NR | 0.6-2.5 | 1.0-6.2 |
| F6E1E | FC6E1 | NR | NR | 0.6-2.5 | 1.0-6.2 |
| F6A2E | FC6A2 | NR | NR | 0.6-2.5 | 1.0-6.2 |
| F6B2E | FC6E2 | NR | NR | 0.6-2.5 | 1.0-6.2 |
| F6C2E | FC6C2 | NR | NR | 0.6-2.5 | 1.0-6.2 |
| F6D2E | FC6D2 | NR | NR | 0.6-2.5 | 1.0-6.2 |
| F6E2E | FC6E2 | NR | NR | 0.6-2.5 | 1.0-6.2 |
| F6A3E | FC6A3 | NR | NR | 0.6-2.5 | 1.0-6.2 |
| F6B3E | FC6B3 | NR | NR | 0.6-2.5 | 1.0-6.2 |
| F6C3E | FC6C3 | NR | NR | 0.6-2.5 | 1.0-6.2 |
| F6D3E | FC6D3 | NR | NR | 0.6-2.5 | 1.0-6.2 |
| F6E3E | FC6E3 | NR | NR | 0.6-2.5 | 1.0-6.2 |
| F6A4E | FC6A4 | NR | NR | 0.6-2.5 | 1.0-6.2 |
| F6B4E | FC6B4 | NR | NR | 0.6-2.5 | 1.0-6.2 |
| F6C4E | FC6C4 | NR | NR | 0.6-2.5 | 1.0-6.2 |
| F6D4E | FC6D4 | NR | NR | 0.6-2.5 | 1.0-6.2 |
| F6E4E | FC6E4 | NR | NR | 0.6-2.5 | 1.0-6.2 |
| F6A5E | FC6A5 | NR | NR | 0.6-2.5 | 1.0-6.2 |
| F6B5E | FC6B5 | NR | NR | 0.6-2.5 | 1.0-6.2 |
| F6C5E | FC6C5 | NR | NR | 0.6-2.5 | 1.0-6.2 |
| F6D5E | FC6D5 | NR | NR | 0.6-2.5 | 1.0-6.2 |
| F6E5E | FC6E5 | NR | NR | 0.6-2.5 | 1.0-6.2 |
| F6A6E | FC6A6 | NR | NR | 0.6-2.5 | 1.0-6.2 |
| F6B6E | FC6B6 | NR | NR | 0.6-2.5 | 1.0-6.2 |
| F6C6E | FC6C6 | NR | NR | 0.6-2.5 | 1.0-6.2 |
| F6D6E | FC6D6 | NR | NR | 0.6-2.5 | 1.0-6.2 |
| F6E6E | FC6E6 | NR | NR | 0.6-2.5 | 1.0-6.2 |
| F7A1E | FC7A1 | NR | NR | 0.6-2.5 | 1.0-6.2 |
| F7B1E | FC7B1 | NR | NR | 0.6-2.5 | 1.0-6.2 |
| F7C1E | FC7C1 | NR | NR | 0.6-2.5 | 1.0-6.2 |
| F7D1E | FC7D1 | NR | NR | 0.6-2.5 | 1.0-6.2 |
| F7E1E | FC7E1 | NR | NR | 0.6-2.5 | 1.0-6.2 |
| F7A2E | FC7A2 | NR | NR | 0.6-2.5 | 1.0-6.2 |
| F7B2E | FC7B2 | NR | NR | 0.6-2.5 | 1.0-6.2 |
| F7C2E | FC7C2 | NR | NR | 0.6-2.5 | 1.0-6.2 |
| F7D2E | FC7D2 | NR | NR | 0.6-2.5 | 1.0-6.2 |
| F7E2E | FC7E2 | NR | NR | 0.6-2.5 | 1.0-6.2 |
| F7A3E | FC7A3 | NR | NR | 0.6-2.5 | 1.0-6.2 |
| F7B3E | FC7B3 | NR | NR | 0.6-2.5 | 1.0-6.2 |
| F7C3E | FC7C3 | NR | NR | 0.6-2.5 | 1.0-6.2 |
| F7D3E | FC7D3 | NR | NR | 0.6-2.5 | 1.0-6.2 |
| F7E3E | FC7E3 | NR | NR | 0.6-2.5 | 1.0-6.2 |
| F7A4E | FC7A4 | NR | NR | 0.6-2.5 | 1.0-6.2 |
| F7B4E | FC7B4 | NR | NR | 0.6-2.5 | 1.0-6.2 |
| F7C4E | FC7C4 | NR | NR | 0.6-2.5 | 1.0-6.2 |
| F7D4E | FC7D4 | NR | NR | 0.6-2.5 | 1.0-6.2 |
| F7E4E | FC7E4 | NR | NR | 0.6-2.5 | 1.0-6.2 |
| F7A5E | FC7A5 | NR | NR | 0.6-2.5 | 1.0-6.2 |
| F7B5E | FC7B5 | NR | NR | 0.6-2.5 | 1.0-6.2 |
| F7C5E | FC7C5 | NR | NR | 0.6-2.5 | 1.0-6.2 |
| F7D5E | FC7D5 | NR | NR | 0.6-2.5 | 1.0-6.2 |
| F7E5E | FC7E5 | NR | NR | 0.6-2.5 | 1.0-6.2 |
| F7A6E | FC7A6 | NR | NR | 0.6-2.5 | 1.0-6.2 |
| F7B6E | FC7B6 | NR | NR | 0.6-2.5 | 1.0-6.2 |
| F7C6E | FC7C6 | NR | NR | 0.6-2.5 | 1.0-6.2 |
| F7D6E | FC7D6 | NR | NR | 0.6-2.5 | 1.0-6.2 |
| F7E6E | FC7E6 | NR | NR | 0.6-2.5 | 1.0-6.2 |
| F8A1E | FC8A1 | NR | NR | 0.6-2.5 | 1.0-6.2 |
| F8B1E | FC8B1 | NR | NR | 0.6-2.5 | 1.0-6.2 |
| F8C1E | FC8C1 | NR | NR | 0.6-2.5 | 1.0-6.2 |
| F8D1E | FC8D1 | NR | NR | 0.6-2.5 | 1.0-6.2 |
| F8E1E | FC8E1 | NR | NR | 0.6-2.5 | 1.0-6.2 |
| F8A2E | FC8A2 | NR | NR | 0.6-2.5 | 1.0-6.2 |
| F8B2E | FC8B2 | NR | NR | 0.6-2.5 | 1.0-6.2 |
| F8C2E | FC8C2 | NR | NR | 0.6-2.5 | 1.0-6.2 |
| F8D2E | FC8D2 | NR | NR | 0.6-2.5 | 1.0-6.2 |
| F8E2E | FC8E2 | NR | NR | 0.6-2.5 | 1.0-6.2 |
| F8A3E | FC8A3 | NR | NR | 0.6-2.5 | 1.0-6.2 |
| F8B3E | FC8B3 | NR | NR | 0.6-2.5 | 1.0-6.2 |
| F8C3E | FC8C3 | NR | NR | 0.6-2.5 | 1.0-6.2 |
| F8D3E | FC8D3 | NR | NR | 0.6-2.5 | 1.0-6.2 |
| F8E3E | FC8E3 | NR | NR | 0.6-2.5 | 1.0-6.2 |
| F8A4E | FC8A4 | NR | NR | 0.6-2.5 | 1.0-6.2 |
| F8B4E | FC8B4 | NR | NR | 0.6-2.5 | 1.0-6.2 |
| F8C4E | FC8C4 | NR | NR | 0.6-2.5 | 1.0-6.2 |
| F8D4E | FC8D4 | NR | NR | 0.6-2.5 | 1.0-6.2 |
| F8E4E | FC8E4 | NR | NR | 0.6-2.5 | 1.0-6.2 |
| F8A5E | FC8A5 | NR | NR | 0.6-2.5 | 1.0-6.2 |
| F8B5E | FC8B5 | NR | NR | 0.6-2.5 | 1.0-6.2 |
| F8C5E | FC8C5 | NR | NR | 0.6-2.5 | 1.0-6.2 |
| F8D5E | FC8D5 | NR | NR | 0.6-2.5 | 1.0-6.2 |
| F8E5E | FC8E5 | NR | NR | 0.6-2.5 | 1.0-6.2 |
| F8A6E | FC8A6 | NR | NR | 0.6-2.5 | 1.0-6.2 |
| F8B6E | FC8B6 | NR | NR | 0.6-2.5 | 1.0-6.2 |
| F8C6E | FC8C6 | NR | NR | 0.6-2.5 | 1.0-6.2 |
| F8D6E | FC8D6 | NR | NR | 0.6-2.5 | 1.0-6.2 |
| F8E6E | FC8E6 | NR | NR | 0.6-2.5 | 1.0-6.2 |

The foams of the present invention have wide utility. The present foams, including each of Foams 1-4 and foams F1-F11, have unexpected advantage in applications requiring low density and/or good compression and/or tensile and/or shear properties, and/or long-term stability, and/or sustainable sourcing, and/or being made from recycled material and being recyclable. In particular, the present foams, including each of Foams 1-6 and each of foams F1-F8, have unexpected advantage in: wind energy applications (wind turbine blades (shear webs, shells, cores, and root); marine applications (hulls, decks, superstructures, bulkheads, stringers, and interiors); industrial low weight applications; automotive and transport applications (interior and exterior of cars, trucks, trains, aircraft, and spacecraft).

PEF:PET copolymers can be formed by any means to those known to those skilled in the art, including but not limited to those procedures described in the Examples hereof.

The foams of the present invention, including each of s 1-4, are formed from either PEF homopolymers, PEF copolymers, PEF:PET copolymers or a combination/mixture of these.

The foams, including each of Foams 1-4, may be formed in preferred embodiments from PEF homopolymer in which the polymer has at least 99.5% by weight, or at least 99.9% of by weight, of ethylene furanoate moieties.

It is contemplated that the foams of the present invention, including each of Foams 1-3, may be formed in preferred embodiments from PEF copolymer in which the polymer, including PEF copolymer that has from about 10% to about 99% by weight of ethylene furanoate moieties. The invention includes foams, including each of Foams 1-3, wherein the thermoplastic polymer consists essentially of the components as described in the following table:

| | RELATIVE MOLE % | | |
|---|---|---|---|
| Thermoplastic | Ethylene | Ethylene | MOLECULAR |
| Polymer | furanoate | terephthalate | WEIGHT, |
| (TMP) | moieties | moieties | g/mol |
| TMP1A | 100 | 0 | 25,000-140,000 |
| TMP1B | 100 | 0 | 50,000-130,000 |
| TMP1C | 100 | 0 | 60,000-130,000 |
| TMP1D | 100 | 0 | 70,000-130,000 |
| TMP1E | 100 | 0 | 80,000-130,000 |
| TMP1F | 100 | 0 | 85,000-110,000 |
| TMP2A | 90 | 10 | 25,000-140,000 |
| TMP2B | 90 | 10 | 50,000-130,000 |
| TMP2C | 90 | 10 | 60,000-130,000 |
| TMP2D | 90 | 10 | 70,000-130,000 |
| TMP2E | 80 | 20 | 80,000-130,000 |
| TMP2F | 90 | 20 | 85,000-110,000 |
| TMP3A | 80 | 20 | 25,000-140,000 |
| TMP3B | 80 | 20 | 50,000-130,000 |
| TMP3C | 80 | 20 | 60,000-130,000 |
| TMP3D | 80 | 20 | 70,000-130,000 |
| TMP3E | 80 | 20 | 80,000-130,000 |
| TMP3F | 80 | 20 | 85,000-110,000 |
| TMP4A | 70 | 30 | 25,000-140,000 |
| TMP4B | 70 | 30 | 50,000-130,000 |
| TMP4C | 70 | 30 | 60,000-130,000 |
| TMP4D | 70 | 30 | 70,000-130,000 |
| TMP4E | 70 | 30 | 80,000-130,000 |
| TMP4F | 70 | 30 | 85,000-110,000 |
| TMP5A | 60 | 40 | 25,000-140,000 |
| TMP5B | 60 | 40 | 50,000-130,000 |
| TMP5C | 60 | 40 | 60,000-130,000 |
| TMP5D | 60 | 40 | 70,000-130,000 |
| TMP5E | 60 | 40 | 80,000-130,000 |
| TMP5F | 60 | 40 | 85,000-110,000 |
| TMP6A | 50 | 50 | 25,000-140,000 |
| TMP6B | 50 | 50 | 50,000-130,000 |
| TMP6C | 50 | 50 | 60,000-130,000 |
| TMP6D | 50 | 50 | 70,000-130,000 |
| TMP6E | 50 | 50 | 80,000-130,000 |
| TMP6F | 50 | 50 | 85,000-110,000 |
| TMP7A | 40 | 60 | 25,000-140,000 |
| TMP7B | 40 | 60 | 50,000-130,000 |
| TMP7C | 40 | 60 | 60,000-130,000 |
| TMP7D | 40 | 60 | 70,000-130,000 |
| TMP7E | 40 | 60 | 80,000-130,000 |
| TMP7F | 40 | 60 | 85,000-110,000 |
| TMP8A | 30 | 70 | 25,000-140,000 |
| TMP8B | 30 | 70 | 50,000-130,000 |
| TMP8C | 30 | 70 | 60,000-130,000 |
| TMP8D | 30 | 70 | 70,000-130,000 |
| TMP8E | 30 | 70 | 80,000-130,000 |
| TMP8F | 30 | 70 | 85,000-110,000 |
| TMP9A | 20 | 80 | 25,000-140,000 |
| TMP9B | 20 | 80 | 50,000-130,000 |
| TMP9C | 20 | 80 | 60,000-130,000 |
| TMP9D | 20 | 80 | 70,000-130,000 |
| TMP9E | 20 | 80 | 80,000-130,000 |
| TMP9F | 20 | 80 | 85,000-110,000 |
| TMP10A | 10 | 90 | 25,000-140,000 |
| TMP10B | 10 | 90 | 50,000-130,000 |
| TMP10C | 10 | 90 | 60,000-130,000 |
| TMP10D | 10 | 90 | 70,000-130,000 |
| TMP10E | 10 | 90 | 80,000-130,000 |
| TMP10F | 10 | 90 | 85,000-110,000 |
| TMP11A | 5 | 95 | 25,000-140,000 |
| TMP11B | 5 | 95 | 50,000-130,000 |
| TMP11C | 5 | 95 | 60,000-130,000 |
| TMP11D | 5 | 95 | 70,000-130,000 |
| TMP11E | 5 | 95 | 80,000-130,000 |
| TMP11F | 5 | 95 | 85,000-110,000 |
| TMP12A | 2.5 | 97.5 | 25,000-140,000 |
| TMP12B | 2.5 | 97.5 | 50,000-130,000 |
| TMP12C | 2.5 | 97.5 | 60,000-130,000 |
| TMP12D | 2.5 | 97.5 | 70,000-130,000 |
| TMP12E | 2.5 | 97.5 | 80,000-130,000 |
| TMP12F | 2.5 | 97.5 | 85,000-110,000 |
| TMP13A | 1 | 99 | 25,000-140,000 |
| TMP13B | 1 | 99 | 50,000-130,000 |
| TMP13C | 1 | 99 | 60,000-130,000 |
| TMP13D | 1 | 99 | 70,000-130,000 |
| TMP13E | 1 | 99 | 80,000-130,000 |
| TMP13F | 1 | 99 | 85,000-110,000 |
| TMP14A | 0.5 | 99 | 25,000-140,000 |
| TMP14B | 0.5 | 99.5 | 50,000-130,000 |
| TMP14C | 0.5 | 99.5 | 60,000-130,000 |
| TMP14D | 0.5 | 99.5 | 70,000-130,000 |
| TMP14E | 0.5 | 99.5 | 80,000-130,000 |
| TMP14F | 0.5 | 99.5 | 85,000-110,000 |

The foams of the present invention, including each of Foams 1-3, can comprise closed cell walls comprising each of the thermoplastic polymers of the present invention, including each of TMP1-TMP12 describe in the table above.

For those embodiments of the present invention involving PEF copolymers, it is contemplated that those skilled in the art will be able, in view of the teachings contained herein, to select the type in an amount of co-polymeric materials to be used within each of the ranges described herein to achieve the desired enhancement/modification of the polymer without undue experimentation.

It is contemplated that the TMPs of the present invention may be formed with a variety of physical properties, including the following ranges of polymer characteristics, which are measured as described in the Examples hereof:

| Polymer | Broad | Intermediate | Narrow |
|---|---|---|---|
| property | Range | Range | Range |
| Glass | 80-100 | 85-95 | 90-95 |
| Transition | | | |
| Temperature, | | | |
| T_{g}, ° C. | | | |
| Melting | 190-250 | 200-240 | 210-230 |
| Temperature, | | | |
| Tₘ, ° C. | | | |
| Decomposition | 300-420 | 320-400 | 330-370 |
| Temperature, | | | |
| T_{d}, ° C. | | | |
| Crystallinity, % | 25-75 | 30-60 | 40-50 |

In general, it is contemplated that those skilled in the art will be able to formulate PEF polymers within the range of properties described above without undue experimentation in view of the teachings contained herein. In preferred embodiments, however, PEF polymer according to the present invention (including PEF:PET copolymers of the present invention), having these properties is achieved using one or more of the synthesis methods described above, in combination with a variety of known supplemental processing techniques, including by treatment with chain extenders, such as PMDA, and/or SSP processing.

### Foams and Foaming Process

The foams of the present invention are thermoplastic foams, and generally it is contemplated that any one or more of a variety of known techniques for forming a thermoplastic foam can be used in view of the disclosures contained herein, and all such techniques and all foams formed thereby or within the broad scope of the present invention.

In general, the forming step involves introducing into the PEF according to the present invention a blowing agent to form a foamable PEF composition comprising PEF and blowing agent. One example of a preferred method for forming such a foamable composition is to plasticize the PEF, preferably comprising heating the PEF to it melt temperature, preferably above its melt temperature, and thereafter exposing the PEF melt to the blowing agent under conditions effective to incorporate (preferably by solubilizing) the desired amount of blowing agent into the polymer melt.

Foaming processes of the present invention and include batch, semi-batch, continuous processes, and combinations of two or more of these. Batch processes generally involve preparation of at least one portion of the foamable polymer composition in a storable state and then using that portion of foamable polymer composition at some future point in time to prepare a foam. Semi-batch process involves preparing at least a portion of a foamable polymer composition and intermittently expanding that foamable polymer composition into a foam all in a single process. For example, U.S. Pat. No. 4,323,528, herein incorporated by reference, discloses a process for making thermoplastic foams via an accumulating extrusion process. The present invention thus includes processes that comprises: 1) mixing PEF thermoplastic polymer and a blowing agent of the present invention under conditions to form a foamable PEF composition; 2) extruding the foamable PEF composition into a holding zone maintained at a temperature and pressure which does not allow the foamable composition to foam, where the holding zone preferably comprises a die defining an orifice opening into a zone of lower pressure at which the foamable polymer composition foams and an openable gate closing the die orifice; 3) periodically opening the gate while substantially concurrently applying mechanical pressure by means of a movable ram on the foamable polymer composition to eject it from the holding zone through the die orifice into the zone of lower pressure, and 4) allowing the ejected foamable polymer composition to expand, under the influence of the blowing agent, to form the foam.

The present invention also can use continuous processes for forming the foam. By way of example such a continuous process involves forming a foamable PEF composition and then expanding that foamable PEF composition without substantial interruption. For example, a foamable PEF composition may be prepared in an extruder by heating the selected PEF polymer resin to form a PEF melt, incorporating into the PEF melt a blowing agent of the present invention, preferably by solubilizing the blowing agent into the PEF melt at an initial pressure to form a foamable PEF composition comprising a substantially homogeneous combination of PEF and blowing agent, and then extruding that foamable PEF composition through a die into a zone at a selected foaming pressure and allowing the foamable PEF composition to expand into a foam under the influence of the blowing agent. Optionally, the foamable PEF composition which comprises the PEF polymer and the incorporated blowing agent, may be cooled prior to extruding the composition through the die to enhance certain desired properties of the resulting foam.

The foamable composition according to preferred aspects of the present invention may optionally contain additional additives, including but not limited to chain extension agents (including preferred chain extension agents as described hereinafter and in the Examples), chain branching agents (including preferred chain branching agents as described hereinafter and in the Examples), such as nucleating agents, cell-controlling agents, dyes, pigments, fillers, antioxidants, extrusion aids, stabilizing agents, antistatic agents, fire retardants, IR attenuating agents and thermally insulating additives. Nucleating agents include, among others, materials such as talc, calcium carbonate, sodium benzoate, and chemical blowing agents such azodicarbonamide or sodium bicarbonate and citric acid. IR attenuating agents and thermally insulating additives can include carbon black, graphite, silicon dioxide, metal flake or powder, among others. Flame retardants can include, among others, brominated materials such as hexabromocyclodecane and polybrominated biphenyl ether. Each of the above-noted additional optional additives can be introduced into the foam at various times and that various locations in the process according to known techniques, and all such additives and methods of addition or within the broad scope of the present invention.

In preferred embodiments, the foams of the present invention are formed in a commercial extrusion apparatus and have the properties as indicated in the following table, with the values being measured as indicated in the table and as supplemented in the Examples hereof and being understood to be modified by “about”:

| Foam | | |
|---|---|---|
| property | | |
| Foam density, | 0.07-0.09 | 0.1-0.12 |
| gm/cm³ (ISO | | |
| 845) | | |
| Tensile Strength | =>3.9 | =>4.7 |
| (ASTM C297), | | |
| MPa | | |
| Compressive | =>2.3 | =>3.7 |
| strength (ISO | | |
| 844), MPa | | |
| Average Cell Size, | 15-30 | 25-40 |
| (SEM) | | |

The foams of the present invention have wide utility. The present foams, including each of Foams 1-3, have unexpected advantage in applications requiring low density and/or good compression and/or tensile and/or shear properties, and/or long-term stability, and/or sustainable sourcing, and/or being made from recycled material and being recyclable. In particular, the present foams, including each of Foams 1-3, have unexpected advantage in: wind energy applications (wind turbine blades (shear webs, shells, cores, and nacelles); marine applications (hulls, decks, superstructures, bulkheads, stringers, and interiors); industrial low weight applications; automotive and transport applications (interior and exterior of cars, trucks, trains, aircraft, and spacecraft).

### Examples

Without limiting the full scope of the present invention, Applicants have conducted a series of experiments for the purposes of demonstrating the utility of the PEF homopolymers and the PEF-based copolymers of the present invention and to compare the performance of the inventive foams made in accordance with the present invention to foams made from PET. These tests involved the synthesis of a series of PET polymers covering a range of physical properties, including molecular weights, crystallinities and melting points. Applicants also prepared a series of PEF polymers (including homopolymers and copolymers) over a similar range of physical properties. A series of foams were prepared using the highly preferred 1234ze(E) as the blowing agent. Foams prepared using other halogenated C3 and C4 olefin blowing agents according to the present invention were also tested. A consistent set of extrusion processing conditions for a given range of comparable polymer properties are utilized. The details of each of these sets of extrusion results are explained in detail in the examples which follow. By way of summary, the following table provides some of the important polymer properties and an indication of advantages of the inventive foams over comparable foams made with PET homopolymer.

| | Polymer Properties | | | Extrusion Conditions | | |
|---|---|---|---|---|---|---|
| | | MW | | Melt | | |
| | | kg/ | Crystallinity, | Temp. | Blowing | Notes on advantage/ |
| Example | Type | mole | % | ° C. | Agent | unexpected results |
| C1 | PET | 105.3 | 13.9 | 275 | 1234ze(E) | Comparative |
| C2 | PET | 95.6 | 33.3 | 275 | 1234ze(E) | Comparative |
| | PET | 83.9 | 41 | 265 | 1234ze(E) | Comparative |
| | PET | 80.9 | 31.9 | 265 | 1234ze(E) | Comparative |
| E1 | PEF | 41.2 | 36.6 | 240 | 1234ze(E) | Shows unexpected |
| | PEF | 75 | 42 | 240 | 1234ze(E) | strength advantage for |
| | | | | | | PEF, over PET though |
| | | | | | | PEF MW is lower |
| E2 | PEF | 90.8 | 54 | 240 | 1234ze(E) | Shows substantial strength |
| | PEF | 96.078 | 53.6 | 240 | 1234ze(E) | advantage for PEF over |
| | | | | | | PET (1.6-2.2 times) at |
| | | | | | | comparable MW |
| E3 | PEF9:PET1 | 117.9(PET) | 25.5% | 250 | 1234ze(E) | Compared to PET, shows |
| | | | | | | strength advantage of |
| | | | | | | copolymer with only 10% |
| | | | | | | PEF over a wide density |
| | | | | | | range (1.2-2.1 times) |
| C3 | PET | 95.6 | 33.3 | 265-275 | 1234ze(E) | Comparative |
| E4 | PEF | 96.7 | 53.6 | 230-240 | 1234ze(E) | Shows substantial strength |
| | | | | | | advantage of PEF over |
| | | | | | | PET (1.5-3 times) |
| E5 | PET9:PEF1 | 44.9(PET) | 28.6 | 260 | 1234ze(E) | Compared to PET, shows |
| | | | | | | strength advantage of |
| | | | | | | copolymer with only 10% |
| | | | | | | PEF (1.1 times strength at |
| | | | | | | 1.1 times lower density) |
| | | | | | | though copolymer MW is |
| | | | | | | ½ as much |
| E6 | PET99:PEF1 | 97.2(PET) | 28.8 | 260 | 1234ze(E) | Compared to PET shows |
| | PET99:PEF1 | 92.2(PET) | 33.5 | 270 | 1234ze(E) | strength advantage of |
| | | | | | | copolymer with only 1% |
| | | | | | | PEF (1.2-1.3 times) over |
| | | | | | | wide range of RFDs |
| E7 | PET19:PEF1 | 46.4 | 30.2 | 260 | 1234ze(E) | Shows comparable strength |
| | | | | | | to PET with MW that is |
| | | | | | | more than 2X greater |
| E8 | PET19:PEF1 | 72.5(PET) | 27.6 | 260 | 1234ze(E) | Compared to PET |
| | PET19:PEF1 | 79(PET) | 32 | 260 | 1234ze(E) | copolymer with only 5% |
| | | | | | | PEF shows comparable |
| | | | | | | strength though |
| | | | | | | crystallinity of copolymer |
| | | | | | | is 18% lower and MW is |
| | | | | | | 16% lower than PET |
| E9 | PET19:PEF1 | 62.4(PET) | 26.1 | 260 | 1234ze(E) | Compared to PET, shows |
| | | | | | | comparable strength with |
| | | | | | | copolymer with only 5% |
| | | | | | | PEF though copolymer |
| | | | | | | has 35% lower MW |
| E10 | PET19:PEF1 | 79(PET) | 32 | 260 | 1234ze(E) | Compared to PET, shows |
| | | | | | | comparable strength for |
| | | | | | | copolymer with only 5% |
| | | | | | | PEF though copolymer |
| | | | | | | has 20% lower MW |
| E11 | PET19:PEF1 | 83(PET) | 20.7 | 260 | 1234ze(E) | Compared to PET, shows |
| | | | | | | comparable strength with |
| | | | | | | copolymer with only 5% |
| | | | | | | PEF though copolymer |
| | | | | | | has 38% lower crystallinity |
| E12 | PET9:PEF1 | 56.7(PET) | 33.9 | 260 | 1234ze(E) | Compared to PET/PMDA, |
| | With ADR | | | | | this copolymer with 10% |
| | PET9:PEF1 With | 69.9:60.8 | 22.8 | 260 | 1234ze(E) | PEF with ADR additive |
| | PMDA + talc | | | | | shows comparable strength |
| | | | | | | though copolymer MW is |
| | | | | | | 60% lower wide range of |
| | | | | | | RFD |
| E14 | PET9:PEF1 | 47 | 5.2 | 260 | 1234ze(E) | Compared to PET/PMDA, |
| | | | | | | copolymer with 10% PEF |
| | | | | | | with PENTA additive |
| | | | | | | shows superior strength |
| | | | | | | though copolymer has 2X |
| | | | | | | lower MW and 7X lower |
| | | | | | | crystallinity |
| E14B | PEF9:PET1 | 117.9:90.4 | 25.5% | 250 | 1336mzz(Z) | Shows utility of 1336mzz(Z) |
| | | | | | 1233zd(E) | and 1233zd(E) to make PEF |
| | | | | | | foam with good expansion. |

As shown by the table above, for each polymer, a unique set of extrusion conditions are identified for the extrusion experiments. The extrusion conditions are kept substantially constant, except for the amount of blowing agent, to generate strength data as a function of polymer expansion or foam relative density (RFD) in these foaming experiments. The extrusion conditions were selected to ensure suitable expansion and foam formation.

The foams thus produced throughout the Examples in this application, were tested to determine the density of foam using a method which corresponds generally to ASTM D71, except that hexane was used for displacement instead of water. In order to facilitate comparison of the densities of the foam produced in these examples, applicants have reported foam density as Relative Foam Density (RFD), which is the density of the foam measured as described above divided by the density of the starting polymer. In this document all foam densities, whether they originate from PEF or PET homopolymers or from PEF-PET copolymers, have been normalized by the density of PEF polymer, 1.43 g/cc, which is about 7% less dense than PET. This way, when strengths of various polymeric foams are compared at the same RFD, they are also compared at the same overall density.

In addition, each of the foams produced in these examples were tested to determine tensile strength and compressive strength. The tensile strength and compressive strength measurements were based on the guidelines provided in ASTM C297 and ISO 844, respectively, with the measurement in each case in the direction of extrusion but with testing of samples without seams or weld lines.

After taking these measurements, applicants found that the foam produced in Example C3B4-1 below had tensile strength values and compressive strength values that were equivalent to (i.e., within about 10% of) the values expected for commercially available PET foam samples (110 kg/m3) tested under the applicants' experimental conditions. Accordingly, in order to facilitate comparison of the test results provided here, the tensile strength values and compressive strength values of the foam produced in Example C2B4-1 were each set to a baseline value of 1, and all other foam strength results reported in these examples are reported on a relative basis to the foam of C2B4-1 as Relative Tensile Strength (“RTS”) and Relative Compressive Strength (“RCS”). For example, a foam that is measured to have a tensile strength that is two (2) times greater than the tensile strength measured for Example C2B4-1 is reported as an RTS of 2.

### Comparative Example C1A—PET Homopolymer Preparation at Molecular Weight of 105.3 kg/mol with PMDA and SSP¹

¹ Designation of an example herein as “Comparative” should not be interpreted as an indication that the example represents any item of prior art and instead only that it is presented for the purposes of comparison to preferred aspects of the invention as presented in other examples.

A homopolymer of PET having a of molecular weight of from about 105 kg/mol was made using the additives and polymer formation procedures as described in Synthesis Example C1A below.

The homopolymer thus produced, which is designated PETC1 was tested and found to have the characteristics as reported in Table C1 below 2:
² Throughout these examples, molecular weight as determined and referenced herein refers to molecular weight determination by diffusion ordered nuclear magnetic resonance spectroscopy (DOSY NMR) as per the description contained in “Application of 1H DOSY NMR in Measurement of Polystyrene Molecular Weights,” VNU Journal of Science: Natural Sciences and Technology, Vol. 36, No. 2 (2020) 16-21 Jun. 2020, Nam et a, except for differences in the solvents used. The reference above used 3 mg of polystyrene and 0.5 ml of deuterated chloroform. For these examples, NMR measurements were made with the dissolved portion of 2-3 mg of polymer in a 0.6 ml mixture of 50 vol % deuterated chloroform+50 vol % trifluoroacetic acid.

TABLE C1

| | Example C1 |
|---|---|
| Designation | PETC1A |
| PET Homopolymer | 105.3 |
| Molecular Weight | |
| Glass Transition | 81.9 |
| Temperature, ° C. | |
| Melting Point, ° C. | 242 |
| Decomposition | 384 |
| Temperature, ° C. | |
| Crystallinity, % | 13.9 |

### Comparative Examples C1B—PET Foam Preparation Using PET1A with 1234ze(E) Blowing Agent

In a series of runs, polymer as indicated in the Table C1A above is extruded in a commercial extrusion apparatus The extrusion conditions used, including the amount of the blowing agent and the melt temperature and pressure, were determined after several tests, based on the ability to form acceptable foams with RFD values in the desired range.

The extruded foams that are produced in this Comparative Example 1B are tested and are found to have the properties as reported in Table C1B below.

TABLE C1B

| Example→ | C1BA | C1BB | C1BC | C1BD | C1BE |
|---|---|---|---|---|---|
| MATERIAL | | | | | |
| Polymer | PETC1A (105.3K) | PETC1A (105.3K) | PETC1A (105.3K) | PETC1A (105.3K) | PETC1A (105.3K) |
| (MW) | | | | | |
| Blowing Agent* | 1234ze(E) | 1234ze(E) | 1234ze(E) | 1234ze(E) | 1234ze(E) |
| FOAMP | | | | | |
| ROPERTIES | | | | | |
| RFD | 0.069 | 0.087 | 0.136 | 0.154 | 0.167 |
| Actual TS, MP | 0.45 | 0.81 | 1.29 | 2.13 | 2.27 |
| RTS | 0.42 | 0.75 | 1.19 | 1.97 | 2.1 |
| Actual CS, MP | 0.53 | 0.32 | 0.88 | 1.02 | 1.48 |
| RCS | 0.88 | 0.53 | 1.47 | 1.7 | 2.47 |
| RTS + RCS | 1.30 | 1.28 | 2.66 | 3.67 | 4.57 |

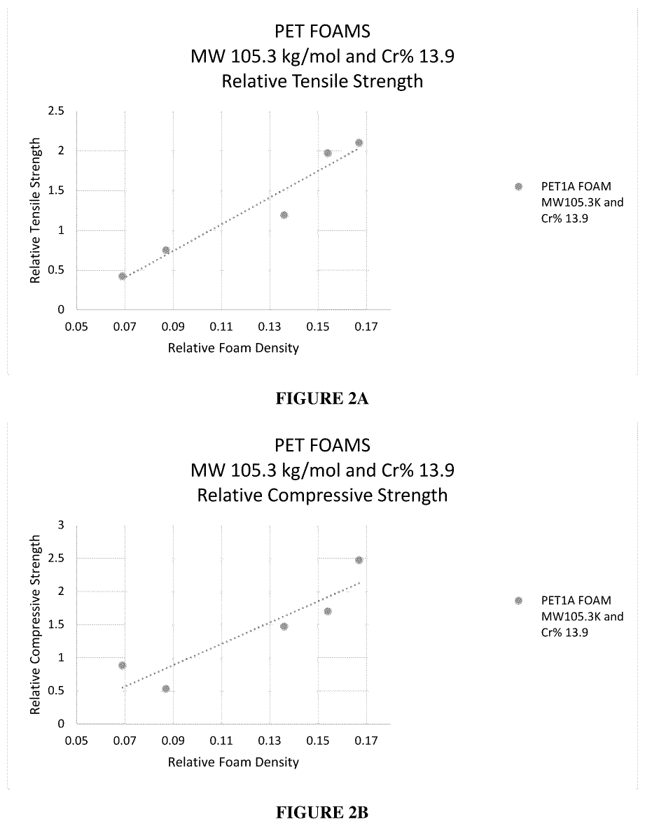

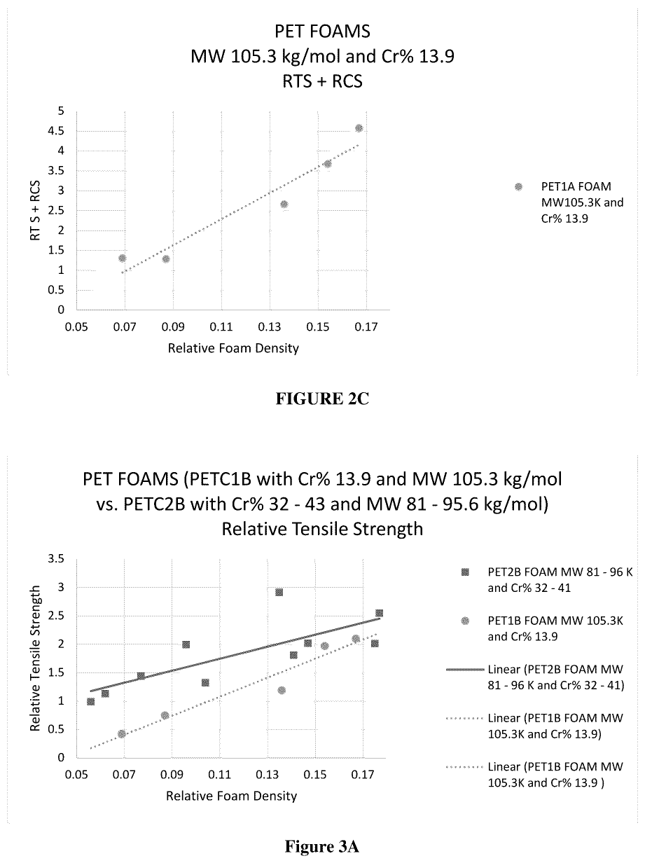

The relative tensile strength, relative compressive strength and combined relative tensile and compressive strength results (hereinafter referred to as “RTS+RCS”) for the foams reported in Table C1B above are plotted in FIGS. 2A-2C, as a function of relative foam density (RFD), with a dashed line being used to show a linear representation of the tensile strength data as a function of relative foam density.

The charts illustrate the generally expected increase in tensile strength and compressive strength of PET foam with increasing foam density over this density range (the dashed line constituting the straight-line trend for the data).

### Comparative Example 2A—PET Homopolymer Preparation at Molecular Weights in the Range of 80-96 kg/mol and Crystallinity of 32-43 with PMDA and SSP

Four (4) PET homopolymers were prepared by polycondensation yielding polymer products having a range of molecular size from about 80 kg/mol to about of 96 kg/mol using the procedures describe in Synthesis Example C2A1, Synthesis Example C2A2, Synthesis Example C2A3, and a variation of these to achieve the polymer with a molecular weight of 83,900 identified as PETC2A4 below.

The PET polymers are designated herein as PETC2A1, PETC2A2, PETC2A3 and PETC2A4 and were tested and found to have the characteristics as reported in Table C2A below:

TABLE C2A

| | Example | Example | Example | Example |
|---|---|---|---|---|
| | C2A1 | C2A2 | C2A3 | C2A4 |
| Designation | PETC2A1 | PETC2A2 | PETC2A3 | PETC2A4 |
| PET | 95,596 | 80,871 | 80,900 | 83,900 |
| Homopolymer | | | | |
| Molecular Weight | | | | |
| Glass Transition | 74 | 74.9 | 76.1 | 76 |
| Temperature, ° C. | | | | |
| Melting Point, ° C. | 219 | 230 | 225 | 227 |
| Decomposition | 382 | 378 | 386 | 376 |
| Temperature, ° C. | | | | |
| Crystallinity, % | 33.3 | 42.9 | 31.9 | 41 |

As noted from the table above, each of the PET homopolymers was produced utilizing the preferred high crystallinity aspects of the present invention and therefore includes an unexpectedly high strength for PET foams made using the present blowing agents compared to PET foams that are made from PET polymers that do not use this aspect of the present invention, as illustrated, by comparison to the results from Comparative Example 1A.

### Comparative Example 2B: PET Foam Preparation Using PETC2A1, PETC2A2, PETC2A3 and PETC2A4 with 1234ze(E) Blowing Agent

In a series of runs, polymer as indicated in the Table C2A above is extruded to form foam. The conditions used, including the amount of the blowing agent and the melt temperature and pressure, are determined after several tests, based on the ability to form acceptable foams with RFD values in the range of about 0.05 to about 0.2.

The PET foams thus produced in this Example C2B are tested and found to have the properties as reported in Table C2B below.

TABLE C2B

| | Example | | | | | | | | | | |
|---|---|---|---|---|---|---|---|---|---|---|---|
| | C2B1-1 | C3B2-1 | C2B1-2 | C2B1-3 | C2B1-4 | C2B2-2 | C2B3-1 | C2B3-2 | C2B2-3 | C2B2-4 | C2B4-1 |
| MATERIAL | | | | | | | | | | | |
| Polymer | PET2A1 | PET2A2 | PET2A1 | PET2A1 | PET2A1 | PET2A2 | PET2A3 | PET2A | PET2A3 | PET3A3 | PET3A3 |
| (MW, K) | 95.6 | 80.9 | 95.6 | 95.6 | 95.6 | 80.9 | 80.9 | 80.9 | 80.9 | 80.9 | 83.9 |
| Blowing | 1234ze(E) | | | | | | | | | | |
| Agent | | | | | | | | | | | |
| FOAM | | | | | | | | | | | |
| PROPERTY | | | | | | | | | | | |
| RFD | 0.062 | 0.056 | 0.077 | 0.135 | 0.147 | .141 | 0.096 | 0.104 | 0.175 | 0.177 | 0.096 |
| Avg. RFD | 0.059 | | | | | | | | 0.176 | | |
| Actual TS, | 1.22 | 1.07 | 1.55 | 3.14 | 2.02 | 1.96 | 2.15 | 1.43 | 2.17 | 2.75 | 1.08 |
| Mp | | | | | | | | | | | |
| RTS | 1.13 | 0.99 | 1.44 | 2.91 | 1.87 | 1.81 | 1.99 | 1.32 | 2.01 | 2.55 | 1 |
| Avg RTS | 1.06 | | | | | | | | 2.28 | | |
| Actual CS, | 0.29 | 0.45 | 0.69 | 1.99 | 1.44 | 0.88 | 0.86 | 1 | 1.15 | 1.15 | 0.6 |
| Mp | | | | | | | | | | | |
| RCS | 0.48 | 0.75 | 1.15 | 3.32 | 2.4 | 1.47 | 1.73 | 1.67 | 1.92 | 1.97 | 1 |
| | 0.615 | | | | | | | | 1.945 | | |
| RTS + RCS | 1.61 | 1.74 | 2.59 | 6.22 | 4.27 | 3.28 | 3.42 | 2.99 | 3.92 | 4.46 | 2 |
| Avg | 1.68 | | | | | | | | 4.215 | | |
| RTS + RCS | | | | | | | | | | | |

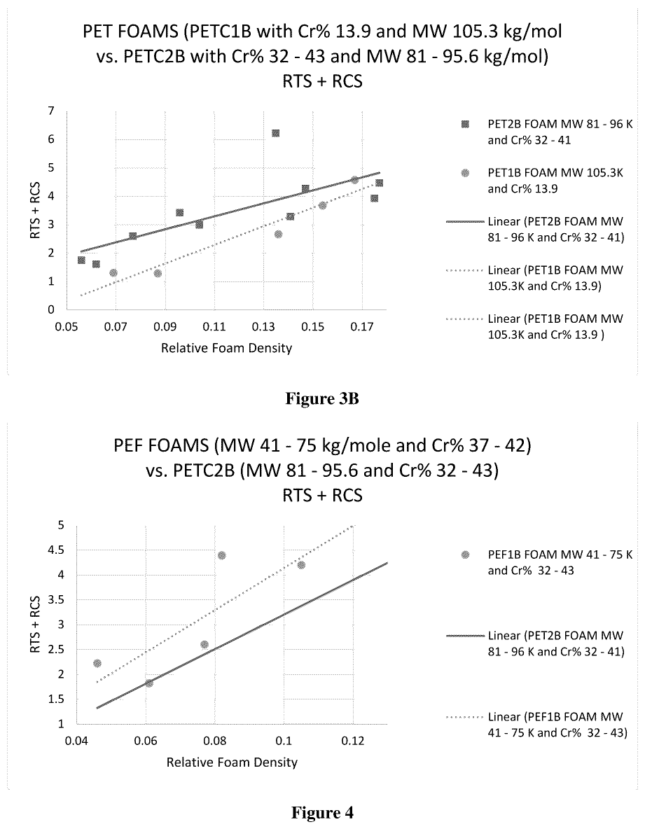

The unexpected ability to achieve high strength PET foams of relatively low density with relatively high molecular weight and improved crystallinity using the preferred blowing agents of the present invention to form extruded foam, including the HFO-1234ze blowing agent used in this example, is illustrated in the FIGS. 3A and 3B, which compares the TS and the RTS+RCS results of the C2B1, C2B2 and C2B3 data of this Comparative Example to Comparative Example 1B.

The data provided by this example demonstrates the aspect of applicant's invention related to the unexpected advantage that is achieved by forming high strength, low density extruded thermoplastic foam, including both PET foam and PEF foams (including PEF copolymers), with relatively high crystallinity. In particular, by utilizing a PET polymer with a crystallinity of greater than about 20%, and even more preferably greater than about 30%, as is the case with Example C2B, the tensile strength and the RTS+RCS of the extruded foam is unexpectedly improved by about 2 times compared even to the polymer with higher molecular weight but lower (i.e., 13.9%) crystallinity.

### Example 1A—PEF Homopolymer Preparation with MW of from about 41 and 75 kg/mol with PMDA and SSP and a Crystallinity of 36%-42%

Two homopolymers of PEF were made yielding polymer products having a range of molecular size from about 41 kg/mol to about of 75 kg/mol using the additives and polymer formation procedures as described in Synthesis Examples 1A1 and 1A2.

The PEF polymers are designated herein as PEF1A1 and PEF1A2 and were tested using the measurement protocols as described above in Comparative Example 1A and found to have the characteristics reported in Table E1A below:

TABLE E1A

| | Example 1A1 | |
|---|---|---|
| | (PEF1A1) | Example 1A2 |
| | 36935-35- | (PEF1A2) |
| | addit-SSP 2nd | 36935-2-3 |
| Molecular Weight, g/mol | 41159 | 75000 |
| Glass Transition | 91.9 | 90.2 |
| Temperature, ° C. | | |
| Melting Point, ° C. | 212 | 222 |
| Decomposition | 340 | 346 |
| Temperature, ° C. | | |
| Crystallinity, % | 36.6 | 42 |

The PEF polymers produced in these examples are referred to in Table E1 above and hereinafter as PEFA, and PEF1A2.

### Example 1B—Extruded PEF Foam Preparation Using PEF1A1 and PEF1A2 with Trans1234ze Blowing Agent

One extruded foam is made using PEF1A1 and four foams are made using PEF1A2 and, as described herein, using foam extrusion processes that were designed using the same criteria as described in Comparative Example 1B. The foams thus produced are tested and found to have the properties as reported in Table E1B below.

TABLE E1B

| Example→ | E1B1 | E1B2-1 | E1B2-2 | E1B2-3 | E1B2-4 |
|---|---|---|---|---|---|
| MATERIALS | | | | | |
| Polymer | PEF1A1 (41.2) | PEF1A2 (75) | PEF1A2 (75) | PEF1A2 (75) | PEF1A2 (75) |
| (MW, K) | | | | | |
| Blowing Agent* | 1234ze(E) | 1234ze(E) | 1234ze(E) | 1234ze(E) | 1234ze(E) |
| FOAM | | | | | |
| PROPERTIES | | | | | |
| RFD | 0.082 | 0.046 | 0.061 | 0.077 | 0.105 |
| TS, MPa | 2.45 | 1.25 | 0.99 | 2.09 | 2.61 |
| RTS | 2.27 | 1.16 | 0.92 | 1.94 | 2.42 |
| CS, MPa | 1.27 | 0.64 | 0.54 | 0.4 | 1.07 |
| RCS | 2.12 | 1.07 | 0.9 | 0.67 | 1.78 |
| RTS + RCS | 4.39 | 2.22 | 1.82 | 2.6 | 4.2 |

As revealed by the data in Table E1B above, applicants have surprisingly found that extruded PEF foams according to the present invention possess unexpectedly high tensile strength and compressive strength values compared to PET foams (based on the trendline) at approximately equivalent crystallinities, even when comparted to extruded PET foams which use the higher crystallinity values according to the present invention and having substantially higher molecular weights than the extruded PEF foams. This is illustrated in FIG. 4, for example, by comparison to the trend line of the foams formed from the PET of Comparative Example 1A over the range of relative foam densities of from 0.04 to 0.13, especially considering that the molecular weight of the extruded PEF foams of the present example are substantially lower than the molecular weight of the extruded PET foams.

As revealed by the chart above and all of the Examples presented herein, the extruded PEF foams of the present invention exhibit dramatically superior strength properties compared to extruded PET foams. With particular reference to the chart above, even though it is generally the case that strength of a foam increases with increasing molecular weight, the present extruded PEF foams are substantially stronger (with crystallinities in the same range) than the extruded PET foams even though the molecular weights of the extruded PEF foam are substantially lower than that of the extruded PET foams. Thus, for example, the trendline of the PEF in the chart at an RFD of about of 0.08 has an RTS+RCS that is 1.3 times greater than the PET trendline, which is based on extruded PET foams formed with much higher molecular weights. This result is highly advantageous and unexpected.

### Example 2A—PEF Homopolymer Preparation with MW Range of about 90-96 kg/mol (with PMDA and SSP)

Two homopolymers of PEF were made yielding polymer products having a molecular size of about 90 kg/mol and about 96 kg/mol using the additives and polymer formation procedures as described in Synthesis Examples 2A1 and 2A2.

The PEF polymers thus produced were tested using the measurement protocols as described above in Comparative Example 1A and found to have the characteristics reported in Table E2A below:

TABLE E2A

| | Example 2A1 | Example 2A2 |
|---|---|---|
| | (PEF2A1) | (PEF2A2) |
| | 36935-2-4 | 36935-32-9 |
| Molecular Weight, g/mol | 90,800 | 96,078 |
| Glass Transition | 92 | 91.4 |
| Temperature, ° C. | | |
| Melting Point, ° C. | 202 | 204.7 |
| Decomposition | 335 | 329 |
| Temperature, ° C. | | |
| Crystallinity, % | 54 | 53.6 |

The PEF polymers produced in these examples are referred to in Table E2A above and hereinafter as PEF2A1 and PEF2A2.

### Example 2B—Extruded PEF Foam Preparation Using PEF1A1 and PEF1A2 with Trans1234ze Blowing Agent

Three foams are made using PEF2A1 and one foam is made using PEF2A2 as described herein using foaming processes that were designed using the same criteria as described in Comparative Example 1B. The foams thus produced are tested and found to have the properties as reported in Table E2B below.

TABLE E2B

| Example→ | E2B1-1 | E2B1-2 | E2B1-3 | E2B2 |
|---|---|---|---|---|
| MATERIALS | | | | |
| Polymer | PEF1A1 (90.8) | PEF1A1 (90.8) | PEF1A1 (90.8) | PEF1A2 (96.7) |
| (MW, K) | | | | |
| Blowing Agent* | 1234ze(E) | 1234ze(E) | 1234ze(E) | 1234ze(E) |
| FOAM | | | | |
| PROPERTIES | | | | |
| RFD | 0.077 | 0.082 | 0.084 | 0.138 |
| TS, MPa | 2.97 | 2.81 | 3.09 | 3.73 |
| RTS | 2.75 | 2.60 | 2.86 | 3.45 |
| CS, MPa | 0.84 | 1.29 | 0.97 | 2.77 |
| RCS | 1.40 | 2.15 | 1.62 | 4.62 |
| RTS + RCS | 4.15 | 4.75 | 4.48 | 8.07 |

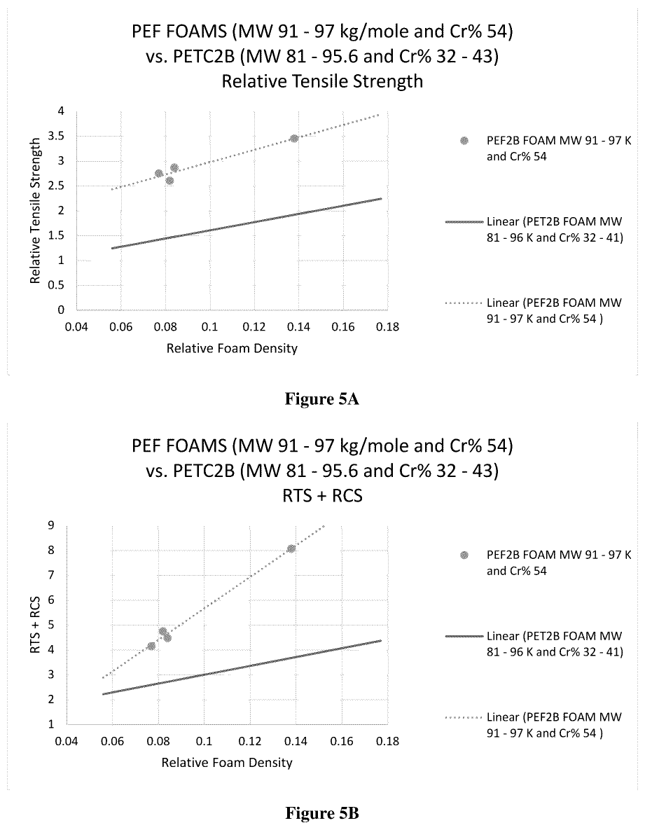

As revealed by the data in Table E1B above, applicants have surprisingly found that extruded PEF foams according to the present invention possess unexpectedly high tensile strength and RTS+RCS values. This is illustrated, for example, by reference to the foams formed from the extruded PET of Comparative Example 2A, as illustrated in FIGS. 5A and 5B, which include for comparison purposes the extruded PET data from Table C2B and the trend line for all of the extruded PET data from Table C2B.

As can be seen from the results of this example, the extruded PEF homopolymer foams of the present invention produce unexpectedly superior strength compared to extruded PET homopolymer foams made using the same foam formation techniques of the present invention, including the preferred HFO-1234ze blowing agent of the present invention.

One unexpected advantage of the present invention that is illustrated by this example is the significantly higher relative tensile strength and the RTS+RCS of the foam, as summarized in the following Table E2C:

TABLE E2C

| | Inventive Extruded PEF | Inventive Extruded PEF |
|---|---|---|
| | Performance Advantage over | Performance Advantage over |
| | trendline Extruded PETC2B | trendline Extruded PETC2B |
| | performance at RFS of 0.08 | performance at RFS of 0.14 |
| | PET C2B | PET C2B |
| Advantage | 1.8 times | 1.75 times |
| of | better | better |
| Inventive | | |
| in RTS | | |
| Advantage | 1.6 times | 2.2 times |
| in RTS + | better | better |
| RCS | | |

The results as summarized in Table E1C above are especially unexpected considering that the extruded PET foams of this example are not disclosed in the prior art, that is, the extruded PET results incorporate the preferred aspects of the present invention relating to the formation of foams from polymers of relatively high crystallinity and high molecular weight and using a preferred blowing agent of the present invention, that is, HFO-1234ze(E). In addition, extruded the PEF-based foams blown with HFO-1234ze(E) of the present invention also are unexpectedly superior to extruded PEF-based foams of the present invention when blown with other halogenated olefin blowing agents, as shown in Example 14 hereof.

### Example 3A—PET9:PEF1 Copolymer Preparation with MW of about 117.9 kg/mol with PMDA

A block copolymer of PET9:PEF1 (9:1 mole ratio) was prepared with a target molecular weight of about 117,900 g/mol for the PET portion of the copolymer using the additives and polymer formation procedures as described in Synthesis Examples 3A.

The PET9:PEF1 copolymers thus produced were tested using the measurement protocols as described above in Comparative Example 1A and found to have the characteristics reported in Table E3A below:

TABLE E3A

| | Example E3A (PET9PEF1) |
|---|---|
| Molecular Weights, | 117,900 |
| PET, g/mol | |
| Glass Transition | 79 |
| Temperature, ° C. | |
| Melting Point, ° C. | 216 |
| Decomposition Temperature, ° C. | 371 |
| Crystallinity, % | 25.5 |

The PET9:PEF1 copolymer so produced is referred to in these Examples as PET9PEF1-EX3A.

### Example 3B—PEF Foam Preparation Using PET9PEF1-EX3A with Trans1234ze Blowing Agent

Six (6) foams are made from PET9PEF1-EX3A using extrusion foaming processes that were designed using the same criteria as described in Comparative Example 1. The foams thus produced are tested and found to have the properties as reported in Table E3B below:

TABLE E3B

| | Example | | | | | | |
|---|---|---|---|---|---|---|---|
| | E3B1 | E3B2 | E3B3 | E3B4 | E3B5 | E3B6 | E3B7 |
| MATERIALS | | | | | | | |
| Polymer (MW, | PET9PEF1-EX9 (117.9) | | | | | | |
| kg/mol) | | | | | | | |
| Blowing Agent* | 1234ze(E) | 1234ze(E) | 1234ze(E) | 1234ze(E) | 1234ze(E) | 1234ze(E) | 1234ze(E) |
| FOAM | | | | | | | |
| PROPERTIES | | | | | | | |
| RFD | .059 | .075 | .078 | .079 | .083 | 0.157 | 0.171 |
| Avg. RFD | | 0.079 | | | | | |
| TS, MPa | 1.28 | 1.44 | 1.42 | 1.75 | 2.53 | 2.4 | 3.77 |
| RTS | 1.19 | 1.33 | 1.31 | 1.62 | 2.34 | 2.22 | 3.49 |
| Avg. RTS | | 1.65 | | | | | |
| CS, MPa | 0.6 | .81 | 0.7 | 0.8 | 0.95 | 2.03 | 2.84 |
| RCS | 1.00 | 1.35 | 1.17 | 1.33 | 1.58 | 3.38 | 4.73 |
| Avg. RCS | | 1.36 | | | | | |
| RTS + RCS | 2.19 | 2.68 | 2.48 | 2.95 | 3.93 | 5.61 | 8.22 |

| | |
|---|---|
| Avg. RTS + RCS | 3.01 |

As revealed by the data in Table E3B above, applicants have surprisingly found that extruded foams made with PET9:PEF1-EX3B according to the present invention possess unexpectedly high strength properties.

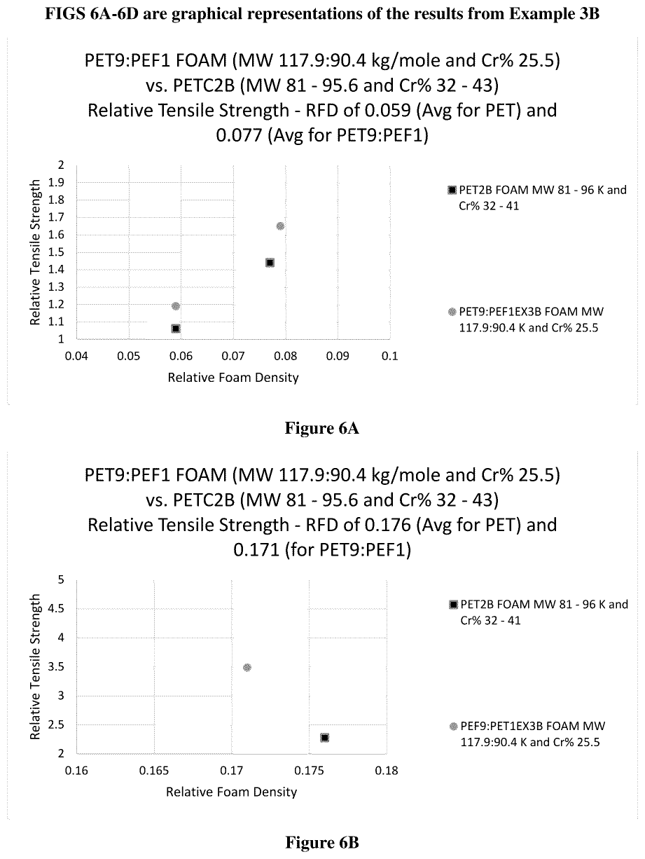

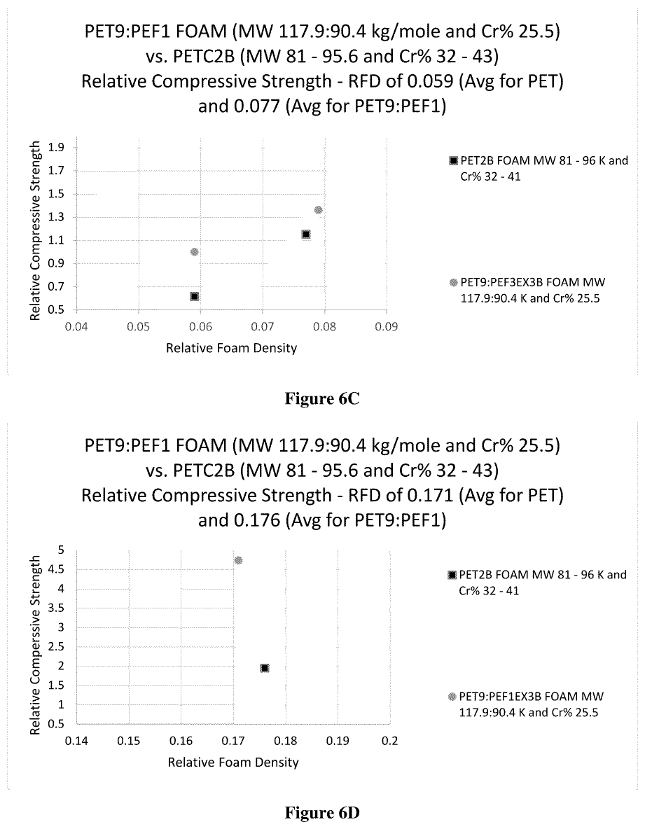

FIGS. 6A-6D show the average tensile strength values for the extruded foam in three density regions, namely, at RFDs in the range: (i) 0.056-0.062; (ii) 0.077-0.079; and 0.171-0.177 as shown in Table E3B above, and include for comparison purposes average data in the same regions for the PET data from Table C2B for the convenience of comparison.

As can be seen from the results of this example, the extruded PET9:PEF1 copolymer foams of the present invention produce unexpectedly superior strength, as is illustrated by this example in terms of the significantly higher relative tensile strength and significantly higher compressive strength of the extruded foam, over a wide range of relative densities. In particular, the extent of this unexpected advantage for this example is summarized in the following Table E3C:

TABLE E3C

| | Inventive | Inventive | Inventive |
|---|---|---|---|
| | PET9:PEF1 | PET9:PEF1 | PET9:PEF1 |
| | Performance | Performance | Performance |
| | Advantage | Advantage | Advantage |
| | over PETC2B | over PETC2B | over PETC2B |
| | performance | performance | performance |
| | at RFS of | at RFS of | at RFS of |
| | about 0.059 | about 0.077 | about 0.17 |
| | PET C2B | PET C2B | PET C2B |
| Advantage | 1.12 times | 1.15 times | 1.53 times |
| of | better | better | better |
| Inventive | | | |
| Foam in | | | |
| RTS | | | |
| Advantage | 1.63 times | 1.18 times | 2.43 times |
| of | better | better | better |
| Inventive | | | |
| Faom in | | | |
| RCS | | | |

The context of these results includes the fact that the comparative examples incorporate preferred aspects of the present invention relating to the formation of extruded foams from polymers of relatively high crystallinity and high molecular weight and preferred blowing agent of the present invention (i.e., HFO-1234ze(E)).

### Comparative Example 3B: PET Foam Preparation Using PETC2A1 and PETC2A2 with 1234ze(E) Blowing Agent

Seven foams are made (three from PETC2A1 and four from PETC2A2) using extrusion foaming processes that were designed using the same criteria as described in Comparative Example 1. The foams thus produced are tested and found to have the properties as reported in Table C3B below.

TABLE C3B

| | Example | | | | | | |
|---|---|---|---|---|---|---|---|
| | C3B1-1 | C3B2-1 | C3B1-2 | C3B2-2 | C3B1-3 | C3B1-4 | C3B1-5 |
| MATERIAL | | | | | | | |
| Polymer | PET2A1 | PET2A2 | PET2A1 | PET2A2 | PET2A1 | PET2A2 | PET2A2 |
| (MW) | (95.6K) | (80.87K) | (95.6K) | (80.87K) | (95.6K) | (95.6K) | (80.87K) |
| Blowing | 1234ze(E) | 1234ze(E) | 1234ze(E) | 1234(E)ze | 1234ze(E) | 1234ze(E) | 1234ze(E) |
| Agent* | | | | | | | |
| FOAM | | | | | | | |
| PROPERTY | | | | | | | |
| RFD | 0.062 | 0.063 | 0.086 | 0.088 | 0.104 | .129 | 0.141 |
| | 0.0625 | | | 0.096 | | | |
| Actual TS, | 1.99 | 1.86 | 3.23 | 2.88 | 2.24 | 1.59 | 2.29 |
| Mp | | | | | | | |
| RTS | 1.84 | 1.72 | 2.99 | 2.67 | 2.07 | 1.47 | 2.12 |
| Avg RTS | 1.775 | | | 2.0 | | | |
| Actual CS, | 0.43 | 0.43 | 0.64 | 0.61 | 1.31 | 0.91 | 1.78 |
| Mp | | | | | | | |
| RCS | 0.72 | 0.72 | 1.07 | 1.02 | 2.18 | 1.52 | 2.97 |
| Avg RCS | 0.072 | | | 1.6 | | | |
| Avg RCS | | | 1.05 | | 1.85 | | |
| RTS + RCS | 2.56 | 2.44 | 4.06 | 3.69 | 4.26 | 2.99 | 5.09 |
| Avg | 2.5 | | | 3.975 | | | |
| RTS + RCS | | | | | | | |

### Example 4B—PEF Foam Preparation Using PEF2A2 with Trans1234ze Blowing Agent

Six (6) foams are made using PEF2A2, as described in Table E2A and using extrusion foaming processes that are designed using the same criteria as described in Comparative Example 1B. The foams thus produced were tested and found to have the properties as reported in Table E4B below.

TABLE E4B

| | Example | | | | | |
|---|---|---|---|---|---|---|
| | E4B1 | E4B2 | E4B3 | E4B4 | E4B5 | E4B6 |
| RUNS | 110/4 | 112/2 | 110/2 | 115/2 | 113/2 | 112/1 |
| MATERIALS | | | | | | |
| Polymer (MW, K) | PEF3A | PEF3A | PEF3A | PEF3A | PEF3A | PEF3A |
| | (96.7) | (96.7) | (96.7) | (96.7) | (96.7) | (96.7) |
| Blowing Agent* | 1234ze(E) | 1234ze(E) | 1234ze(E) | 1234ze(E) | 1234ze(E) | 1234ze(E) |
| FOAM | | | | | | |
| PROPERTIES | | | | | | |
| RFD | 0.046 | 0.059 | 0.111 | 0.114 | 0.122 | .163 |
| Avg RFD | | | 0.116 | | | |
| TS, MPa | 0.54 | 0.88 | 2.5 | 3.2 | 3.3 | 2.5 |
| RTS | 0.50 | 0.81 | 2.32 | 2.93 | 3.01 | 2.3 |
| Avg RTS | | | 2.73 | | | |
| CS, MPa | 0.49 | 0.72 | 4.64 | 2.85 | 2.54 | 4.19 |
| RCS | 0.82 | 1.2 | 7.73 | 4.75 | 4.23 | 6.98 |
| Avg RCS | | | 5.57 | | | |
| RTS + RCS | 1.32 | 2.01 | 9.47 | 8.94 | 8.8 | 9.28 |

| | |
|---|---|
| Avg RTS + RCS | 8.3 |

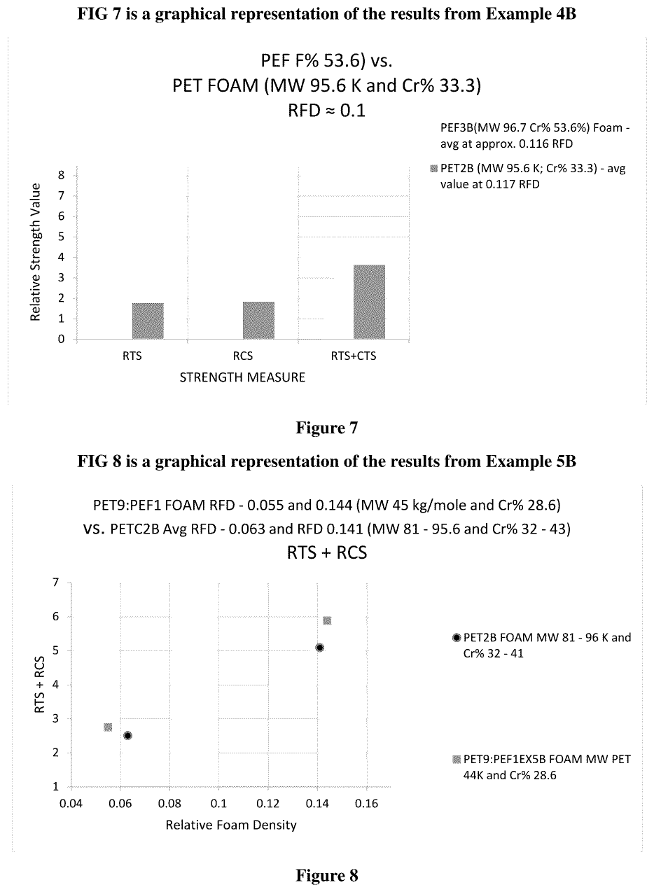

As revealed by the data in Table E4B above, applicants have surprisingly found that extruded PEF foams according to the present invention possess unexpectedly high tensile strength and compressive strength values. This is illustrated, for example, by reference to the extruded foams formed from the PET of Comparative Example C3B2, as illustrated by the charts in FIG. 7, especially considering the fact that the comparative examples incorporate preferred aspects of the present invention relating to the formation of extruded foams from polymers of relatively high crystallinity and high molecular weight and preferred blowing agent of the present invention (i.e., HFO-1234ze(E)). FIG. 7 shows the results for data for foams in the RFD region of about 0.116.

As can be seen from the results of this example, the extruded PEF homopolymer foams of the present invention produce unexpectedly superior strength compared to extruded PET homopolymer foams made using the same foam formation techniques of the present invention, including the preferred HFO-1234ze blowing agent of the present invention. For example, as is illustrated by this example in terms of the significantly higher relative tensile strength and RTS+RCS of the extruded foam. In particular, the extent of this unexpected advantage is summarized in the following Table E4C:

TABLE E4C

| | Inventive PEF Performance Advantage |
|---|---|
| | over PETC2B performance at RFD of 0.117 |
| Advantage | 1.54 times |
| of | better |
| Inventive | |
| in RTS | |
| Advantage | 3.04 times |
| of | better |
| Inventive | |
| in RCS | |
| Advantage | 2.3 times |
| in RTS + | better |
| RCS | |

### Example 5A—PET9:PEF1 Copolymer Preparation with MW of about 45 kg/mol with PMDA and 28.6 CR %

A block copolymer of PET9:PEF1 (9:1 mole ratio) was prepared with a target molecular weight of about 45,000 g/mol for the PET portion of the copolymer, using the additives polymer formation procedures as described below in Synthesis Example 5Ae.

The PET9:PEF1 copolymer thus produced was tested using the measurement protocols as described above in Comparative Example 1A and found to have the characteristics reported in Table E5A below:

TABLE E5A

| | Example E5A (PET9PEF1) |
|---|---|
| Molecular Weights, | PET MW - 44,904 |
| PET, g/mol | |
| Glass Transition | 79.8 |
| Temperature, ° C. | |
| Melting Point, ° C. | 208.5 |
| Crystallinity, % | 28.6 |

The PET9:PEF1 copolymer so produced is referred to in these Examples as PET9PEF1-EX5A.

### Example 5B—PEF Foam Preparation Using PET9PEF1-EX5A with Trans1234ze Blowing Agent

Two (2) extruded foams are made from PET9PEF1-EX5A using foam extrusion processes that were designed using the same criteria as described in Comparative Example 1. The foams thus produced are tested and found to have the properties as reported in Table E5B below:

TABLE E5B

| Example→ | E5B1 | E5B2 |
|---|---|---|
| RUNS | 138/6 | 139/2 |
| MATERIALS | | |

| | |
|---|---|
| Polymer (MW, | PET9PEF1-EX5 (PET- 44.9) |

| | | |
|---|---|---|
| kg/mol) | | |
| Blowing Agent* | 1234ze(E) | 1234ze(E) |
| FOAM | | |
| PROPERTIES | | |
| RFD | .055 | 0.144 |
| TS, MPa | 2.03 | 2.3 |
| RTS | 1.9 | 2.13 |
| CS, MPa | 0.51 | 2.25 |
| RCS | 0.85 | 3.75 |
| RTS + RCS | 2.75 | 5.88 |

As revealed by the data in Table E5B above, applicants have surprisingly found that extruded foams made with PET9:PEF1-EX5B according to the present invention possess unexpectedly high strength properties.

FIG. 8 shows the strength values for the foams in comparison to the average values for PETC3B2 foams (as reported in Table C3B above) in the same density regions covered in Table E5B above, namely about 0.05-0.06 and about 0.13-0.15.

As can be seen from the results of this example, the extruded PET9:PEF1 copolymer foams of the present invention produce unexpectedly superior strength, as is illustrated by this example in terms of the significantly higher RCS in the region of RFD of about 0.06 and about 0.14. In particular, the extent of this unexpected advantage for this example is summarized in the following Table E5C:

TABLE E5C

| | Inventive PET9:PEF1 | Inventive PET9:PEF1 |
|---|---|---|
| | Performance Advantage | Performance Advantage |
| | over PETC2B performance | over PETC2B performance |
| | at RFD of about 0.06 | at RFDS of about 0.14 |
| | PET C2B | PET C2B |
| Advantage | 1.18 times better | 1.26 times |
| of | (even with inventive | better |
| Inventive | foam having a | |
| Foams in | lower density) | |
| RCS | | |

### Example 6A1 and 6A2-PET99:PEF1 Copolymer Preparation with PET MW of about 92-97 kg/mol with PMDA and SSP and 28.8-33.5 CR %

Two random copolymers of PET99:PEF1 (99:1 mole ratio) were prepared with a PET portion with a target molecular weight of about 92 and 97 kg/mol, with a target molecular of about 45,000 g/mol for the PET portion of the copolymer, using the additives and polymer formation procedures as described in Synthesis Example 6A1 below, or a variation thereof to achieve a polymer with the target molecular weight of 92,160.

The PET99:PEF1 copolymers were tested and found to have the characteristics in Table E6A:

TABLE E6A

| | Example E6A | Example E6A |
|---|---|---|
| | (PET99PEF1) | (PET99PEF1) |
| Molecular Weights, | 97,190 | 92,160 |
| PET, g/mol | | |
| Glass Transition | 76.4 | 76.4 |
| Temperature, ° C. | | |
| Melting Point, ° C. | 224.3 | 224 |
| Decomposition Temperature, | 385 | 381 |
| ° C. | | |
| Crystallinity, % | 28.8 | 33.5 |

The PET99:PEF1 copolymers so produced are referred to in these Examples as PET99PEF1-EX6A1 and PET99PEF1-EX6A2.

### Example 6B—Foam Preparation Using PET99PEF1-EX6A1 and A2 with Trans1234ze Blowing Agent

Six (6) foams are made from PET99PEF1-EX6B using extrusion processes that were designed using the same criteria as described in Comparative Example 1. The foams thus produced are tested and found to have the properties as reported in Table EB below:

TABLE E6B

| | Example | | | | | | |
|---|---|---|---|---|---|---|---|
| | E6B1-1 | E6B2-1 | E6B2-2 | E6B1-2 | E6B1-3 | E6B2-3 | E6B1-4 |
| MATERIALS | | | | | | | |
| Polymer (MW of | PET99PEF1- | PET99PEF1- | PET99PEF1- | PET99PEF1- | PET99PEF1- | PET99PEF1- | PET99PEF1- |
| PET portion, | EX6A1 | EX6A1 | EX6A1 | EX6A1 | EX6A1 | EX6A1 | EX6A1 |
| kg/mol) | (97.1) | (92.6) | (92.6) | (97.1) | (97.1) | (92.6) | (97.1) |
| Blowing Agent* | 1234ze(E) | 1234ze(E) | 1234ze(E) | 1234ze(E) | 1234ze(E) | 1234ze(E) | 1234ze(E) |
| FOAM | | | | | | | |
| PROPERTIES | | | | | | | |
| RFD | .066 | 0.096 | 0.129 | .140 | 0.143 | 0.148 | 0.153 |
| | | | | 0.1415 | | | |
| TS, MPa | 2.16 | 2.13 | 2.58 | 2.59 | 2.54 | 1.91 | 1.84 |
| RTS | 2.00 | 1.97 | 2.39 | 2.4 | 2.35 | 1.77 | 1.7 |
| CS, MPa | 0.74 | 2.31 | 1.66 | 1.8 | 2.03 | 1.78 | 2.36 |
| RCS | 1.23 | 3.85 | 2.77 | 3 | 3.38 | 2.97 | 3.93 |
| RTS + RCS | 3.23 | 5.82 | 5.16 | 5.4 | 5.74 | 4.74 | 5.64 |

| | |
|---|---|
| Avg RTS + RCS | 5.57 |

As revealed by the data in Table E6B above, applicants have surprisingly found that extruded foams made with PET99:PEF1-EX6A1 and EX6A2 according to the present invention possess unexpectedly high strength properties.

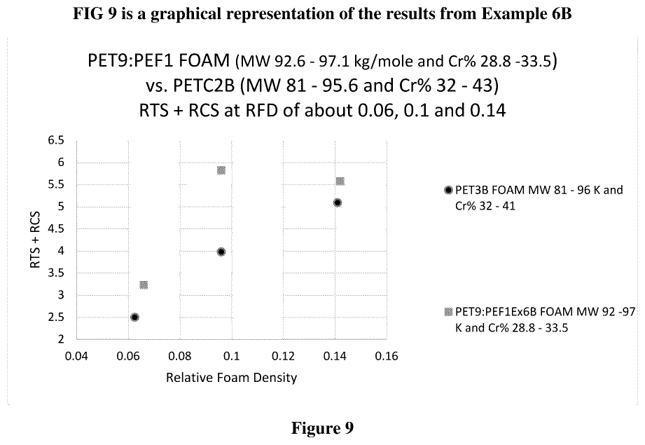

FIG. 9 shows the tensile strength values, the compressive strength values and the combined tensile strength plus compressive strength for the foams as shown in Table E6B above and include for comparison purposes data for the PET data from Table C1B for the convenience of comparison.

As can be seen from the results of this example, the extruded PET99:PEF1 copolymer foams of the present invention produce unexpectedly superior strength, illustrated for example by comparison to extruded PET homopolymer foams made of Comparative Example 1, which use the preferred HFO-1234ze blowing agent of the present invention. As can be seen from the results of this example, the PET99:PEF1 copolymer foams of the present invention produce unexpectedly superior strength compared to PET homopolymer foams made using the same foam formation techniques of the present invention, including the preferred HFO-1234ze blowing agent of the present invention. In particular, the extent of this unexpected advantage is summarized in the following Table E6C:

TABLE E6C

| | Inventive | Inventive | Inventive |
|---|---|---|---|
| | PET99:PEF1 | PET99:PEF1 | PET99:PEF1 |
| | Performance | Performance | Performance |
| | Advantage | Advantage | Advantage |
| | over PETC3B | over PETC3B | over PETC3B |
| | performance | performance | performance |
| | at RFD of | at RFD of | at RFD of |
| | about 0.06 | about 0.1 | about 0.14 |
| Advantage | 1.29 times | 1.46 times | 1.09 times |
| of Inventive | greater | greater | greater |
| in RTS + | | | |
| RCS | | | |

### Example 7A1—PET19:PEF1 Copolymer Preparation with PET MW of about 46 kg/mol with PMDA and 30.2 CR %

A random copolymer of PET19:PEF1 (19:1 mole ratio) was prepared with a PET portion with a target molecular weight of about 46 kg/mol, using the same additives and basic polymer formation procedures as described below in Synthesis Example 8A, with variations to produce a target PET molecular weight of about 46 kg/mol.

The PET9:PEF1 copolymers were tested and found to have the characteristics in Table E7A:

TABLE E7A

| | Example E7A (PET19PEF1) |
|---|---|
| Molecular Weight, | 46,395 |
| PET, g/mol | |
| Glass Transition | 80 |
| Temperature, ° C. | |
| Melting Point, ° C. | 225 |
| Decomposition Temperature, | 380 |
| ° C. | |
| Crystallinity, % | 30.2 |

The PET19:PEF1 copolymer so produced is referred to in this Example as PET19PEF1-EX7A1.

### Example 7B—Foam Preparation Using PET19PEF1-EX7A1 with Trans1234ze Blowing Agent

A foam is made from PET19PEF1-EX7A using extrusion processes that are designed using the same criteria as described in Comparative Example 1. The extruded foam thus produced is tested and found to have the properties as reported in Table E7B below:

TABLE E7B

| Example→ | E7B |
|---|---|
| MATERIALS | |
| Polymer (MW, | PET19PEF1-EX7A1 (46.4) |
| kg/mol) | |
| Blowing Agent* | 1234ze(E) |
| FOAM | |
| PROPERTIES | |
| RFD | .08 |
| TS, MPa | 1.91 |
| RTS | 1.77 |
| CS, MPa | 0.44 |
| RCS | 0.73 |
| RTS + RCS | 2.5 |

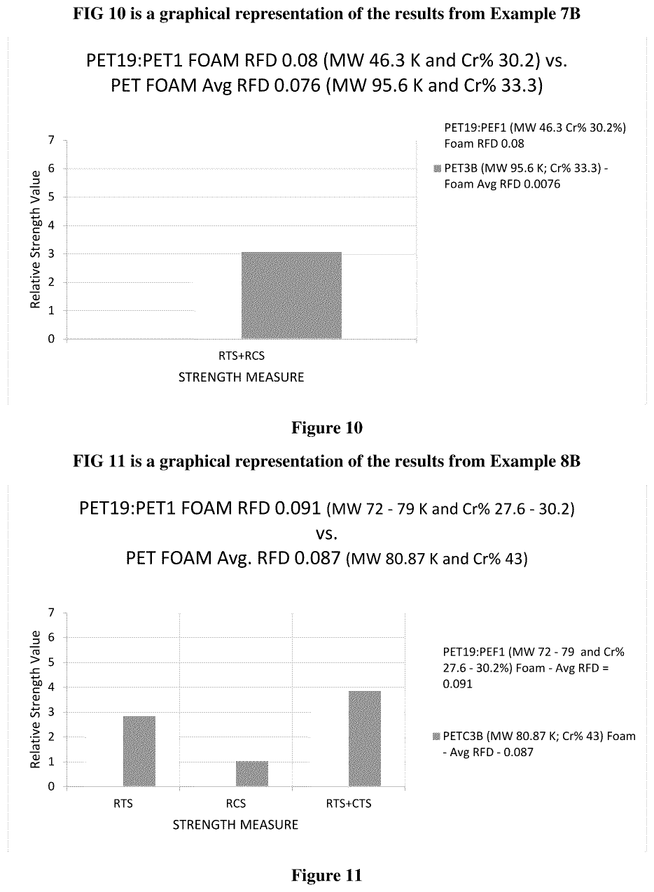

As revealed by the data in Table E7B above, applicants have found that extruded foam made with PET19:PEF1-EX7A1 according to the present invention possess excellent strength properties. For example, the foam produced with the relatively low density copolymer of the present invention has strength values that compare favorably with average results for the extruded PET homopolymer foam identified as C3B2-14 (having an RFD of 0.063) and C3B2-2 (having an RFD of 0.088) in Table C3B above, which has nearly doubled the molecular weight of the PET19:PEF1 copolymer of the present invention. This unexpected result is illustrated with respect to RTS+RCS in FIG. 10.

Given that the molecular weight of the PET homopolymer is more than double the molecular weight of the PET19:PEF1 of the present invention, it is unexpected that the strength values of the extruded PET19:PEF1 foam would be comparable.

### Example 8A1 and 8A2—PET19:PEF1 Copolymer Preparation with PET MW of about 72-79 kg/mol with PMDA and SSP and 27.62-32%

Two random copolymers of PET19:PEF1 (19:1 mole ratio) were prepared with a PET portion with target molecular weights of about 72 kg/mol and about 79 kg/mol, using the additives and polymer formation procedures as described in Synthesis Example 8A1 and 8A2.

The PET19:PEF1 copolymers were tested and found to have the characteristics in Table E8A:

TABLE E8A

| | Example E8A1 | Example E8A2 |
|---|---|---|
| | (PET19PEF1) | (PET19PEF1) |
| Molecular Weight, | 72,550 | 79,033 |
| PET, g/mol | | |
| Glass Transition | 78.3 | 77.7 |
| Temperature, ° C. | | |
| Melting Point, ° C. | 221 | 220 |
| Decomposition Temperature, | 380 | 381 |
| ° C. | | |
| Crystallinity, % | 27.6% | 32 |

The PET19:PEF1 copolymers so produced are referred to in this Example as PET19PEF1-EX8A1 and PET19PEF1-EX8A2.

### Example 8B—Foam Preparation Using PET19PEF1-EX8A1 and EX8A2 with Trans1234ze Blowing Agent

Foam is made from each of PET19PEF1-EX8A1 and EX8A2 using extrusion processes that were designed using the same criteria as described in Comparative Example 1. The extruded foams thus produced are tested and found to have the properties as reported in Table E8B below:

TABLE E8B

| Example→ | E8B1 | E8B2 |
|---|---|---|
| MATERIALS | | |
| Polymer (MW of | PET19PEF1- | PET19PEF1- |
| PET portion, kg/mol) | EX8A1 (72.55) | EX8A2 (79.03) |
| Blowing Agent* | 1234ze(E) | 1234ze(E) |
| FOAM | | |
| PROPERTIES | | |
| RFD | .090 | 0.092 |

| | |
|---|---|
| Avg RFD | 0.091 |

| | | |
|---|---|---|
| TS, MPa | 2.37 | 2.83 |
| RTS | 2.19 | 2.62 |

| | |
|---|---|
| Avg. RTS | 2.41 |

| | | |
|---|---|---|
| CS, MPa | 0.94 | 1.02 |
| RCS | 1.57 | 1.7 |

| | |
|---|---|
| Avg. RCS | 1.64 |

| | | |
|---|---|---|
| RTS + RCS | 3.76 | 4.32 |

| | |
|---|---|
| Avg RTS + RCS | 4.04 |

As revealed by the data in Table E8B above, applicants have found that extruded foams made with PET19:PEF1-EX8A1 and EX8A2 according to the present invention possess excellent strength properties. For example, the present extruded foams, which have an average RFD of 0.091, exhibit strength values that compare favorably with the extruded PET homopolymer foams identified as C3B1-2 and C3B2-2 in Table C3B above, which have the same average density compared to the RFD of the PET19:PEF1 copolymer of the present example. This unexpected result is illustrated in FIG. 11.

Given that the crystallinity of the extruded PET homopolymer foam is 1.3 times higher than the crystallinity of the extruded PET19:PEF1 copolymer foam, and that the MW of extruded PET homopolymer is 1.2× higher than the MW of extruded PET19:PEF1 foam of the present example of the present example, it is thoroughly unexpected that the strength values of the extruded PET19:PEF1 foam would be comparable to the extruded foam formed from the PET homopolymer, and it is especially unexpected that the Relative Compressive strength of the present invention would be greater than those values for the PET homopolymer, resulting in combined RTS+CTS value which is also higher than that of the foam formed from the PET homopolymer.

### Example 9A1—PET19:PEF1 Copolymer Preparation with PET MW of about 62 kg/mol with PMDA and SSP and 26.1 CR %

A random copolymer of PET19:PEF1 (19:1 mole ratio) was prepared with a PET portion with a target molecular weight of about 62 kg/mol, using the same additives and basic polymer formation procedures as described below in Synthesis Example 8A, with variations to produce a target PET molecular weight of about 62 kg/mol.

The PET19:PEF1 copolymers were tested and found to have the characteristics in Table E9A:

TABLE E9A

| | Example E9A (PET19PEF1) |
|---|---|
| Molecular Weight, | 62,378 |
| PET, g/mol | |
| Glass Transition | 79.9 |
| Temperature, ° C. | |
| Melting Point, ° C. | 225 |
| Crystallinity, % | 26.1 |

The PET19:PEF1 copolymer so produced is referred to in this Example as PET19PEF1-EX9A1.

### Example 9B—Foam Preparation Using PET19PEF1-EX9A1 with Trans1234ze Blowing Agent

A foam was made from PET19PEF1-EX9A using foam extrusion processes that were designed using the same criteria as described in Comparative Example 1. The extruded foam thus produced was tested and found to have the properties as reported in Table E9B below:

TABLE E9B

| Example→ | E9B |
|---|---|
| MATERIALS | |
| Polymer (MW of | PET99PEF1-EX6A1 (62.37) |
| PET portion, kg/mol) | |
| Blowing Agent* | 1234ze(E) |
| FOAM | |
| PROPERTIES | |
| RFD | .107 |
| TS, MPa | 2.19 |
| RTS | 2.03 |
| CS, MPa | 1.29 |
| RCS | 2.15 |
| RTS + RCS | 4.18 |

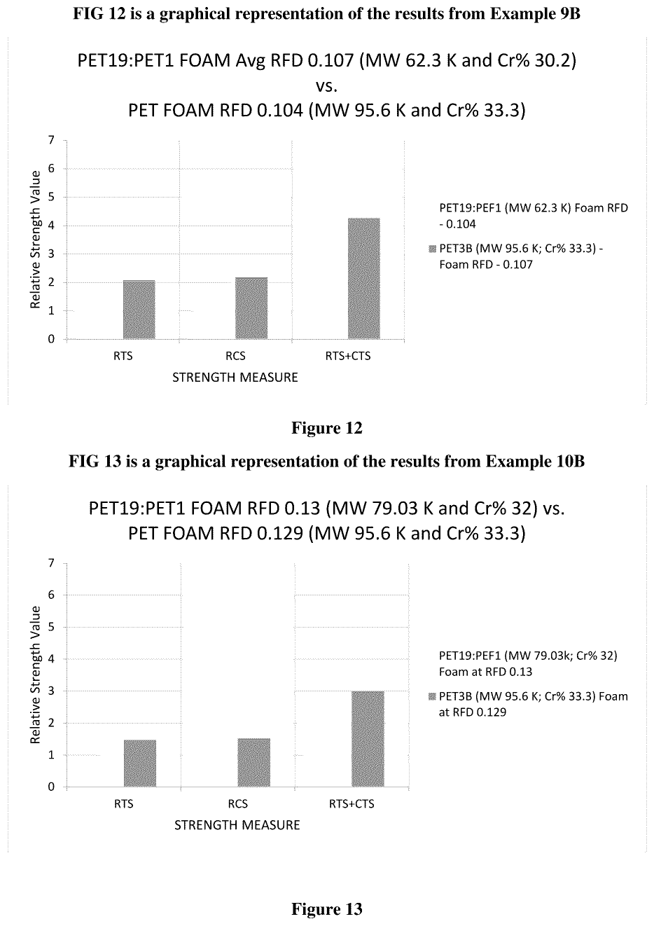

As revealed by the data in Table E9B above, applicants have found that extruded foams made with PET19:PEF1-EX9A1 according to the present invention possess excellent strength properties. For example, the extruded foam produced with the relatively low density copolymer of the present invention has strength values that compare favorably with the extruded PET homopolymer foam identified as C3B1-3 in Table C3B above, which has a density of 0.104 and therefore very near the density of the extruded foam formed from the PET19:PEF1 copolymer of the present invention. This unexpected result is illustrated in FIG. 12.

Given that the molecular weight of the extruded foam made from the PET homopolymer is more than 1.5 times higher than the molecular weight of the foam formed from the PET19:PEF1 of the present invention, it is thoroughly unexpected that the each of the reported strength values of the PET19:PEF1 extruded foam would be essentially equivalent to the strength values of the PET homopolymer extruded foam.

### Example 10A—PET19:PEF1 Copolymer Preparation with PET MW of about 79 kg/mol with PMDA and SSP and 32.4 CR %

A random copolymer of PET19:PEF1 (19:1 mole ratio) is prepared with a PET portion with a target molecular weight of about 79 kg/mol, using the additives and basic polymer formation procedures as described below in Synthesis Example 8A, with variations to produce a target PET molecular weight of about 79 kg/mol.

The PET19:PEF1 copolymers were tested and found to have the characteristics in Table E10A:

TABLE E10A

| | Example E10A (PET19PEF1) |
|---|---|
| Molecular Weight, | 79,033 |
| PET, g/mol | |
| Glass Transition | 77.7 |
| Temperature, ° C. | |
| Melting Point, ° C. | 220 |
| Decomposition Temperature, ° C. | 381 |
| Crystallinity, % | 32.4 |

The PET19:PEF1 copolymer so produced is referred to in this Example as PET19PEF1-EX10A.

### Example 10B—Foam Preparation Using PET19PEF1-EX10A with Trans1234ze Blowing Agent

An extruded foam was made from PET19PEF1-EX10A using extrusion processes that are designed using the same criteria as described in Comparative Example 1. The extruded foam thus produced is tested and found to have the properties as reported in Table E10B below:

TABLE E10B

| Example→ | E10B |
|---|---|
| MATERIALS | |
| Polymer (MW of | PET99PEF1-EX10A1 (79.03) |
| PET portion, kg/mol) | |
| Blowing Agent* | 1234ze(E) |
| FOAM | |
| PROPERTIES | |
| RFD | 0.13 |
| TS, MPa | 1.64 |
| RTS | 1.52 |
| CS, MPa | 0.86 |
| RCS | 1.4 |
| RTS + RCS | 2.92 |

As revealed by the data in Table E10B above, applicants have found that the extruded foams made with PET19:PEF1-EX10A according to the present invention possess excellent strength properties. For example, the extruded foam of this example had a density of 0.13 but exhibited strength values that compared well with the extruded foam made from a PET homopolymer having substantially the same density but a much higher molecular weight. In particular, the extruded PET homopolymer foam identified as C3B1-4 in Table C3B above has a density of 0.129 and had molecular weight that is 20% higher than the PET19:PEF1 copolymer used to make the foam of the present invention. Nevertheless, the strength values of the two foams are unexpectedly comparable, as illustrated in FIG. 13.

Given that the molecular weight of the PET homopolymer is about 20% higher than the molecular weight of the PET19:PEF1 of the present example, it is thoroughly unexpected that the each of the reported extruded foam strength values of the PET19:PEF1 would be about the same as the PET homopolymer.

### Example 11A—PET19:PEF1 Copolymer Preparation with PET MW of About 83 kg/mol with PMDA and SSP and 20.7 CR %

A block copolymer of PET19:PEF1 (19:1 mole ratio) was prepared with a PET portion with a target molecular weight of about 83 kg/mol as described in Synthesis Example 11A below.

The PET19:PEF1 copolymers were tested and found to have the characteristics in Table E11A:

TABLE E11A

| | Example E11A (PET19PEF1) |
|---|---|
| Molecular Weight, | 83,033 |
| PET, g/mol | |
| Glass Transition | 79.9 |
| Temperature, ° C. | |
| Melting Point, ° C. | 223.6 |
| Crystallinity, % | 20.7 |

The PET19:PEF1 copolymer so produced is referred to in this Example as PET19PEF1-EX11A.

### Example 11B—Foam Preparation Using PET19PEF1-EX10A with Trans1234ze Blowing Agent

A foam is made from PET19PEF1-EX11A using foam extrusion processes that are designed using the same criteria as described in Comparative Example 1. The extruded foam thus produced is tested and found to have the properties as reported in Table E11B below:

TABLE E11B

| Example→ | E11B |
|---|---|
| MATERIALS | |
| Polymer (MW, | PET99PEF1-EX10A1 |
| kg/mol) | |
| Blowing Agent* | 1234ze(E) |
| FOAM | |
| PROPERTIES | |
| RFD | 0.128 |
| TS, MPa | 1.44 |
| RTS | 1.33 |
| CS, MPa | 1.16 |
| RCS | 1.93 |
| RTS + RCS | 3.27 |

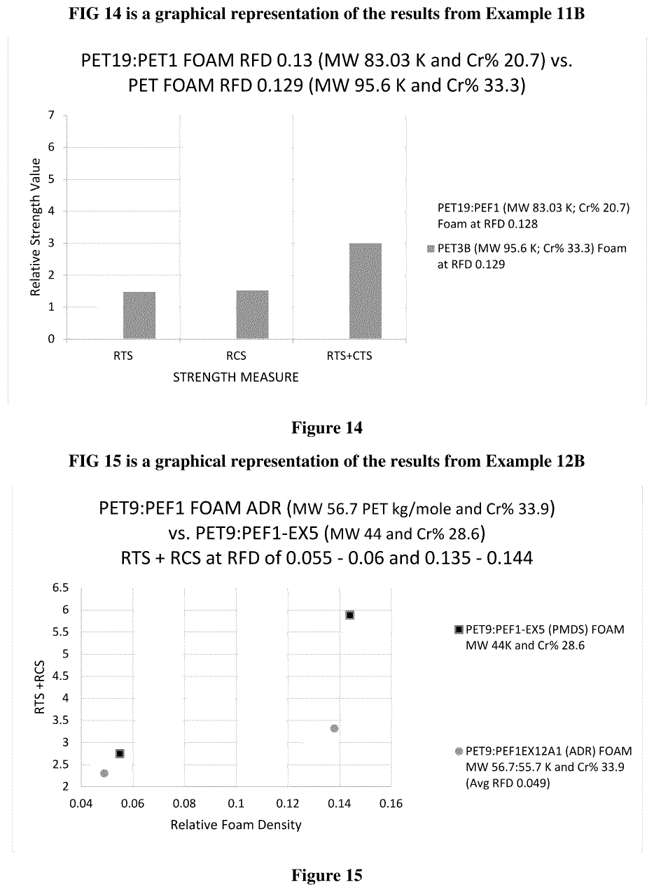

As revealed by the data in Table E11B above, applicants have found that extruded foams made with PET19:PEF1-EX11A according to the present invention possess excellent strength properties. For example, the extruded foam of this example is made from a copolymer with a PET portion having a molecular weight of about 83 kg/mol and a crystallinity of about 21%, but nevertheless exhibits strength values that compare well or even surpass the strength of a PET homopolymer foam of substantially the same density but made from polymer having a 1.2 times higher molecular weight and a 1.6 times higher crystallinity. In particular, the extruded PET homopolymer foam identified as C3B1-4 in Table C3B above has a density of 0.129 and has, for example, a relative compressive strength that is substantially less than the compressive strength of the lower density of the PET19:PEF1 data of this example, as illustrated in FIG. 14.

Given that the molecular weight of the PET homopolymer is about 20% higher than the molecular weight of the PET19:PEF1 of the present example and that the crystallinity is about 60% higher, it is thoroughly unexpected that the each of the reported strength values of the PET19:PEF1 extruded foam would be about the same or slightly higher than the extruded foam made from PET homopolymer.

### Examples 12A1 and 12A2—PET9:PEF1 Copolymer Preparation with MW of about 57-69 kg/mol with ADR and PMDA with Talc and SSP and 28-34 CR %

Two (2) block copolymers of PET9:PEF1 (9:1 mole ratio) were prepared with target molecular weights of about 57 to about 69 kg/mol for the PET portion of the copolymer using the additives and polymer formation procedures as described in Synthesis Examples 12A1 and 12A2.

The PET9:PEF1 copolymers thus produced were tested using the measurement protocols as described above in Comparative Example 1A and found to have the characteristics reported in Table E12A below:

TABLE E12A

| | Example | Example |
|---|---|---|
| | E12A1(PET9PEF1) | E12A2(PET9PEF1) |
| Molecular Weight, | 56,794 | 69,941 |
| PET porion, g/mol | | |
| Glass Transition | 81.2 | 79 |
| Temperature, ° C. | | |
| Melting Point, ° C. | 222.6 | 206.9 |
| Decomposition | 378 | 370 |
| Temperature, ° C. | | |
| Crystallinity, % | 33.9 | 22.8 |
| Additive | ADR | PMDA + talc |

The PET9:PEF1 copolymers so produced are referred to in these Examples as PET9PEF1-EX12A1, PET9PEF1-EX12A2 and PET9PEF1-EX12A3.

### Example 12B—PEF Foam Preparation Using PET9PEF1-EX12A1 with Trans1234ze Blowing Agent

Three (3) foams are made from PET9PEF1-EX12A1 using foam extrusion processes that are designed using the same criteria as described in Example 5A. The extruded foams thus produced are tested and found to have the properties as reported in Table E12B1 below:

TABLE E12B1

| Example→ | E12B1-1 | E12B1-2 | E12B1-3 |
|---|---|---|---|
| MATERIALS | | | |
| Polymer (PET MW, | PET9PEF1-EX12A1 (56.7) | | |
| kg/mol) | | | |
| Blowing Agent* | 1234ze(E) | 1234ze(E) | 1234ze(E) |
| FOAM | | | |
| PROPERTIES | | | |
| RFD | .042 | 0.056 | 0.138 |
| Avg RFD | 0.049 | | |
| TS, MPa | 1.97 | 1.52 | 1.55 |
| RTS | 1.82 | 1.41 | 1.44 |
| CS, MPa | 0.41 | 0.39 | 1.13 |
| RCS | 0.68 | 0.65 | 1.88 |
| RTS + RCS | 2.51 | 2.06 | 3.32 |

| | |
|---|---|
| Avg RTS + RCS | 2.3 |

As revealed by the data in Table E12B above, applicants have surprisingly found that extruded foams made with PET9:PEF1-EX12A1 according to the present invention possess unexpectedly high strength properties.

FIG. 15 shows the strength values for the extruded foams in comparison to the PET9:PEF1 foams made using PMDA in Example 5 in the same density regions covered in Table E5B above, namely about 0.05-0.06 and about 0.13-0.15.

As can be seen from the results of this example, the PET9:PEF1-EX12 made acceptable extruded foams with good expansion.

### Example 12C—PEF Foam Preparation Using PET9PEF1-EX12A2 with Trans1234ze Blowing Agent

An extruded foam is made from PET9PEF1-EX12A2 using extrusion foaming processes that were designed using the same criteria as described in Example 5A. The extruded foams thus produced are tested and found to have the properties as reported in Table E12B2 below:

TABLE E12B2

| Example→ | E12B1-1 |
|---|---|
| MATERIALS | |
| Polymer (MW, | PET9:PET1EX12A2 |
| kg/mol) | (69,941:60,841) |
| Blowing Agent | 1234ze(E) |
| FOAM | |
| PROPERTIES | |
| RFD | .074 |
| TS, MPa | 1.38 |
| RTS | 1.95 |
| CS, MPa | 0.46 |
| RCS | 0.77 |
| RTS + RCS | 2.15 |

As revealed by the data in Table E12B2 above, applicants have surprisingly found that extruded foams made with PET9:PEF1-EX12A2 according to the present invention possess unexpectedly high strength properties.

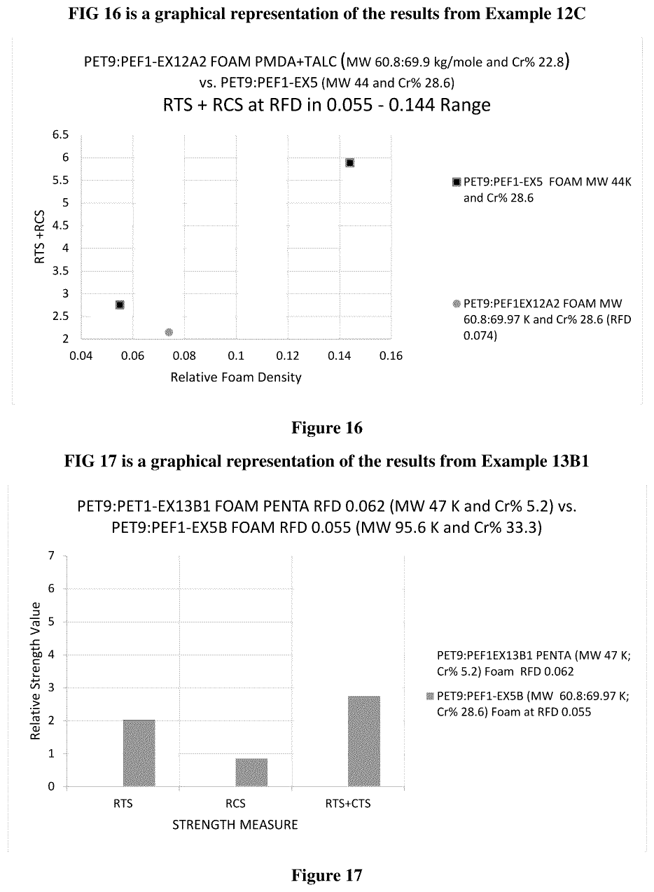

FIG. 16 shows the strength values for the extruded foams in comparison to the PET9:PEF1 foams made using PMDA in Example 5 in a density region between the density regions illustrated in Table E5B above, namely about 0.055 and about 0.144.

As can be seen from the results of this example, the PET9:PEF1-EX12 made acceptable extruded foams with good expansion.

### Example 13A1 and 13A2—PET9:PEF1 and PET19:PEF1 Copolymer Preparation with MW of about 47 and 12 kg/mol with Penta and SSP

A first block copolymer of PET9:PEF1 (9:1 mole ratio) was prepared with a target PET molecular weight of about 47 kg/mol, with PET and PEF oligomer blocks of 1-5 (monomers), 1-5 (monomers), using PENTA additive with the polymer formation procedures as described in Synthesis Example 13A to achieve a target molecular weight of 47,030 or with variations on Synthesis Example 13A to achieve the target molecular weights of about 45,000 or about 12,000 kg/mole.

The PET:PEF copolymers thus produced were tested using the measurement protocols as described above in Comparative Example 1A and found to have the characteristics reported in Table E13A below:

TABLE E13A

| | Example | Example | Example |
|---|---|---|---|
| | E13A1(PET9PEF1) | E13A2(PET19PEF1) | E13A3(PET19PEF1) |
| Molecular | 47,030 | 45,589 | 11,769 |
| Weights, | | | |
| PET, g/mol | | | |
| Glass Transition | 79.5 | 79.9 | 79.3 |
| Temperature, ° C. | | | |
| Melting Point, ° C. | 221 | 226.7 | 222.4 |
| Decomposition | | 367 | |
| Temperature, ° C. | | | |
| Crystallinity, % | 5.2% | 34.2 | 29.3 |
| Additive | PENTA | PENTA | PENTA |

The PET9:PEF1 copolymers so produced are referred to in these Examples as PET9PEF1-EX13A1, PET9PEF1-EX13A2 and PET9PEF1-EX13A3, as indicated in the Table E13A above.

### Example 13B1—PEF Foam Preparation Using PET9PEF1-EX13A1 with Trans1234ze Blowing Agent

An extruded foam is made from PET9PEF1-EX13A1 using extrusion foaming processes that are designed using the same criteria as described in Comparative Example 5, except that PENTA was used instead of PMDA. The extruded foam thus produced is tested and found to have the properties as reported in Table E13B below:

TABLE E13B1

| Example→ | E13B1 |
|---|---|
| MATERIALS | |
| Polymer (MW, | PET9PEF1-EX13A (PET 47) |
| kg/mol) | |
| Blowing Agent | 1234ze(E) |
| FOAM | |
| PROPERTIES | |
| RFD | .062 |
| TS, MPa | 2.36 |
| RTS | 2.19 |
| CS, MPa | 0.52 |
| RCS | 0.87 |
| RTS + RCS | 3.05 |

As revealed by the data in Table E13B1 above, applicants have surprisingly found that extruded foams made with PET9:PEF1-EX13A1 according to the present invention possess unexpectedly high strength properties.

FIG. 17 shows the strength values for the extruded foams in comparison to the PET9:PEF1 foams made using PMDA in Example 5 in the density region of the foam illustrated in Table E5B above having a value of about 0.055.

As can be seen from the results of this example, the PET9:PEF1-EX12 made acceptable extruded foams with good expansion.

### Example 13B2—PET19:PEF1 Copolymer Preparation with MW of about 45 kg/mol with Penta

An extruded foam is made from PET19PEF1-EX13A2 using extrusion foaming processes that are designed using the same criteria as described in Example 7, except that PENTA is used instead of PMDA. The foam thus produced is tested and found to have the properties as reported in Table E13B2 below:

TABLE E13B2

| Example→ | E13B2 |
|---|---|
| RUNS | 133/4 |
| MATERIALS | |
| Polymer (MW, | PET19PEF1-EX13A2 (45,589) |
| kg/mol) | |
| Blowing Agent | 1234ze(E) |
| FOAM | |
| PROPERTIES | |
| RFD | 0.078 |
| TS, MPa | 1.68 |
| RTS | 1.56 |
| CS, MPa | 1.16 |
| RCS | 1.68 |
| RTS + RCS | 3.49 |

As revealed by the data in Table E13B2 above, applicants have surprisingly found that extruded foams made with PET9:PEF1-EX13A2 according to the present invention possess unexpectedly high strength properties.

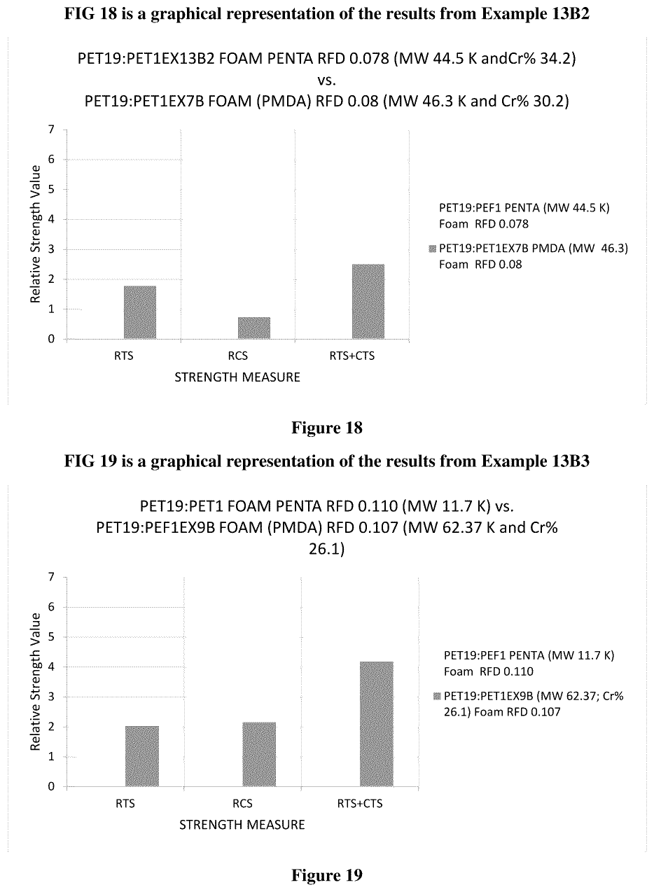

FIG. 18 shows the strength values for the extruded foams in comparison to the extruded PET9:PEF1 foams made using PMDA in Example 7 in the density region of the foam illustrated in Table E7B above having a value of about 0.08.

As can be seen from the results of this example, the PET9:PEF1-EX12 made acceptable extruded foams with good expansion.

### Example 13B3—PET19:PEF1 Copolymer Preparation with MW of about 11.69 kg/mol with Penta and SSP

A foam was made from PET19PEF1-EX13A3 using foaming processes that were designed using the same criteria as described in Example 9B, except that PENTA was used instead of PMDA. The foam thus produced was tested and found to have the properties as reported in Table E13B3 below:

TABLE E13B3

| Example→ | E13B3 |
|---|---|
| MATERIALS | |
| Polymer (MW, | PET19PEF1-EX13A2 (11769) |
| kg/mol) | |
| Blowing Agent | 1234ze(E) |
| CONDITION | |
| FOAM | |
| PROPERTIES | |
| RFD | 0.110 |
| TS, MPa | 2.26 |
| RTS | 2.09 |
| CS, MPa | 2.08 |
| RCS | 3.47 |
| RTS + RCS | 5.56 |

As revealed by the data in Table E13B3 above, applicants have surprisingly found that foams made with PET9:PEF1-EX13A3 according to the present invention possess unexpectedly high strength properties.

FIG. 19 shows the strength values for the foams in comparison to the PET9:PEF1 foams made using PMDA in Example 9 in the density region of the foam illustrated in Table E97B above having a value of about 0.107.

As can be seen from the results of this example, the PET9:PEF1-EX12 made acceptable foams with good expansion.

### Example 14B—PET9:PEF1 Foam Preparation Using PET9:PEF1_EX3A and Trans123zd, Trans1233zd, and Cis1336 Blowing Agent

A series of foams are made using PET9:PEF1-Ex3A using extrusion foaming processes that are designed using the same criteria as described in Comparative Example 1B. The foams thus produced are tested and found to have the properties as reported in Table E14B below.

TABLE E14B

| | Example | | | | | | | |
|---|---|---|---|---|---|---|---|---|
| | E14B1 | E14B1-2 | Eq4B1-3 | E14B1-4 | E14B1-5 | E14B1-6 | E14B1-7 | E2B1-8 |
| RUNS | 68/1 | 77/2 | 57/2 | 84/3 | 72/5 | 58/1 | 68/5 | 68/6 |
| MATERIALS | | | | | | | | |
| Polymer | PET:PEF1 | PET:PEF1 | PET:PEF1 | PET:PEF1 | PET:PEF1 | PET:PEF1 | PET:PEF1 | PET:PEF1 |
| (MW, K) | Ex3B1 | Ex3B1 | Ex3B1 | Ex3B1 | Ex3B1 | Ex3B1 | Ex3B1 | Ex3B1 |
| | (117.9:90.4) | (117.9:90.4) | (117.9:90.4) | (117.9:90.4) | (117.9:90.4) | (117.9:90.4) | (117.9:90.4) | (117.9:90.4) |
| Blowing Agent | 1233zd(E) | 1336mzz(Z) | 1336mzz(Z) | 1234ze(E) | 1336mzz(Z) | 1234ze(E) | 1336mzz(Z) | 1336mzz(Z) |
| FOAM | | | | | | | | |
| PROPERTIES | | | | | | | | |
| RFD | 0.066 | 0.067 | 0.071 | 0.075 | 0.075 | 0.083 | 0.085 | 0.111 |
| TS, MPa | 0.56 | 0.59 | 1.15 | 1.44 | 1.64 | 2.53 | 1.69 | 2.6 |
| RTS | 0.52 | 0.55 | 1.07 | 1.35 | 1.53 | 2.36 | 1.57 | 2.43 |
| CS, MPa | 0.84 | 0.25 | 0.6 | 0.81 | 0.36 | 0.95 | 0.45 | 0.91 |
| RCS | 1.4 | 0.41 | 1 | 1.35 | 0.6 | 1.6 | 0.75 | 1.51 |
| RTS + RCS | 1.92 | 0.96 | 2.07 | 2.7 | 2.13 | 3.96 | 2.32 | 3.94 |

As revealed by the data in Table E1B above, applicants have surprisingly found that extruded PET:PEF foams according to the present invention generally possess superior strength characteristics when the blowing agent comprises, or consists essentially of or consists of 1234ze(E) in comparison to other blowing agents, including 1233zd and, 1336, as revealed by the data in the table above. Nevertheless, acceptable extruded foams are made and have substantial utility when the blowing agent comprises, or consists essentially of or consists of 1233zd(E) or 1336mzz(Z), as also revealed by the data above.

### Comparative Example 4A: PET Homopolymer Preparation at Molecular Weight of 46.4 kg/mol with PMDA and SSP

A PET homopolymer was prepared using the same design conditions as specified in Comparative Example 1 but with process conditions targeted to produce a polymer molecular weight in the range of 40,000 to 50,000 g/mol. As with Comparative Example 1, the polymer was treated according to known techniques with the chain extender PMDA at 0.7% by weight and then subjected to solid state polymerization as described in Comparative Example 1 to produce the PET homopolymer. The PET homopolymer was tested and found to have the characteristics as reported in Table C4A below:

TABLE C4A

| | Comparative Example C4A |
|---|---|
| Polymer No - PET | 36895-65-3D SSP |
| Polymers | |
| Designation | PETC4 |
| PET Homopolymer | 46,400 |
| Molecular Weight | |
| Glass Transition | 80 |
| Temperature, ° C. | |
| Melt Temperature, ° C. | 238 |
| Decomposition | 383 |
| Temperature, ° C. | |
| Crystallinity, % | 32.8 |

The PET polymer so produced are referred to in these Examples as PETC4A.

### Comparative Example 4B: PET Foam Preparation Using PETC4A with 1234ze(E) Blowing Agents

Two (2) foams are made using extrusion foaming processes that are designed using the same criteria as described in Comparative Example 1B. The extrusion foam produced in this Comparative Example 4 is tested and found to have the properties as reported in Table C4B below:

TABLE C4

| Example→ | C4B1 | C4B2 |
|---|---|---|
| MATERIAL | | |
| Polymer MW, | PETC4A1 46.4 | PETC42 46.4 |
| kg/mol | | |
| Blowing Agent* | 1234ze(E) | 1234ze(E) |
| FOAM | | |
| PROP | | |
| RFD | 0.184 | 0.129 |
| RTS | 0.2 | 0.5 |
| RCS | 1.7 | 0.83 |

### Example 15A—PEF Homopolymer Preparation with MW of about 49 kg/mol with PMDA and SSP

A homopolymer of PEF was made using the same additives and basic polymer formation procedures as were used to form the PET homopolymer of Comparative Example 3 to achieve polymer molecular weight of about 49,000 g/mol. In particular, the 49 kg/mol MW PEF homopolymer was formed by esterification and polycondensation of 75 grams of 2,5-furandicarboxylic acid (FDCA) with 59.8 grams of mono ethylene glycol (EG). The reactants were added to a 500 mL cylindrical steel reactor equipped with an overhead stirrer and a distillation/condensation apparatus. After pulling vacuum and back filling with nitrogen, 0.067 gram of titanium (IV) isopropoxide catalyst was added to the flask. The flask was then lowered into a 180° C. salt bath and overhead mixing was started at 200 rpm under a nitrogen atmosphere. After 2.5 hours, the bath temperature was increased to 220° C. After 30 minutes at this temperature under nitrogen, vacuum was started. After 40 minutes under vacuum, the temperature was increased to 230° C. and was continued for 1 hour. Under a stream of nitrogen, 0.58 gram (0.7% by weight) of PMDA was slowly added over a time of about 5 minutes. To perform SSP, an aliquot (30 g) of the product was ground and heated at 180° C. under vacuum for 3 days on a rotary evaporator to produce the PEF homopolymer as reported below. The PEF homopolymer was tested using the same measurement techniques as described in Comparative Example 1 and found to have the characteristics reported in Table E15 below:

TABLE E15

| | Example 15 (PEF15A) |
|---|---|
| Molecular Weight, g/mol | 49,000 |
| Glass Transition | 92 |
| Temperature, ° C. | |
| Melt Temperature, ° C. | 220 |
| Decomposition Temperature, ° C. | 340 |
| Crystallinity, % | 43 |

The PEF polymer so produced is referred to in Table E3 and in the Examples hereinafter as PEF15A.

### Examples 15B: PEF Foam Preparation Using PEF3 and Trans1234ze as Blowing Agent

Three foams are made from PEF2 as described herein using extrusion foaming processes that are designed using the same criteria as described in Comparative Example 1. The extruded foams thus produced are tested and found to have the properties as reported in Table 15A below:

TABLE E15A

| Example→ | E15A | E15B | E15C |
|---|---|---|---|
| RUNS | 42/3 | 62/2 | 51/6 |
| MATERIALS | | | |
| Polymer | PEF2 (49) | PEF2 (49) | PEF2 (49) |
| (MW, K) | | | |
| Blowing | 1234ze(E) | 1234ze(E) | 1234ze(E) |
| Agent | | | |
| FOAM | | | |
| PROP | | | |
| RFD | 0.08 | 0.094 | 0.064 |
| Avg. RFD | 0.079 | | |
| RTS | 0.76 | 1.92 | 1.35 |
| Avg. RTS | 1.34 | | |
| RCS | 1.35 | 1.22 | 0.55 |

Surprisingly, the extruded foams made with the lower molecular weight PEF of this example did not exhibit a substantial reduction in tensile strength compared to the PET foams made with higher molecular weight PET. This result is unexpected. Consequently, the tensile strength of the extruded foams made from PEF homopolymers with a molecular weight of 49K and 1234ze(E) blowing agent was dramatically superior to the extruded foams made from the PET homopolymer at a molecular weight of 46.5K and 1234ze(E) blowing agent. This unexpected result can be shown, for example, by observing that the average RFD of the three PEF data points according to the present invention results in an average density of 0.079 and an average relative tensile strength of 1.34. In comparison to the extruded PET foam, which has a density that is more than 200% greater the average extruded PEF foam density, the PEF foams of the present invention nevertheless produce an average tensile strength that is 4 times greater than the average relative tensile strength (0.35) of the high-density PET foam. This is a very important and unexpected result.

### Example 16—PET9:PEF1 Copolymer Preparation with MW of about 133.8 kg/mol with PMDA and SSP

A random copolymer of PET9:PEF1 (9:1 mole ratio) was prepared by adding 8.7 grams (0.0472 moles) of furan dicarboxylic methyl ester (FDME), 106.8 grams (0.42 moles) of bis(2-hydroxyethyl) terephthalate (BHET) and 6.2 grams (0.1 moles) of EG to a 500 mL cylindrical steel reactor equipped with an overhead stirrer and a distillation/condensation apparatus. After evacuating and back filling with N2, 0.046 grams of Ti (IV) isopropoxide catalyst were added. The reactor was then placed into a 180° C. salt bath and overhead mixing was started at 200 rpm under N2 atmosphere. After 2.5 hours the bath temperature was increased to 220° C. After 30 minutes under N2, vacuum was started. After 40 minutes under vacuum, the temperature was increased to 250° C. and continued for 40 minutes. Under N2 atmosphere, 0.59 grams of PMDA (0.0.0027 mol) was slowly added. An additional 30 minutes of mixing at temperature were allowed before stopping the reaction. Solid state polymerization was conducted by grinding an aliquot (30 g) of the above product and then heating at 180° C. under vacuum for 3 days on a rotary evaporator. The PEF polymer was tested and found to have the characteristics in Table E7:

TABLE E16

| | Example 16 (PET9PEF1) |
|---|---|
| Molecular Weight, g/mol | 133,800 |
| Glass Transition | 82.5 |
| Temperature, ° C. | |
| Melt Temperature, ° C. | 219 |
| Decomposition Temperature, ° C. | 377 |
| Crystallinity, % | 25-26% |

The PET9:PEF1 random copolymer so produced is referred to in these Examples as PET9PEF1-EX16.

### Examples 16B1-16B3—PETPEF Copolymer Foam Preparation Using PET9PEF1-EX16B and Trans1234ze as Blowing Agent

Three (3) extruded foams are made from PET9PEF1-EX16B using extrusion foaming processes that are designed using the same criteria as described in Comparative Example 1. The extruded foams thus produced are tested and found to have the properties as reported in Table E16B below:

TABLE E16B

| Example→ | E16B1 | E16B2 | E16B3 |
|---|---|---|---|
| MATERIALS | | | |
| Polymer (MW, | PET9PEF1- | PET9PEF1- | PET9PEF1- |
| kg/mol) | EX16B (133.8) | EX16B (133.8) | EX16B (133.8) |
| Blowing Agent | 1234ze(E) | 1234ze(E) | 1234ze(E) |
| FOAM | | | |
| PROPERTIES | | | |
| RFD | .061 | 0.062 | .088 |
| RTS | 0.90 | 0.87 | 1.41 |
| RCS | 0.33 | 0.48 | 0.85 |

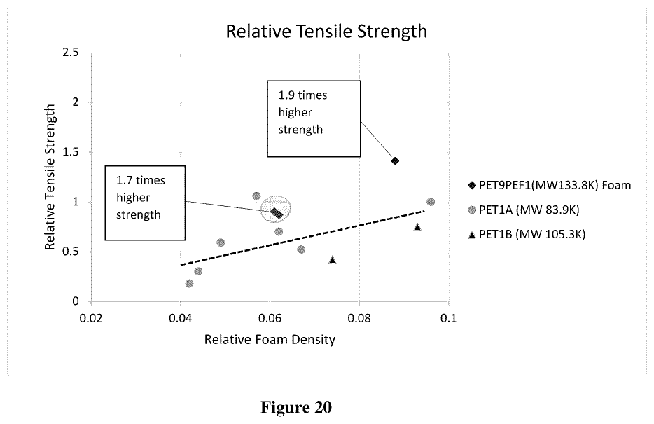

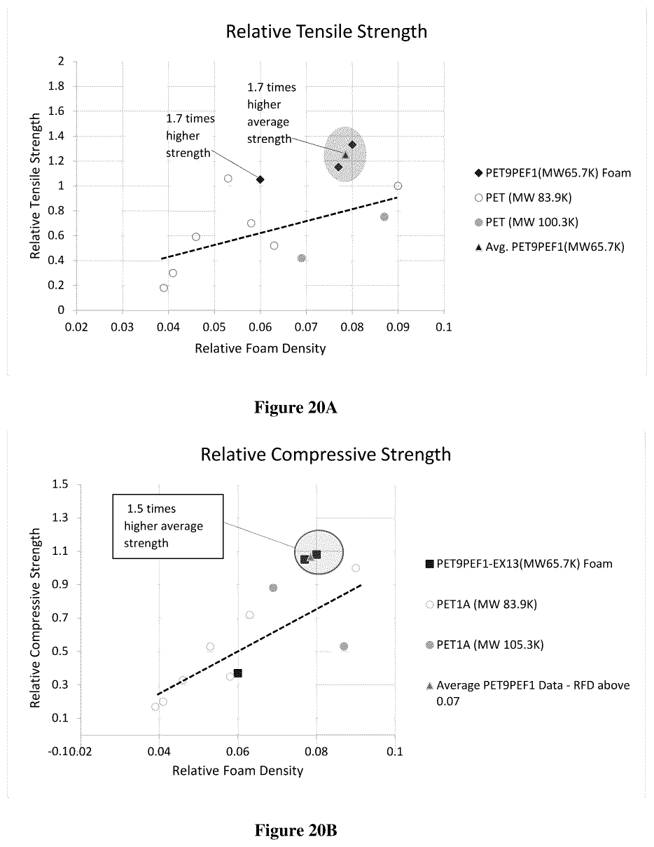

As revealed by the data in Table E16B above, applicants have surprisingly found that the extruded foam made from PEF9:PET1-EX16B according to the present invention possess tensile strength that is unexpectedly superior to extruded foams formed from PET homopolymer, as illustrated by FIG. 20, which includes for the purposes of comparison the PET tensile strength data from comparative examples.

As illustrated in FIG. 20, the relative tensile strength of the extruded foams made from PET9PEF1-EX16B copolymers, which contained a relatively low percentage of PEF moieties (about 10 mole %) and which used 1234ze(E) as blowing agent, produced superior relative tensile strength compared to the extruded foams made from PET1A and PET1B homopolymer and 1234ze(E) blowing agent.

One aspect of this unexpected result can be shown, for example, by noting that the relative tensile strength of the two extruded foams made with PET9PEF1-EX16B copolymer at about an RFD of about 0.062 had an average relative tensile strength of 0.89. In contrast, at this same RFD of about 0.062, the extruded PET homopolymer had a relative tensile strength of about 0.52 based on a trend line for the PET data, as illustrated by the dashed line in the chart above. This represents a relative tensile strength that is about 1.7 times greater for applicants' PET9PEF1 foam of this example compared to the extruded foam made from the PET homopolymer. Similarly, at about an RFD of about 0.088, the PET9PEF1 extruded foam had a relative tensile strength of 1.41. In contrast, at this same RFD of about 0.088 the extruded PET homopolymer foam had a relative tensile strength of about 0.75 according to the PET trend-line. This represents a relative tensile strength that is about 1.9 times greater for applicants' PET9PEF1 foam. These are important and unexpected results.

### Comparative Example C5: PET Homopolymer Preparation at Molecular Weight of about 38 kg/mol with PMDA and SSP

A PET homopolymer was prepared by adding about 93 grams (0.3659 mol) of bis(2-hydroxyethyl) terephthalate (BHET) to a 500 mL round bottom flask. After pulling vacuum and back filling with N2, the flask was lowered into a 180° C. salt bath and overhead mixing was started at 100 rpm under N2 flow. 0.13 grams (0.00045 mole) of titanium isopropoxide catalyst were charged into the flask. After 1 hour, the bath temperature was increased to 230° C. After 30 minutes at this temperature under N2, vacuum was started and continued for 1 hour, and then temperature was increased further to 285° C. After two hours at 285° C., pyromellitic dianhydride PMDA (0.49 g; 0.0022 mol) was slowly added over the span of about 10 minutes. An additional 30 minutes of mixing at temperature were allowed before stopping the reaction. Solid state polymerization was conducted by grinding an aliquot (30 g) of the above product and then heating at 180° C. under vacuum for 3 days on a rotary evaporator. The PET homopolymer thus produced was tested and found to have the characteristics as reported in Table C5 below:

TABLE C5

| | Example |
|---|---|
| | C5 |
| Designation | PET3 |
| PET Homopolymer | 37,600 |
| Molecular Weight | |
| Melt Temperature, ° C. | 246 |
| Decomposition | 382 |
| Temperature, ° C. | |
| Crystallinity, % | 37.4 |

The PET polymer so produced are referred to in these Examples as PETC3.

### Comparative Example 6: PET Foam Preparation Using PETC3 with 1234ze(E) Blowing Agent

An extruded foam is produced in this Comparative Example 6 and is tested and found to have the properties as reported in Table C6 below:

TABLE C6

| Example→ | C6 |
|---|---|
| MATERIAL | |
| Polymer (MW, kg/mol) | PET3 (37.6K) |
| Blowing Agent | 1234ze(E) |
| Blowing Agent, (moles) | 0.48 |
| FOAM | |
| PROP | |
| RFD | 0.19 |
| RTS | 0.59 |
| RCS | 0.83 |

### Example 17A—PEF Homopolymer Preparation with MW of 33 kg/mol with PMDA and SSP

A homopolymer of PEF was made using the same additives and basic polymer formation procedures as were used to form the PEF homopolymer of Comparative Example 3 to achieve polymer molecular weight of about 30,000 kg/mol. In particular, the PEF homopolymer was formed by esterification and polycondensation of 2,5-furandicarboxylic acid with mono-ethylene glycol according to methods consistent with those described herein to produce PEF homopolymer, which is then treated according to known techniques with PMDA at 0.7% by weight. The polymer then undergoes solid state polymerization consistent with the prior examples to produce a PEF homopolymer. The PEF polymer was tested using the same measurement techniques as described in Comparative Example 1 and found to have the characteristics reported in Table E17A below:

TABLE E17A

| | Example 17 (PEF-Ex17A) |
|---|---|
| Designation | PEF-Ex17 |
| Molecular Weight, g/mol | 33,000 |
| Glass Transition | 90.5 |
| Temperature, ° C. | |
| Melt Temperature, ° C. | 224 |
| Decomposition Temperature, ° C. | 341 |
| Crystallinity, % | 45 |

The PEF polymer produced in this Example is referred to Table E17A above and hereinafter as PEF-Ex17A.

### Examples 17B-1 and 17B: PEF Foam Preparation Using PEF-EX17A and Trans1234ze as Blowing Agent

Two extruded foams are made from PEF-EX17A using extrusion foaming processes that are designed using the same criteria as described in these examples. The extruded foams thus produced are tested and found to have the properties as reported in Table E17A below:

TABLE E17A

| Example→ | E17B-1 | E17B-2 |
|---|---|---|
| MATERIALS | | |
| Polymer | PEFEX17 (33) | PEFEX17 (33) |
| (MW, | | |
| kg/mol) | | |
| Blowing | 1234ze(E) | 1234ze(E) |
| Agent | | |
| FOAM | | |
| PROP | | |
| RFD | 0.08 | 0.081 |
| RTS | 1.34 | 1.33 |
| RCS | 0.55 | 1.12 |

Surprisingly, the tensile strength of the extruded foams made from PEF homopolymers and 1234ze(E) blowing agent is dramatically superior to the extruded foams made from the PET homopolymer and 1234ze(E) blowing agent. In this regard, it is important to note that the molecular weight (37.6 K) of the PET used to make the extruded PET foam was reasonably close to the molecular weight of extruded PEF foams (33K), thus making the data comparable from a molecular weight standpoint. This unexpected result can be shown, for example, by first taking an average of the two PEF data points according to the present invention having an RFD of less than 0.1 and then noting that the average density for those two points is 0.0805 and that the average relative tensile strength is 1.34. In comparison to the PET foam, which has a density that is more than 2.4 times the density of the foam made from the PEF of the present invention, the present PEF foam nevertheless produces an average tensile strength that is equal to the tensile strength of the PET foam. This is a very important and unexpected result.

Surprisingly, the compressive strength of the extruded foams made from PEF homopolymers and 1234ze(E) blowing agent are dramatically superior to the foams made from the PET homopolymer and 1234ze(E) blowing agent. This unexpected result can be shown, for example, by first taking an average of the two PEF data points according to the present invention having an RFD of less than 0.1 and noting that the average density for those two points is 0.0805 and that the average relative compressive strength is 0.84. In comparison to the PET foam, which has a density that is more than 2 times the average PEF foam density, the PEF foams of the present invention nevertheless produce an average tensile strength that is equal to the tensile strength of the PET foam. This is a very important and unexpected advantage of PEF foam compared to PET foam.

### Example 18A—PET9:PEF1 Copolymer Preparation with PET MW of about 133.8 kg/mol with PMDA and SSP

A random copolymer of PET9:PEF1 (9:1 mole ratio) was prepared by adding 8.7 grams (0.0472 moles) of furan dicarboxylic methyl ester (FDME), 106.8 grams (0.42 moles) of bis(2-hydroxyethyl) terephthalate (BHET) and 6.2 grams (0.1 moles) of EG to a 500 mL cylindrical steel reactor equipped with an overhead stirrer and a distillation/condensation apparatus. After evacuating and back filling with N2, 0.046 grams of Ti (IV) isopropoxide catalyst were added. The reactor was then placed into a 180° C. salt bath and overhead mixing was started at 200 rpm under N2 atmosphere. After 2.5 hours the bath temperature was increased to 220° C. After 30 minutes under N2, vacuum was started. After 40 minutes under vacuum, the temperature was increased to 250° C. and continued for 40 minutes. Under N2 atmosphere, 0.59 grams of PMDA (0.0.0027 mol) was slowly added. An additional 30 minutes of mixing at temperature were allowed before stopping the reaction. Solid state polymerization was conducted by grinding an aliquot (30 g) of the above product and then heating at 180° C. under vacuum for 3 days on a rotary evaporator. The PEF polymer was tested and found to have the characteristics in Table E18A:

TABLE E18A

| | Example 18A |
|---|---|
| | (PET9PEF1-EX18A) |
| Molecular Weight, g/mol | 133,800 |
| Glass Transition | 82.5 |
| Temperature, ° C. | |
| Melt Temperature, ° C. | 219 |
| Decomposition Temperature, ° C. | 377 |
| Crystallinity, % | 25-26% |

The PET9:PEF1 random copolymer so produced is referred to in these Examples as PET9PEF1-EX18A.

### Examples 18B1, 18B2 and 18C3—Extruded PETPEF Copolymer Foam Preparation Using PET9PEF1-EX18A and Trans1234ze as Blowing Agent

Three (3) extruded foams were made from PET9PEF1-EX18A using extrusion foaming processes that were designed using the same criteria as described in Comparative Example 1. The extruded foams thus produced are tested and found to have the properties as reported in Table E18B below:

TABLE E18B

| Example→ | E18B1 | E18B2 | E18B3 |
|---|---|---|---|
| MATERIALS | | | |
| Polymer (MW, | PET9PEF1- | PET9PEF1- | PET9PEF1- |
| kg/mol) | EX18A (133.8) | EX18A (133.8) | EX18A (133.8) |
| Blowing Agent | 1234ze(E) | 1234ze(E) | 1234ze(E) |
| FOAM | | | |
| PROPERTIES | | | |
| RFD | .061 | 0.062 | .088 |
| RTS | 0.90 | 0.87 | 1.41 |
| RCS | 0.33 | 0.48 | 0.85 |

As revealed by the data in Table E18B above, applicants have surprisingly found that the extruded foams made from PEF9:PET1-EX18A according to the present invention possess tensile strength that are unexpectedly superior to extruded foams formed from PET homopolymer, which includes for the purposes of comparison the PET tensile strength data from the comparative examples.

The relative tensile strength of the extruded foams made from PET9PEF1-EX18A copolymer, which contained a relatively low percentage of PEF moieties (about 10 mole %) and which used 1234ze(E) as blowing agent, produced superior relative tensile strength compared to the foams made from the comparative PET homopolymer foam, even though they were formed from the preferred 1234ze(E) blowing agent of the present invention.

One aspect of this unexpected result can be shown, for example, by noting that the relative tensile strength of the two extruded foams made with PET9PEF1-EX7 copolymer at about an RFD of about 0.062 had an average relative tensile strength of 0.89. In contrast, at this same RFD of about 0.062, the PET homopolymer had a relative tensile strength of about 0.52 based on a trend line for the PET data, as illustrated by the dashed line in the chart above. This represents a relative tensile strength that is about 1.7 times greater for applicants' PET9PEF1 foam of this example compared to the foam made from the PET homopolymer. Similarly, at about an RFD of about 0.088, the PET9PEF1 foam had a relative tensile strength of 1.41. In contrast, at this same RFD of about 0.088 the PET homopolymer foam had a relative tensile strength of about 0.75 according to the PET trend-line. This represents a relative tensile strength that is about 1.9 times greater for applicants' PET9PEF1 foam. These are important and unexpected results.

### Example 19A—PET1:PEF9 Copolymer Preparation with MW of about 85 kg/mol with PMDA and SSP

A random copolymer of PET1:PEF9 (1:9 mole ratio) was prepared with a target molecular of about 85,000 g/mol. In particular, 90.7 grams of FDME (0.49 moles) and 13.9 grams of BHET (0.055 moles) and 64.1 grams of EG (1.03 moles) were added to a 500 mL round steel reactor equipped with an overhead stirrer and a distillation/condensation apparatus. After evacuating and back filling with N2, 0.074 gram of the Ti (IV) isopropoxide catalyst was added. The flask was then lowered into a 180° C. salt bath and overhead mixing was started at 200 rpm under N2 atmosphere. After 2.5 hours the bath temperature was increased to 220° C. After 30 minutes at this temperature under N2, vacuum was started. After 40 min under vacuum, the temperature was increased to 250° C. and was continued for 2 hours. Under a N2 atmosphere, 0.68 gram of PMDA were slowly added. An additional 30 minutes of mixing at temperature were allowed before stopping the reaction. Solid state polymerization was conducted by grinding an aliquot (30 g) of the above product and then heating at 180° C. under vacuum for 3 days on a rotary evaporator. The copolymer thus produced was a random copolymer with an overall molar ratio of PET:PEF of 1:9 and with PET to PEF of 1.1. The PEF polymer was tested and found to have a molecular weight of about 85,100.

The PET1:PEF9 copolymer so produced is referred to in these Examples as PET1PEF9-EX19A.

### Example 19B—PET1PEF9 Copolymer Foam Preparation Using PET1PEF9EX11 and Trans1234ze as Blowing Agent

One extruded foam was made from PET1PEF9-EX19A using extrusion foaming processes that were designed using the same criteria as described in the comparative examples. The extruded foam thus produced was tested and found to have the properties as reported in Table E19B below:

TABLE E19B

| Example→ | E19B |
|---|---|
| MATERIALS | |
| Polymer (MW, kg/mol) | PET1PEF9-EX19B (85.1) |
| Blowing Agent* | 1234ze(E) |
| Blowing Agent, (moles) | 0.26 |
| FOAM | |
| PROPERTIES | |
| RFD | 0.063 |
| RTS | 1.2 |
| RCS | 0.52 |

As revealed by the data in Table E19B above, applicants have surprisingly found that the extruded foams made with the PET1:PEF9-EX19A copolymer according to the present invention possess tensile strength that is unexpectedly superior to the tensile strength of extruded foams formed from PET homopolymer. The tensile strength of the extruded foam made from PET1PEF9-EX19A copolymer, which contained about 10% of PET moieties and which used 1234ze(E) as blowing agent, produced dramatically superior tensile strength compared to the comparative PET homopolymers of the made with 1234ze(E) blowing agent. In this regard it is important to note that the molecular weights (83.9 kg/mol and 105.3 kg/mol) of the PET homopolymers used to make the extruded PET foams were sufficiently close to the molecular weights of the foam made using the PET1PEF9-EX19A copolymer (85.1K) to make the data comparable in favor of the PET homopolymer from a molecular weight standpoint.

One aspect of this unexpected result can be shown, for example, by noting that the tensile strength of the foam made with PET1PEF9 copolymer at about an RFD of 0.063 produced a tensile strength of 1.2. In contrast, at this same RFD of about 0.063, the PET homopolymer had a tensile strength of about 0.6 based on the trendline. This represents a tensile strength that is about 2 times greater for applicants' PET1PEF9 foam of this example compared to the foam made from the PET homopolymer. This is an important and unexpected result.

### Example 20—PET9:PEF1 Copolymer Preparation with MW of about 65.7 kg/mol with PMDA Chain Extender and SSP

A block copolymer of PET9:PEF1 (9:1 mole ratio) was prepared with a target molecular weight of about 65,000 g/mol with PET to PEF blocks of 1-5,1-3. In particular, PEF was first prepared by adding 498 grams of FDCA (2.7 moles) and 417 grams of EG (6.72 moles) to a 1000 mL cylindrical glass reactor equipped with an overhead stirrer and a distillation/condensation apparatus which was immersed in a 190° C. salt bath. After purging with nitrogen, 0.414 grams of Ti (IV) isopropoxide catalyst were added to the flask and overhead mixing was started at 200 rpm under N2 atmosphere. After 2.5 hours the bath temperature was increased to 220° C. After 30 minutes at this temperature under N2, vacuum was started. After 40 minutes under vacuum, the temperature was increased to 240° C. and was continued for 2 hours before stopping the reaction, and PEF was produced.

PEF Oligomers were prepared by adding 109 grams of EG and 0.45 grams of sodium carbonate to a 500 ml cylindrical reactor equipped with a reflux condenser and an overhead stirrer. The mixture was heated until boiling (196° C.), and then an aliquot of PEF (160 grams) from the above step was added. The mixture was allowed to react under reflux for 2 hours until the reaction was stopped. The resulting mixture are the PEF oligomers.

PET Oligomers were prepared by adding, EG (28 grams) and sodium carbonate (0.46 g) to a 500 ml cylindrical reactor equipped with a condenser and an overhead stirrer. The mixture was heated until boiling (196° C.). Then 170 grams of commercially available PET were added. The mixture was allowed to react under reflux for 2 hours until the reaction was stopped. The result was a PET oligomer mixture.

The co-polymer was made by quickly adding 7.14 grams of the PEF oligomers and 67.9 grams of the PET oligomers to a 500 mL cylindrical steel reactor equipped with an overhead stirrer and a distillation/condensation apparatus that was immersed in a 220° C. salt bath, followed by adding 0.84 grams of Ti(IV) isopropoxide. Shortly thereafter (<2 min), vacuum was applied to remove EG. After 40 minutes, the temperature was increased to 270° C., and the contents of the reactor were allowed to remain under vacuum for 40 minutes. Under a N2 atmosphere, 0.46 grams of PMDA were slowly added over the span of about 5 minutes. An additional 30 minutes of mixing at temperature were allowed before stopping the reaction. Solid state polymerization was then conducted by grinding an aliquot (30 g) of this product and then heating at 180° C. under vacuum for 3 days on a rotary evaporator.

The PET9:PEF1 copolymer was tested and found to have the characteristics in Table E20A:

TABLE E20A

| | Example 20A |
|---|---|
| | (PET9PEF1-EX20A) |
| Molecular Weight, g/mol | 65,700 |
| Glass Transition Temperature, ° C. | 80.4 |
| Melt Temperature, ° C. | 217-221 |
| Decomposition Temperature, ° C. | 369 |
| Crystallinity, % | 20-24 |

The PET:PEF block copolymer so produced is referred to in these Examples as PET9PEF1-EX20A.

### Examples 20B1, 20B2 and 20B3—PETPEF Copolymer Foam Preparation Using PET9PEF1-EX20A and Trans1234ze as Blowing Agent

Three (3) extruded foams were made from PET9PEF1-EX20A using extrusion foaming processes that are designed using the same criteria as described for the examples above. The extruded foams thus produced are tested and found to have the properties as reported in Table E20B below:

TABLE E20B

| Example→ | E20B1 | E20B2 | E20B3 |
|---|---|---|---|
| MATERIALS | | | |
| Polymer (MW, | PET9PEF1- | PET9PEF1- | PET9PEF1- |
| kg/mol) | EX20A (65.7) | EX20A (65.7) | EX20A (65.7) |
| Blowing Agent* | 1234ze(E) | 1234ze(E) | 1234ze(E) |
| FOAM | | | |
| PROPERTIES | | | |
| RFD | 0.06 | .077 | 0.08 |
| RTS | 1.04 | 1.15 | 1.33 |
| RCS | 0.37 | 1.05 | 1.08 |

As revealed by the data in Table E20B above, applicants have surprisingly found that the extruded PET9:PEF1-EX20B copolymer foam according to the present invention possess tensile strength that is unexpectedly superior to the tensile strength of extruded foams formed from comparable PET homopolymers, as illustrated FIG. 20A, which includes for the purposes of comparison the PET tensile strength data from comparative examples. As illustrated in FIG. 20B, the compressive strength of the foam made with the PET9PEF1 copolymer and 1234ze(E) of the present invention was as good as, or in the case of foams having an RFD above 0.07, substantially and unexpectedly better than, the compressive strength exhibited by foams made from PET homopolymer. With reference to the data above RFD of 0.07, the extruded foam made from the PET9PEF1 copolymer exhibited an average relative compressive strength of 1.065, while the PET foam at this RFD had a compressive strength of about 0.7 based on the trendline. At densities above 0.07, therefore, the extruded foams made with PET9PEF1 copolymer and 1234ze(E) produced a compressive strength that is 1.5 times higher than the foams made with the PET homopolymers, based on the PET data trendline. This is an important and unexpected result.

### Example 21—PET1:PEF9 Copolymer Preparation with MW of about 25 kg/mol with PMDA and SSP

A random copolymer of PET1:PEF9 (1:9 mole ratio) was prepared with a target molecular of about 25,000 g/mol and a PET to PEF blocks of 1,1. In particular, 40 grams of FDME (0.26 moles) and 7.24 grams of BHET (0.0285 moles) and 31.8 grams of EG (0.5123 moles) were added to a 250 mL round bottom flask equipped with stir bar. After pulling vacuum and back filling with N2, the flask was lowered into a 180C salt bath and overhead mixing was started at 100 rpm under N2 flow. Then 0.04 grams of the Ti (IV) isopropoxide catalyst were added. After 2.5 hours the bath temperature was increased to 230° C. After 30 minutes at this temperature under N2, vacuum was started and continued for 2 hours. Under an N2 atmosphere, 0.313 grams of PMDA were slowly added over the span of about 10 minutes. An additional 30 minutes of mixing at temperature were allowed before stopping the reaction. Solid state polymerization was conducted by grinding an aliquot (20 g) of the above product and then heating at 180° C. under vacuum for 3 days on a rotary evaporator. The PET1:PEF9 copolymer was tested and found to have the characteristics in Table E21A:

TABLE E21A

| | Example 21 (PET1PEF9) |
|---|---|
| | 25,500 |
| Molecular Weight, g/mol | 25,500 |
| Glass Transition Temperature, ° C. | 88.7 |
| Melt Temperature, ° C. | 206 |
| Decomposition Temperature, ° C. | 347 |
| Crystallinity, % | 3.7% |

The PET1:PEF9 random copolymer produced is referred to in these Examples as PET1PEF9-EX21A.

### Examples 21B1 and 21B2—PETPEF Copolymer Foam Preparation Using PET1PEF9-EX21A and Trans1234ze as Blowing Agent

An extruded foam was made from PET1PEF9-EX21A using an extrusion foaming process that was designed using the same criteria as described in the examples above. The extruded foams thus produced were tested and found to have the properties as reported in Table E21B below:

TABLE E21B

| Example→ | E21B |
|---|---|
| MATERIALS | |
| Polymer (MW, K) | PET9PEF1-EX21A (25.5) |
| Blowing Agent | 1234ze(E) |
| FOAM | |
| PROPERTIES | |
| RFD | .065 |
| RTS | 1.32 |
| RCS | 0.55 |

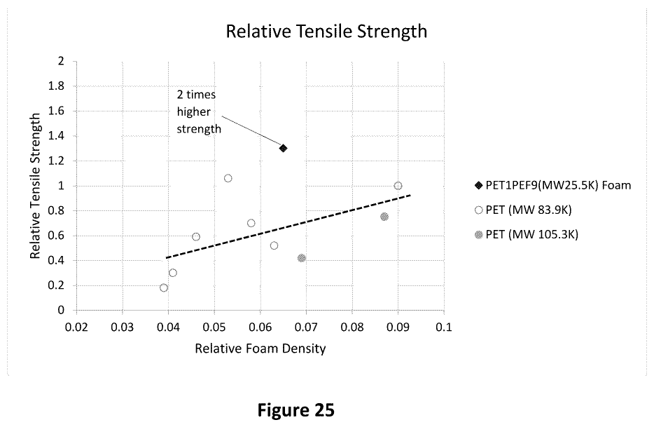

As revealed by the data in Table E21B above, applicants have surprisingly found that extruded PEF foams according to the present invention, namely PET1PEF9-EX21B copolymers, possess tensile strength that is unexpectedly superior to extruded foams formed from PET, as illustrated in FIG. 25, which includes for the purposes of comparison the PET tensile strength data from the comparative examples.

### SYNTHESIS EXAMPLES

### Synthesis Example 1A1

A 41.2 kg/mol PEF homopolymer was formed by esterification and polycondensation of 75 grams of 2,5-furandicarboxylic acid (FDCA) with 55 grams of mono-ethylene glycol (EG). The reactants were added to a 500-mL cylindrical steel reactor equipped with an overhead stirrer and a distillation/condensation apparatus. After pulling vacuum and back filling with nitrogen, 0.228 gram of titanium (IV) isopropoxide catalyst was added to the flask. The flask was then lowered into a 180° C. salt bath and overhead mixing was started at 200 rpm under a nitrogen atmosphere. After 2.5 hours, the bath temperature was increased to 220° C. After 30 minutes at this temperature under nitrogen, vacuum was started. After 40 minutes under vacuum, the temperature was increased to 250° C. and was continued for 1 hour. Under a stream of nitrogen, PMDA (0.5732 g) was slowly added over the span of about 5 minutes. An additional 30 minutes of mixing at temperature were allowed before stopping the reaction. To perform SSP, an aliquot of the product was ground and heated at 180° C. under vacuum for 3 days on a rotary evaporator to produce the PEF homopolymer with a molecular weight of 41 kg/mole as reported in Example 1A.

### Synthesis Example 1A2—75000

In particular, the 75 kg/mol PEF homopolymer was formed by esterification and polycondensation of 350 grams of 2,5-furandicarboxylic acid (FDCA) with 279 grams of mono-ethylene glycol (EG). The reactants were added to a 1-liter cylindrical steel reactor equipped with an overhead stirrer and a distillation/condensation apparatus. After pulling vacuum and back filling with nitrogen, 0.228 gram of titanium (IV) isopropoxide catalyst was added to the flask. The flask was then lowered into a 180° C. salt bath and overhead mixing was started at 200 rpm under a nitrogen atmosphere. After 2.5 hours, the bath temperature was increased to 220° C. After 30 minutes at this temperature under nitrogen, vacuum was started. After 40 minutes under vacuum, the temperature was increased to 230° C. and was continued for 1 hour. Under a stream of nitrogen, PMDA (2.73 g—0.7% by weight) was slowly added over the span of about 5 minutes. An additional 30 minutes of mixing at temperature were allowed before stopping the reaction. To perform SSP, an aliquot (30 g) of the product was ground and heated at 180° C. under vacuum for 3 days on a rotary evaporator to produce the PEF homopolymer with a molecular weight of 75 kg/mole as reported in Example 1A.

### Synthesis Example 2A1—PEF Homopolymer Preparation with MW Range of about 90 kg/mol with PMDA and SSP

For the 90.8 kg/mol MW polymer, FDCA (75 g) and EG (54.6 g) were added to a 500 mL cylindrical steel reactor equipped with an overhead stirrer and a distillation/condensation apparatus. After pulling vacuum and back filling with nitrogen, 0.100 gram of titanium (IV) isopropoxide catalyst was added to the flask. The flask was then lowered into a 180° C. salt bath and overhead mixing was started at 200 rpm under a nitrogen atmosphere. After 2.5 h, the bath temperature was increased to 220° C. After 30 minutes at this temperature under nitrogen, vacuum was started. After 40 min under vacuum, the temperature was increased to 250° C. and was continued for 2 h. Under a stream of nitrogen, PMDA (0.587 g) was slowly added over the span of about 5 minutes. The reaction was stopped after an additional 30 minutes of mixing at temperature. The product was removed from the vessel. Gamma-valerolactone was added to dissolve the polymer that was remaining in the reactor and on the impeller. The mixture was stirred for several hours at 190° C. The gamma-valerolactone was distilled from the polymer under vacuum resulting in a solid. To perform SSP, an aliquot (30 g) of the product was ground and heated at 180° C. under vacuum for 3 days on a rotary evaporator to produce the PEF homopolymer with a molecular weight of 90.8 kg/mole as reported in Example 2A.

### Synthesis Example 2A2—PEF Homopolymer Preparation with MW Range of about 96 kg/mol with PMDA and SSP

For the 96,078 g/mol MW polymer, 75 grams of 2,5-furandicarboxylic acid (FDCA) with 55 grams of mono-ethylene glycol (EG). The reactants were added to a 500-mL cylindrical steel reactor equipped with an overhead stirrer and a distillation/condensation apparatus. After pulling vacuum and back filling with nitrogen, 0.228 gram of titanium (IV) isopropoxide catalyst was added to the flask. The flask was then lowered into a 180° C. salt bath and overhead mixing was started at 200 rpm under a nitrogen atmosphere. After 2.5 hours, the bath temperature was increased to 220° C. After 30 minutes at this temperature under nitrogen, vacuum was started. After 40 minutes under vacuum, the temperature was increased to 250° C. and was continued for 1 hour. Under a stream of nitrogen, PMDA (0.5732 g) was slowly added over the span of about 5 minutes. An additional 30 minutes of mixing at temperature were allowed before stopping the reaction. To perform SSP, an aliquot of the product was ground and heated at 180° C. under vacuum for 3 days on a rotary evaporator to produce the PEF homopolymer as reported below. The product was removed from the vessel. Gamma-valerolactone was added to dissolve the polymer that was remaining in the reactor and on the impeller. The mixture was stirred for several hours at 190° C. The gamma-valerolactone was distilled from the polymer under vacuum resulting in a solid. To perform SSP, an aliquot of the product was ground and heated at 180° C. under vacuum for 3 days on a rotary evaporator to produce the PEF homopolymer with a molecular weight of 96,078, as reported in Example 2A.

### Synthesis Example 3A—PET9:PEF1 Copolymer Preparation with MW of about 117.9:90.4 kg/mol with PMDA and SSP

A block copolymer of PET9:PEF1 (9:1 mole ratio) was prepared with a target molecular of about 117,900 g/mol with PET and PEF blocks of 4,4 respectively. In particular, PEF was first prepared by adding 498 grams of FDCA (2.7 moles) and 417 grams of EG (6.72 moles) to a 1000 mL cylindrical glass reactor equipped with an overhead stirrer and a distillation/condensation apparatus which was immersed in a 190° C. salt bath. After purging with nitrogen, 0.414 grams of Ti (IV) isopropoxide catalyst were added to the flask and overhead mixing was started at 200 rpm under N2 atmosphere. After 2.5 hours, the bath temperature was increased to 220° C. After 30 minutes at this temperature under N2, vacuum was started. After 40 minutes under vacuum, the temperature was increased to 240° C. and was continued for 2 hours before stopping the reaction, and PEF was produced.

PEF Oligomers were prepared by adding 109 grams of EG and 0.45 grams of sodium carbonate to a 500 ml cylindrical reactor equipped with a reflux condenser and an overhead stirrer. The mixture was heated until boiling in at salt bath at 230° C. An aliquot of PEF (160 grams) from the above step was added. The mixture was allowed to react under reflux for 2 hours until the reaction was stopped. The resulting mixture are the PEF oligomers.

PET Oligomers were prepared by adding, 103 grams of EG and 0.45 gram of sodium carbonate to a 500 ml cylindrical reactor equipped with a condenser and an overhead stirrer. The mixture was heated in at salt bath at 230° C. Then 160 grams of commercially available recycled PET flake were added. The mixture was allowed to react under reflux for 2 hours until the reaction was stopped. The result was a PET oligomer mixture.

The co-polymer was made by quickly adding 12.0 grams of the PEF oligomers and 111.7 grams of the PET oligomers to a 500 mL cylindrical steel reactor equipped with an overhead stirrer and a distillation/condensation apparatus that was immersed in a 220° C. salt bath, followed by adding 0.9083 grams of Ti(IV) isopropoxide. Shortly thereafter (<2 min), vacuum was applied to remove EG. After 40 minutes, the temperature was increased to 270° C., and the contents of the reactor were allowed to remain under vacuum for 40 minutes. Under a N2 atmosphere, 0.483 gram of PMDA was slowly added. An additional 30 minutes of mixing at temperature were allowed before stopping the reaction. Solid state polymerization was conducted by grinding an aliquot (30 g) of the above product and then heating at 180° C. under vacuum for 3 days on a rotary evaporator to produce the PET9:PEF1 copolymer with a PET molecular weight of 117.9 kg/mole as reported in Example 3A.

### Synthesis Example 5A—PET9:PEF1 Block Copolymer Preparation with MW of about 44.9 kg/mol with PMDA and SSP

A block copolymer of PET9:PEF1 (9:1 mole ratio) was prepared with a target molecular size of about 44,900 g/mol with PET and PEF blocks of 6,7, respectively.

PEF oligomers were prepared by adding 40.5 grams of EG and 0.174 grams of sodium carbonate to a 500 mL cylindrical reactor equipped with a reflux condenser and an overhead stirrer. The mixture was heated to 230° C. until the catalyst was completely dissolved. Commercially available PEF (59.5 grams) was added and the mixture was allowed to reflux under N2 for 2 hours. The resulting mixture are the PEF oligomers.

PET oligomers were prepared by adding, 235 grams of EG and 1.0 gram of sodium carbonate to a 1000 mL cylindrical reactor equipped with a condenser and an overhead stirrer. The mixture was heated to 230° C. until the catalyst was completely dissolved. Commercially available PET (364 g) was added and the mixture was allowed to reflux under N2 for 2 hours. The result was a PET oligomer mixture.

The co-polymer was made by quickly adding 12 grams of the PEF oligomers and 111.7 grams of the PET oligomers (both melted at 160° C.) to a 500 mL cylindrical steel reactor equipped with an overhead stirrer and a distillation/condensation apparatus that was immersed in a 220° C. salt bath, followed by adding 0.8847 grams of Ti(IV) isopropoxide. Shortly thereafter (<2 min), vacuum was slowly applied to remove EG. After 40 minutes, the temperature was increased to 270° C., and the contents of the reactor were allowed to remain under vacuum for 40 minutes. Under a N2 atmosphere, 0.483 gram of PMDA was slowly added. An additional 30 minutes of mixing at temperature were allowed before stopping the reaction, yielding a polymer with a molecular weight of ˜34,900 g/mol. An aliquot of this sample was sized to 60M and crystallized under N2 for 4 hours at 165° C. Solid state polymerization was then conducted on the above crystallized product by heating at 180° C. under vacuum for 1 day on a rotary evaporator to produce the PET9:PEF1 copolymer with a PET molecular weight of 117.9 kg/mole as reported in Example 5A.

### Synthesis Example 6A1—PET99:PEF1 Random Copolymer Preparation with MW of about 97.2 kg/mol with PMDA and SSP

A random copolymer of PET99:PEF1 (99:1 mole ratio) was prepared by adding 0.68 grams (0.0037 moles) of furan dicarboxylic methyl ester (FDME), 93.0 grams (0.366 moles) of bis(2-hydroxyethyl) terephthalate (BHET), and 0.46 grams (0.0074 moles) of EG to a 500 mL round bottom flask equipped with an overhead stirrer and a distillation/condensation apparatus. After evacuating and back filling with N2, 0.138 grams of Ti (IV) isopropoxide catalyst were added. The reactor was then placed into a 180° C. salt bath and overhead mixing was started at 100 rpm under N2 atmosphere. After one hour the bath temperature was increased to 230° C. After 30 minutes, temperature was increased to 270° C. After 2.5 hours under N2 at this temperature, vacuum was started and continued for 3 hours. Under an N2 atmosphere, 0.50 grams of PMDA (0.0.0023 mol) was slowly added. An additional 25 minutes of mixing at temperature were allowed before the mixer seized, yielding a polymer with a molecular weight of ˜58,000 g/mol. Solid state polymerization was conducted by grinding an aliquot of the above product and then heating at 180° C. under vacuum for 1 day on a rotary evaporator to produce a to produce the PET99:PEF1 copolymer with a PET molecular weight of 97,190 g/mole as reported in Example 6A.

A variation of this technique was used to produce the PET99:PEF1 copolymer with a PET molecular weight of 92,190 g/mole as reported in Example 6A.

### Synthesis Example 8A1 and 8A2—PET19:PEF1 Random Copolymer Preparation with MW of about 72 and 79 kg/mol with PMDA and SSP

A random copolymer of PET95:PEF5 (95:5 mole ratio) was prepared by adding 3.54 grams (0.0192 moles) of furan dicarboxylic methyl ester (FDME), 93.0 grams (0.366 moles) of bis(2-hydroxyethyl) terephthalate (BHET), and 2.39 grams (0.0385 moles) of EG to a 500 mL round bottom flask equipped with an overhead stirrer and a distillation/condensation apparatus. After evacuating and back filling with N2, 0.144 grams of Ti (IV) isopropoxide catalyst were added. The reactor was then placed into a 180° C. salt bath and overhead mixing was started at 100 rpm under N2 atmosphere. After one hour the bath temperature was increased to 230° C. After 30 minutes, temperature was increased to 270° C. After 1 hour under N2 at this temperature, vacuum was started and continued for 2 hours. Under an N2 atmosphere, 0.515 grams of PMDA (0.0.0024 mol) was slowly added. An additional 30 minutes of mixing at temperature were allowed, yielding a polymer with a molecular weight of ˜40,000 g/mol. Solid state polymerization was conducted by grinding an aliquot of the above product and then heating at 180° C. under vacuum for 1 day on a rotary evaporator to produce a PET19:PEF1 copolymer with a PET molecular weight of 72.6 kg/mole as reported in Example 7A1.

A variation of this technique was used to produce the PET19:PEF1 copolymer with a PET molecular weight of 79 kg/mole as reported in Example 7A2. In particular,

a random copolymer of PET95:PEF5 (95:5 mole ratio) was prepared by adding 3.54 grams (0.0192 moles) of furan dicarboxylic methyl ester (FDME), 93.0 grams (0.366 moles) of bis(2-hydroxyethyl) terephthalate (BHET), and 2.39 grams (0.0385 moles) of EG to a 500 mL round bottom flask equipped with an overhead stirrer and a distillation/condensation apparatus. After evacuating and back filling with N2, 0.144 grams of Ti (IV) isopropoxide catalyst were added. The reactor was then placed into a 180° C. salt bath and overhead mixing was started at 100 rpm under N2 atmosphere. After one hour the bath temperature was increased to 230° C. After 30 minutes, temperature was increased to 270° C. After 1 hour under N2 at this temperature, vacuum was started and continued for 2 hours. Under an N2 atmosphere, 0.515 grams of PMDA (0.0.0024 mol) was slowly added. An additional 30 minutes of mixing at temperature were allowed, yielding a polymer with a molecular weight of ˜40,000 g/mol. Solid state polymerization was conducted by grinding an aliquot of the above product and then heating at 180° C. under vacuum for 1 day on a rotary evaporator to produce the PET19:PEF1 copolymer with a PET molecular weight of 79 kg/mole as reported in Example 7A2.

### Synthesis Example 11A—PET95:PEF5 Block Copolymer Preparation with MW of about 83 kg/mol with PMDA

A block copolymer of PET95:PEF5 (95:5 mole ratio) was prepared with a target molecular size of about 83,000 g/mol with PET and PEF blocks of 7,7, respectively.

PEF oligomers were prepared by adding 40.5 grams of EG and 0.174 grams of sodium carbonate to a 500 mL cylindrical reactor equipped with a reflux condenser and an overhead stirrer. The mixture was heated to 230° C. until the catalyst was completely dissolved. Commercially available PEF (59.5 grams) was added and the mixture was allowed to reflux under N2 for 2 hours. The resulting mixture are the PEF oligomers.

PET oligomers were prepared by adding, 235 grams of EG and 1.0 gram of sodium carbonate to a 1000 mL cylindrical reactor equipped with a condenser and an overhead stirrer. The mixture was heated to 220° C. until the catalyst was completely dissolved. Commercially available PET (364 g) was added and the mixture was allowed to reflux under N2 for 2 hours. The result was a PET oligomer mixture.

The co-polymer was made by quickly adding 6 grams of the PEF oligomers and 117.9 grams of the PET oligomers (both melted at 160° C.) to a 500 mL cylindrical steel reactor equipped with an overhead stirrer and a distillation/condensation apparatus that was immersed in a 220° C. salt bath, followed by adding 0.892 grams of Ti(IV) isopropoxide. Shortly thereafter (<2 min), vacuum was slowly applied to remove EG. After 40 minutes, the temperature was increased to 270° C., and the contents of the reactor were allowed to remain under vacuum for 40 minutes. Under a N2 atmosphere, 0.483 gram of PMDA was slowly added. An additional 30 minutes of mixing at temperature were allowed before stopping the reaction to produce the PET19:PEF1 copolymer with a PET molecular weight of 83.033 g/mole as reported in Example 11A.

### Synthesis Example 12A1—PET9:PEF1 Copolymer Preparation with MW of about 56 kg/mol with ADR

A random copolymer of PET9:PEF1 (9:1 mole ratio) was prepared by adding 8.7 grams (0.0472 moles) of furan dicarboxylic methyl ester (FDME), 107.6 grams (0.42 moles) of bis(2-hydroxyethyl) terephthalate (BHET) and 6.22 grams (0.1 moles) of EG to a 500 mL cylindrical steel reactor equipped with an overhead stirrer and a distillation/condensation apparatus. After evacuating and back filling with N2, 0.0503 grams of Ti (IV) isopropoxide catalyst were added. The reactor was then placed into a 180° C. salt bath and overhead mixing was started at 200 rpm under N2 atmosphere. After 2.5 hours the bath temperature was increased to 220° C. After 30 minutes under N2, vacuum was started. After 40 minutes under vacuum, the temperature was increased to 250° C. and continued for 2 hours. Under N2 atmosphere, 1.1507 grams of ADR-4468 was slowly added. An additional 30 minutes of mixing at temperature were allowed before stopping the reaction. Solid state polymerization was conducted by grinding an aliquot (30 g) of the above product and then heating at 180° C. under vacuum for 3 days on a rotary evaporator to produce the PET9:PEF1 copolymer with a PET molecular weight of 56,794 g/mole as reported in Example 12A1.

### Synthesis Example 12A2—PEF Homopolymer Preparation with MW of about 70 kg/mol with PMDA Plus Talc and SSP

A block copolymer of PET9:PEF1 (9:1 mole ratio) was prepared with a target molecular of about 117,900 g/mol with PET and PEF blocks of 5,4 respectively. In particular, PEF was first prepared by adding 498 grams of FDCA (2.7 moles) and 417 grams of EG (6.72 moles) to a 1000 mL cylindrical glass reactor equipped with an overhead stirrer and a distillation/condensation apparatus which was immersed in a 190° C. salt bath. After purging with nitrogen, 0.414 grams of Ti (IV) isopropoxide catalyst were added to the flask and overhead mixing was started at 200 rpm under N2 atmosphere. After 2.5 hours, the bath temperature was increased to 220° C. After 30 minutes at this temperature under N2, vacuum was started. After 40 minutes under vacuum, the temperature was increased to 240° C. and was continued for 2 hours before stopping the reaction, and PEF was produced.

PEF Oligomers were prepared by adding 109 grams of EG and 0.45 grams of sodium carbonate to a 500 ml cylindrical reactor equipped with a reflux condenser and an overhead stirrer. The mixture was heated until boiling in at salt bath at 230° C. An aliquot of PEF (160 grams) from the above step was added. The mixture was allowed to react under reflux for 2 hours until the reaction was stopped. The resulting mixture are the PEF oligomers.

PET Oligomers were prepared by adding, 136 grams of EG and 0.68 gram of sodium carbonate to a 500 ml cylindrical reactor equipped with a condenser and an overhead stirrer. The mixture was heated in at salt bath at 230° C. Then 210 grams of commercially available recycled PET flake were added. The mixture was allowed to react under reflux for 2 hours until the reaction was stopped. The result was a PET oligomer mixture.

The co-polymer was made by quickly adding 10.15 grams of the PEF oligomers and 97.64 grams of the PET oligomers to a 500 mL cylindrical steel reactor equipped with an overhead stirrer and a distillation/condensation apparatus that was immersed in a 220° C. salt bath, followed by adding 0.957 grams of Ti(IV) isopropoxide. Shortly thereafter (<2 min), vacuum was applied to remove EG. After 40 minutes, the temperature was increased to 270° C., and the contents of the reactor were allowed to remain under vacuum for 40 minutes. Under a N2 atmosphere, a mixture of 0.4615 gram of PMDA and 0.3317 gram of Talc was slowly added. An additional 30 minutes of mixing at temperature were allowed before stopping the reaction. Solid state polymerization was conducted by grinding an aliquot of the above product and then heating at 180° C. under vacuum for 3 days on a rotary evaporator to produce the PET9:PEF1 copolymer with a PET molecular weight of 69,900 g/mole as reported in Example 12A2.

### Synthesis Example 13A—PET9:PEF1 Block Copolymer Preparation with MW of about 47 kg/mol with Pentaerythritol

A block copolymer of PET9:PEF1 (9:1 mole ratio) was prepared with a target molecular size of about 47,000 g/mol with PET and PEF blocks of 6,7, respectively.

PEF oligomers were prepared by adding 40.5 grams of EG and 0.174 grams of sodium carbonate to a 500 mL cylindrical reactor equipped with a reflux condenser and an overhead stirrer. The mixture was heated to 230° C. until the catalyst was completely dissolved. Commercially available PEF (59.5 grams) was added and the mixture was allowed to reflux under N2 for 2 hours. The resulting mixture are the PEF oligomers.

PET oligomers were prepared by adding, 235 grams of EG and 1.0 gram of sodium carbonate to a 1000 mL cylindrical reactor equipped with a condenser and an overhead stirrer. The mixture was heated to 230° C. until the catalyst was completely dissolved. Commercially available PET (364 g) was added and the mixture was allowed to reflux under N2 for 2 hours. The result was a PET oligomer mixture.

The co-polymer was made by quickly adding 12 grams of the PEF oligomers and 111.7 grams of the PET oligomers (both melted at 160° C.) to a 500 mL cylindrical steel reactor equipped with an overhead stirrer and a distillation/condensation apparatus that was immersed in a 220° C. salt bath, followed by adding 0.332 grams of pentaerythritol and 0.9 grams of Ti(IV) isopropoxide. Shortly thereafter (<2 min), vacuum was slowly applied to remove EG. After 40 minutes, the temperature was increased to 270° C., and the contents of the reactor were allowed to remain under vacuum for 40 minutes.

### Synthesis Example C1A—PET Homopolymer Preparation with MW of about 105 kg/mol with PMDA and SSP

About 163 grams of bis(2-hydroxyethyl) terephthalate (BHET) and 0.114 grams of titanium (IV) isopropoxide were added to a 500 mL cylindrical reactor. The reactor was then lowered into a 180° C. salt bath and overhead mixing was started at 200 rpm under N2 atmosphere. After 1.5 hours the bath temperature was increased to 250° C. After 30 minutes at this temperature under N2, vacuum was started. After 40 min under vacuum, the temperature was increased to 280° C. and was continued for 1 hours. Under a N2 atmosphere, 0.66 grams of PMDA were slowly added over the span of about 5 minutes. An additional 30 minutes of mixing at temperature were allowed before stopping the reaction. Solid state polymerization was conducted by grinding an aliquot (30 g) of the above product and then heating at 180° C. under vacuum for 3 days on a rotary evaporator.

### Synthesis Example C2A1—PET Homopolymer Preparation at Molecular Weight of 95.6 kg/mol with PMDA and SSP

PET homopolymer was prepared by polycondensation yielding products with a molecular size of 48.3 kg/mol. About 93 grams (0.366 mol) of bis(2-hydroxyethyl) terephthalate (BHET) was added to a 500 mL round bottom flask. After pulling vacuum and back filling with N2, the flask was lowered into a 180° C. salt bath and overhead mixing was started at 100 rpm under N2 flow. 0.129 grams (0.0005 mol) of titanium isopropoxide catalyst were charged into the flask. After 50 minutes, the bath temperature was increased to 285° C. After two hours at this temperature under N2, vacuum was started and continued for 2 hours. Under a stream of N2, pyromellitic dianhydride PMDA (0.49 g; 0.0022 mol) was slowly added over the span of about 10 minutes. An additional 30 minutes of mixing at temperature were allowed before stopping the reaction. Solid state polymerization was conducted by grinding an aliquot (30 g) of the above product and then heating at 180° C. under vacuum for 3 days on a rotary evaporator yielding a polymer with a molecular weight of 95.6 kg/mol.

### Synthesis Example C2A2—PET Homopolymer Preparation at Molecular Weight of 80.87 kg/mol with PMDA and SSP

PET homopolymer was prepared by polycondensation yielding products with a molecular size of 80,871 g/mol. About 93 grams (0.366 mol) of bis(2-hydroxyethyl) terephthalate (BHET) was added to a 500 mL round bottom flask. After pulling vacuum and back filling with N2, the flask was lowered into a 180° C. salt bath and overhead mixing was started at 100 rpm under N2 flow. 0.123 grams (0.0004 mol) of titanium isopropoxide catalyst were charged into the flask. After three hours, the bath temperature was increased to 285° C. After one hour at this temperature under N2, vacuum was started and continued for one hour. Under a stream of N2, pyromellitic dianhydride PMDA (0.49 g; 0.0022 mol) was slowly added over the span of about 10 minutes. An additional 30 minutes of mixing at temperature were allowed before stopping the reaction. Solid state polymerization was conducted by grinding an aliquot of the above product and then heating at 180° C. under vacuum for 3 days on a rotary evaporator yielding a polymer with a molecular weight of 80.9 kg/mol.

### Synthesis Example C2A3—PET Homopolymer Preparation at Molecular Weight of 80.9 kg/mol with PMDA and SSP

PET homopolymer was prepared by polycondensation yielding products with a molecular size of 61.1 kg/mol. About 93 grams (0.366 mol) of bis(2-hydroxyethyl) terephthalate (BHET) was added to a 500 mL round bottom flask. After pulling vacuum and back filling with N2, the flask was lowered into a 180° C. salt bath and overhead mixing was started at 100 rpm under N2 flow. After three hours of heating under N2, 0.123 grams (0.0004 mol) of titanium isopropoxide catalyst were charged into the flask. After 50 minutes, the bath temperature was increased to 285° C. After 1.5 hours at this temperature under N2, vacuum was started and continued for two hours. Under a stream of N2, pyromellitic dianhydride PMDA (0.49 g; 0.0022 mol) was slowly added over the span of about 10 minutes. An additional 30 minutes of mixing at temperature were allowed before stopping the reaction. Solid state polymerization was conducted by grinding an aliquot (30 g) of the above product and then heating at 180° C. under vacuum for 3 days on a rotary evaporator yielding a polymer with a molecular weight of 81 kg/mol.

### USE EXAMPLES

### Comparative Example 7: Wind Turbine Generator Made with PET Foam

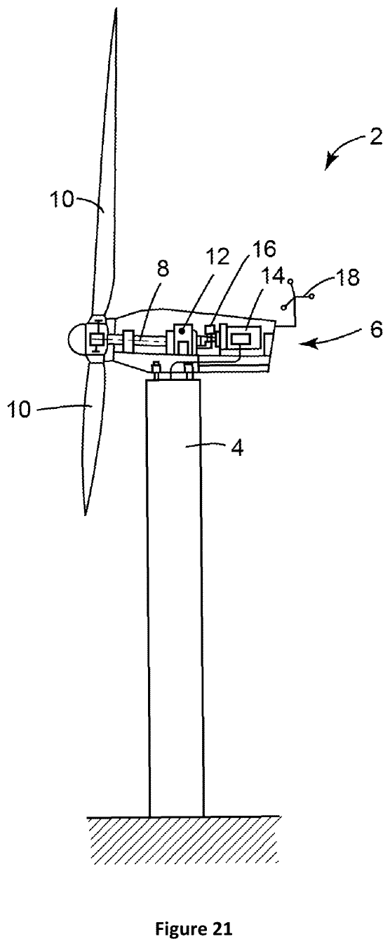

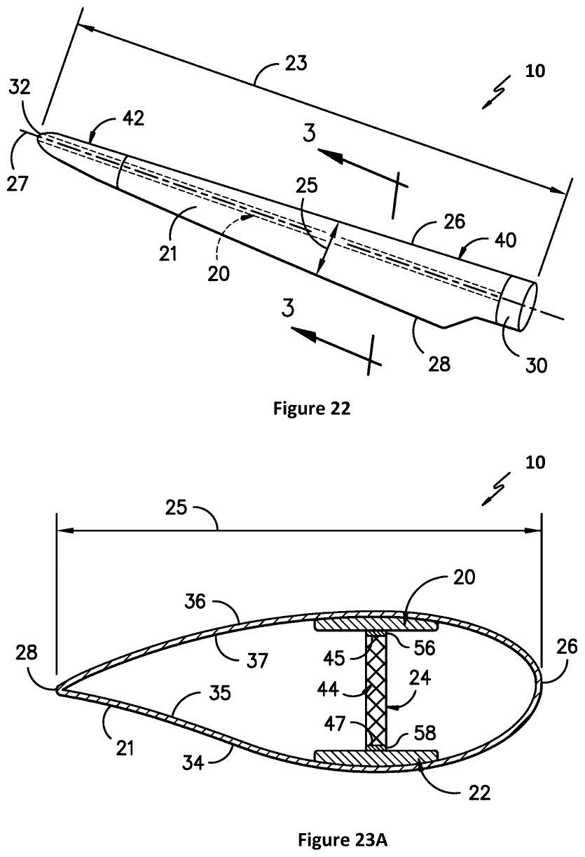

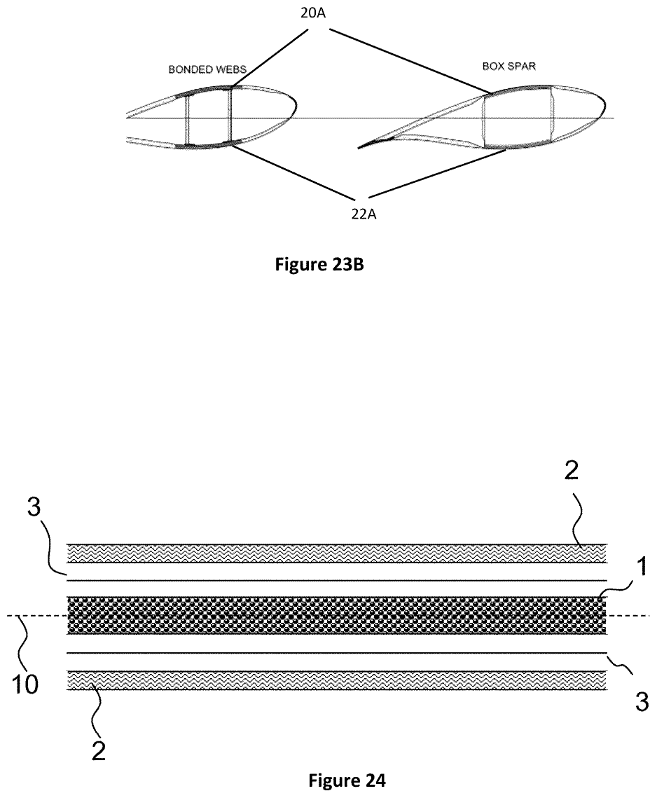

A wind turbine generator having a configuration of the general type illustrated in FIGS. 21-24 hereof is constructed on land with a nacelle approximately 150 meters off the ground (referenced to the center-line of the nacelle). The blade span for each blade from the hub axis to the blade tip is about 100 meters and a rotor diameter of about 200 meters. The generator produces about 13 MW of electric power at peak design conditions. For blade designs in which PET is the only core material used, each the three blades will have 26.4 m3, of the type illustrated generally in FIG. 24, per blade shell, for a total of 79.2 m3 for all three blades. Since the PET has a density of about 100 kg/m3, the total weight of PET foam for the wind turbine is 7,900 kg. The PET foam provides a foam core compression strength of 1.5 MPa and a foam core tensile strength of 2.5 MPa, based on technical data sheets provided by suppliers of commercial PET foam, i.e., Gurit, AArmacel.

### Example 22A: Wind Turbine Generator Made with PEF Homopolymer Foam of the Present Invention

A wind turbine generator having a configuration as described in Comparative Example 7 is constructed, except that the foam core is extruded foam of the present invention, including each of Foams 1-4, or extruded foam made from PEF polymer of the present invention, including Thermoplastic Polymer TPP1A-TPP22E, or any of the extruded foams described in Examples 1-22. The higher relative tensile strength of the preferred extruded PEF foams of the present invention relative to extruded PET foam enables a factor of about 1.2 to about 1.4 times lower density of the PEF foam of the present invention relative to commercially available PET foam, while matching the tensile strength of the higher density PET foam. As a result of taking these strength advantages into account, the PEF-based wind turbine blade of this example is 1.3 times lighter than the foam part of the PET-based blade of Comparative Example 4, while achieving the same energy production. Based on the 2011 Sandia Report SAND2011-3779 (https://energy.sandia.gov/wp-content/gallery/uploads/113779.pdf), the blades of a 13 MW wind turbine (100 m blades) is 20 wt. % foam core. A factor of 1.3 times reduction in the weight of the foam results in 5% reduction in blade weight. To balance the torque, this weight reduction in the turbine blade produces an additional reduction in the weight of the nacelle, the final value depending on the distance between the center of mass for the nacelle with respect to the tower. This overall weight savings for the wind turbine generator, as a result of using foam of the present invention, including each of Foams 1-4, or foam made from PEF polymer of the present invention, including Thermoplastic Polymer TPP1A-TPP22E, or any of the foams described in Examples 1-22, is a highly advantageous and unexpected result.

### Example 23: Wind Turbine Generator Made with Extruded PET:PEF Copolymer Foams of the Present Invention in the Blade Shell

A wind turbine generator having a configuration as described in Comparative Example 4 is made, except that the foam core is an extruded foam of the present invention, including each of Foams 1-4, or foam made from PEF polymer of the present invention, including Thermoplastic Polymer TPP1A-TPP22E, or any of the foams described in Examples 1-22. The preferred copolymeric foams show an approximate 2 times higher in tensile strength and compressive strength at densities comparable to the density of the PET foam of the comparative example. Based on information publicly available from the suppliers of commercial PET foam for the based-line for the comparison, the preferred PET-PEF copolymeric foam of the present invention is believed to have a shear strength advantage, which is approximately the average of the tensile and compressive strength advantages, about 2 times compared to PET foam. This 2 times advantage in shear strength is an unexpected and highly advantageous result, at least in part, because it enables the core foam thickness to be reduced by as much as a factor of two (2), as long as the flexural rigidity of the foam core is still acceptable, which is expected to be the case. This is indicated by the following calculations described in Chapter 3 of the Introduction to Sandwich Structures, Student Edition, 1995, Dan Zenkert.

τ_{c}=Tₓ/d

where:
Tx is the direct load in newtons (per width of the beam, which is 1 cm in this case), causing bending of the beam (in this case the blade);
d is thickness of the core foam+skin, which is approximately equal to thickness of the core foam (in cm);
τc is the shear stress experienced by the core foam, as a result of the direct load. Since load here is in newton/cm, the stress becomes newton/cm2, which has the units of pressure. High shear strength, implies high shear stress (τc), enabling lower core foam thickness, while still addressing the same direct load on the beam.

Based on publicly available data from suppliers of commercially available PET foam, increasing the density of the PET foam from 80 kg/m³ to 135 kg/m3 increases the compressive and tensile strengths of the PET foam by a factor of 2.5 times and 1.5 times, respectively. In this interval, the shear strength is increased by a factor of approximately 2, which is roughly the average of tensile and compressive strength advantages. The advantages as determined in this examples are based on the information and data contained in the following publicly available sources, each of which is incorporated herein by reference: https://www.gurit.com/-/media/Gurit/Datasheets/Kerdyn-Green.pdf); (https://local.armacell.com/fileadmin/cms/pet-foams/ArmaPET_website/Product_Flyer/ArmaPET_Struct_GR)

### Example 24: Wind Turbine Generator Made with Extruded PET:PEF Copolymer Foams of the Present Invention in the Blade Shell

A wind turbine generator having a configuration as described in Comparative Example 7 is made, except that the foam core is extruded foam of the present invention, including each of Foams 1-4, or extruded foam made from PEF polymer of the present invention, including Thermoplastic Polymer TPP1A-TPP22E, or any of the extruded foams described in Examples 1-22. The copolymeric foam of the present invention has a relative tensile strength approximately 1.7 times higher than the relative tensile strength of the PET foam of the comparative example at comparable densities. The copolymeric foam of the present invention also has a relative compressive strength approximately 1.5 times higher than the relative compressive strength of the PET foam of the comparative example at comparable densities. These results indicate that the copolymeric foams of the present invention will have a shear strength that is higher than the comparable PET foam by about a factor of about 1.6 times, which will enable lowering the thickness of the foam core by as much as a factor of about 1.6, as long as the flexural rigidity of the foam core is still adequate, which is expected to be the case. Reducing the thickness of the foam core results in a significant weight reduction, and this is a highly advantageous but unexpected result.

What is claimed is:

1. An extruded thermoplastic foam comprising:
(a) thermoplastic polymer cells comprising cell walls forming closed cells, wherein said thermoplastic polymer consists essentially of ethylene furanoate moieties and optionally ethylene terephthalate moieties, wherein said polymer comprises from about 10 mole % to about 100 mole % of ethylene furanoate moieties and optionally at least about 1 mole % ethylene terephthalate moieties; and
(b) trans1234ze contained in the closed cells.

2. The extruded foam of claim 1 wherein said thermoplastic polymer: (i) comprises from about 10 mole % to about 100 mole % of ethylene furanoate moieties and from 10 mole % to about 90% ethylene terephthalate moieties; and (ii) has a molecular weight of at least about 25,000.

3. The extruded foam of claim 1 wherein said thermoplastic polymer: (i) comprises from about 10 mole % to about 100 mole % of ethylene furanoate moieties and from 10 mole % to about 90% ethylene terephthalate moieties; and (ii) has a molecular weight of from about 25,000 to about 140,000.

4. The extruded foam of claim 1 wherein said thermoplastic polymer has been formed by a process that includes treatment with a chain extender.

5. The extruded foam of claim 1 wherein at least about 75% of the cells are closed cells.

6. The extruded foam of claim 1 wherein at least about 90% of the cells are closed cells.

7. The extruded foam of claim 1 wherein said foam has a relative foam density (RFD) of about 0.09 or less.

8. The extruded foam of claim 1 wherein said foam has a foam density of less than 0.1 g/cc.

9. The extruded foam of claim 8 wherein said cell walls consist essentially of thermoplastic having a molecular weight of from about 30,000 to about 130,000.

10. The extruded foam of claim 9 wherein said foam has a relative foam density (RFD) of about 0.09 or less.

11. A wind energy turbine blade and/or nacelle comprising a foam according to claim 1.

12. A wind energy turbine blade and/or nacelle comprising a foam according to claim 2.

13. A wind energy turbine blade and/or nacelle comprising a foam according to claim 4.

14. A wind energy turbine blade and/or nacelle comprising a foam according to claim 5.

15. A wind energy turbine blade and/or nacelle comprising a foam according to claim 8.

16. An automobile car wall comprising an extruded foam according to claim 1.

17. A marine vessel comprising an extruded foam according to claim 1.

18. An aircraft or aerospace vessel comprising an extruded foam according to claim 1.

19. A method of forming extruded thermoplastic foam comprising extruding a foamable composition comprising thermoplastic polymer and blowing agent, wherein said thermoplastic polymer consists essentially of ethylene furanoate moieties and optionally ethylene terephthalate moieties and wherein said extruding step comprises forcing said foamable composition from a relatively high pressure region through a die to a relatively low pressure region.

20. The method of claim 19 wherein said thermoplastic polymer: (i) comprises from about 10 mole % to about 100 mole % of ethylene furanoate moieties and from 10 mole % to about 90% ethylene terephthalate moieties; and (ii) has a molecular weight of from about 25,000 to about 140,000, and wherein said thermoplastic foam comprises a closed cell thermoplastic foam in which at least about 75% of the cells in said extruded foam are closed cells.
